(19) United States
(12) Patent Application Publication
(10) Pub. No.: US 2023/0108958 A1
(43) Pub. Date: Apr. 6, 2023

(54) COMPUTER IMPLEMENTED TECHNIQUES AND GRAPHICAL USER INTERFACES FOR FACILITATING ONLINE SALE, TRANSFER, AND/OR EXCHANGE OF WHOLE OR FRACTIONAL OWNERSHIP INTERESTS OF ELECTRONIC SPORTS WAGER TRANSACTIONS

(71) Applicant: Wire Industries Inc., Los Angeles, CA (US)

(72) Inventors: Zachary Doctor, Los Angeles, CA (US); Guy Dotan, Los Angeles, CA (US); Travis Geiger, Los Angeles, CA (US)

(73) Assignee: Wire Industries Inc., Los Angeles, CA (US)

(21) Appl. No.: 17/938,040

(22) Filed: Oct. 4, 2022

Related U.S. Application Data
(60) Provisional application No. 63/267,837, filed on Feb. 10, 2022.
(60) Provisional application No. 63/252,143, filed on Oct. 4, 2021.

(51) Int. Cl. G06Q 30/0601; G06Q 20/04; G06Q 50/34; G06Q 20/40; G06Q 20/10; G07F 17/32

(52) U.S. Cl. CPC G06Q 30/0611; G06Q 20/0457; G06Q 50/34; G06Q 20/4014; G06Q 20/10; G07F 17/3288

(57) ABSTRACT

Various aspects described or referenced herein are directed to different methods, systems, computer program products, and graphical user interfaces for facilitating online sale, transfer, and/or exchange of whole or fractional ownership interests of wager-based, sports related electronic bet tickets originating from different sportsbook providers.

### RELATED APPLICATION DATA

The present application claims benefit, pursuant to the provisions of 35 U.S.C. § 119, of U.S. Provisional Application Ser. No. 63/267,837 (Attorney Docket No. WIREP002P), titled “COMPUTER IMPLEMENTED TECHNIQUES AND GRAPHICAL USER INTERFACES FOR FACILITATING ONLINE SALE, TRANSFER, AND/OR EXCHANGE OF WHOLE OR FRACTIONAL OWNERSHIP IN INTERESTS OF ELECTRONIC SPORTS WAGER TRANSACTIONS”, naming Doctor et al. as inventors, and filed 10 Feb. 2022, the entirety of which is incorporated herein by reference for all purposes.

The present application herein incorporates by reference in its entirety and for all purposes U.S. Provisional Application Ser. No. 63/252,143 (Attorney Docket No. WIREP001P), titled “COMPUTER IMPLEMENTED TECHNIQUES AND GRAPHICAL USER INTERFACES FOR FACILITATING ONLINE SALE, TRANSFER, AND/OR EXCHANGE OF WHOLE OR FRACTIONAL OWNERSHIP IN INTERESTS OF ELECTRONIC SPORTS WAGER TRANSACTIONS ACROSS MULTIPLE SPORTSBOOK SERVICES PROVIDERS”, naming Doctor et al. as inventors, and filed 4 Oct. 2021.

### BACKGROUND

The present disclosure relates generally to sports wagering, and particularly to computer implemented techniques and graphical user interfaces for facilitating online sale, transfer, and/or exchange of whole or fractional ownership interests of electronic sports wager transactions.

In traditional sports betting, a customer purchases a bet ticket that includes one or more wagers on one or more sporting events. Traditionally, the tickets were issued as physical slips of paper. The price of the ticket depends on the current odds, which are typically set by the gaming establishment (e.g., sportsbook entity) or service selling the ticket. The odds are typically dynamic and may change at any time before the sporting event occurs.

More recently, gaming establishments and sportsbook entities have begun offering electronic-based bet tickets, referred to as electronic bet tickets. Many of these gaming and sportsbooks entities and now provide online access for enabling remote customers to purchase electronic bet tickets. Using electronic devices such as computers and/or smart phones, customers from different geographic locations and/or jurisdictions are able to purchase electronic bet tickets online from a variety of different gaming and sportsbooks entities. However, such gaming and sportsbooks entities are still required by law to comply with local, state, and federal jurisdictional laws and regulations governing online wagering.

In order for a customer to purchase an electronic bet ticket with an online sportsbook, the customer is typically required to create an online account with that sportsbook. Subsequently, when the customer purchases an electronic bet ticket with that sportsbook, the electronic bet ticket is assigned to the customer's account associated with that sportsbook. However, unlike physical bet tickets which may be freely and privately bought and sold between customers, a customer who purchases an electronic bet ticket from a given sportsbook is typically unable to sell their electronic bet ticket to another customer. Similarly, a prospective buyer is typically unable to purchase an electronic bet ticket owned by another customer. One reason for this is due to the heavily regulated jurisdictions in which gaming and sportsbook entities operate. Another reason relates to security, as many gaming and sportsbooks entities are reluctant to provide remote access of their databases to outside parties. Similar challenges also exist in the context of fantasy sports wagering.

The various techniques disclosed in the present application are aimed at addressing one or more of the problems identified above.

### BRIEF DESCRIPTION OF THE DRAWINGS

FIG. 1 illustrates a simplified block diagram of a specific example embodiment of an Electronic Sports Wager Exchange System 100.

FIG. 2 shows an alternate example embodiment of an Electronic Sports Wager Exchange System.

FIG. 3 is a simplified block diagram of an exemplary client system 300 in accordance with a specific embodiment.

FIG. 4 illustrates an example embodiment of a System Server 480.

FIG. 5 illustrates an example of a functional block diagram of a Wager Wire system Server in accordance with a specific embodiment.

FIGS. 6-7 and 28-43 illustrate various example embodiments of different procedures and/or procedural flows which may be used for facilitating activities relating to one or more of the electronic bet ticket exchange techniques disclosed herein FIGS. 8A-F and 9A-F illustrate example WagerWire GUI screenshots.

FIGS. 10-21, 22A, 23A, 24A, 22B, 23B, 24B and 25-27 illustrate example screenshots of various GUIs which may be used for facilitating activities relating to one or more of the electronic bet ticket exchange aspects disclosed herein.

FIG. 44 shows an example embodiment of an Electronic Bet Ticket Exchange Transaction Procedure A.

FIG. 45A shows an example embodiment of an Electronic Bet Ticket Exchange Transaction Procedure B.

FIG. 45B shows an example embodiment of an Electronic Bet Ticket Exchange Transaction Procedure C.

FIGS. 46A-B, 47A-B, 48A-B, 49, and 61-63 illustrate example embodiments of various types of data structures and data which may be used for accounting, tracking, distributing, and/or managing of funds relating to WagerWire facilitated transactions across one or more different Sportsbook entities.

FIGS. 50A-50O illustrate example screenshots of different graphical user interfaces (GUIs) which may be generated by a mobile device application (e.g., WagerWire application, Sportsbook application) running on a user's mobile computing device (e.g., smartphone) for enabling the user to engage in various electronic bet ticket exchange transactions with other users via an online electronic bet ticket exchange marketplace.

FIGS. 51A-52N illustrate example screenshots of different graphical user interfaces (GUIs) which may be generated by a mobile device application (e.g., WagerWire application) running on a user's mobile computing device (e.g., smartphone) for enabling the user to engage in various electronic bet ticket exchange transactions with other users via an online electronic bet ticket exchange marketplace.

FIGS. 52A-52N illustrate example screenshots of different graphical user interfaces (GUIs) which may be generated by a mobile device application (e.g., WagerWire application) running on a user's mobile computing device (e.g., smartphone) for enabling the user to engage in various electronic bet ticket exchange transactions with other users via an online electronic bet ticket exchange marketplace

FIGS. 53A-E show example GUI screenshot relating to an example procedural flow involving the sale/purchase of a fractional portion of an electronic bet ticket via an electronic bet ticket exchange marketplace.

FIGS. 54A-E show example GUI screenshot relating to an example procedural flow involving a buyer-initiated offer to purchase of a fractional portion of an electronic bet ticket via an electronic bet ticket exchange marketplace.

FIG. 55 illustrates an example embodiment of a WW-Book payment flow.

FIG. 56 illustrates an example embodiment of a Book-Book payment flow.

FIG. 57 illustrates an example embodiment of a sportsbook funded payment flow.

FIG. 58 shows an example screenshot of an Electronic Bet Ticket Checkout GUI.

FIG. 59 shows an example screenshot of a WagerWire application GUI a user may utilize for configuring a sales price of an electronic bet ticket to be listed for sale at the WagerWire marketplace.

FIG. 60 shows an example embodiment of a Conditional Purchase Configuration GUI which provides functionality for enabling a user to configure specific conditional purchase parameters.

FIG. 64 shows an example screenshot of a Make Me Whole Offer Configuration GUI 6401 in accordance with one embodiment.

### DETAILED DESCRIPTION OF EXAMPLE EMBODIMENTS

### Overview

Various aspects described or referenced herein are directed to different methods, systems, computer program products, and graphical user interfaces for facilitating online sale, transfer, and/or exchange of whole or fractional ownership interests of wager-based sports electronic bet tickets originating from different sportsbook services providers.

Various aspects described or referenced herein are directed to different methods, systems, and computer program products for facilitating exchange of wager-based electronic bet tickets among users via an online electronic bet ticket exchange marketplace; the users including a first user, a second user, and a third user; the wager-based electronic bet tickets including a first electronic bet ticket originating from a first sportsbook system, and including a second electronic bet ticket originating from a second sportsbook system; the first electronic bet ticket representing a first bet placed by the first user at the first sportsbook system; the first electronic bet ticket having associated therewith a first wagered amount value and a first bet win amount value; the first electronic bet ticket being represented by a first bet object stored in non-transitory memory of a first sportsbook system database; the first bet object including data identifying a first user account as a current owner of the first electronic bet ticket; the first user account being associated with the first user; the second electronic bet ticket representing a second bet placed by the second user at the second sportsbook system; the second electronic bet ticket having associated therewith a second wagered amount value and a second bet win amount value; the second electronic bet ticket being represented by a second bet object stored in non-transitory memory of a second sportsbook system database; the second bet object including data identifying a second user account as a current owner of the second electronic bet ticket; the second user account being associated with the second user.

In at least one embodiment, various method(s), system(s) and/or computer program product(s) may be operable to cause at least one processor to execute a plurality of instructions stored in non-transient memory for: receiving, at a computerized ticket exchange system, a first request from the first user to post, at the electronic bet ticket exchange marketplace, a first sale offer to sell a first portion of ownership interest in the first electronic bet ticket, the first sale offer specifying a first set of terms, including a first purchase price, a first win amount; processing the first request; posting, in response to processing the first request, the first sale offer at the electronic bet ticket exchange marketplace; receiving, at the ticket exchange system, a third request from the third user to purchase the first portion of ownership interest in the first electronic bet ticket in accordance with the first set of terms; processing the third request; executing, in response to processing the third request, a first plurality of operations for facilitating execution of a first electronic bet ticket sale transaction relating to a sale of the first portion of ownership interest in the first electronic bet ticket to the third user, in accordance with the first sale offer, the first plurality of operations including: determining whether the first electronic bet ticket sale transaction relates to a whole bet sale of a 100% portion of ownership interest in the first electronic bet ticket, or a fractional bet sale of less than a 100% portion of ownership interest in the first electronic bet ticket; calculating a first amount of proceeds of the first electronic bet ticket sale transaction which are due to the first user; transmitting, to the first sportsbook system, a first set of transaction details relating to the first electronic bet ticket sale transaction; transmitting instructions to the first sportsbook system for causing the first sportsbook system to distribute funds or credits relating to the first amount of proceeds to the first user account; transmitting additional instructions to the first sportsbook system for causing the first sportsbook system to update a status of the of the first electronic bet ticket to reflect that the first electronic bet ticket is settled or closed; transmitting additional instructions to the first sportsbook system for causing the first sportsbook system to create a third electronic bet ticket at the first sportsbook system representing the first portion of ownership interest in the first electronic bet ticket, using the first set of transaction details; transmitting additional instructions to the first sportsbook system for causing the first sportsbook system to update the first sportsbook system database to associate ownership of the third electronic bet ticket with a third user account at the first sportsbook system, wherein the third user account is associated with the third user; if it is determined that the first electronic bet ticket sale transaction relates to the fractional bet sale of less than a 100% portion of ownership interest in the first electronic bet ticket, calculating an updated win amount for the first electronic bet ticket which is retained by the first user after execution of the first electronic bet ticket sale transaction; if it is determined that the first electronic bet ticket sale transaction relates to the fractional bet sale of less than a 100% portion of ownership interest in the first electronic bet ticket, transmitting additional instructions to the first sportsbook system for causing the first sportsbook system to create a fourth electronic bet ticket at the first sportsbook system representing a remainder portion of ownership interest in the first electronic bet ticket which is retained by the first user after execution of the first electronic bet ticket sale transaction, using the first set of transaction details; and if it is determined that the first electronic bet ticket sale transaction relates to the fractional bet sale of less than a 100% portion of ownership interest in the first electronic bet ticket, transmitting additional f instructions to the first sportsbook system for causing the first sportsbook system to update the first sportsbook system database to associate ownership of the fourth electronic bet ticket with the first user account.

Additional method(s), system(s) and/or computer program product(s) may be further operable to cause at least one processor to execute additional instructions for: performing verification and regulatory compliance clearance analysis to confirm eligibility and approval for executing the first electronic bet ticket sale transaction.

Additional method(s), system(s) and/or computer program product(s) may be further operable to cause at least one processor to execute additional instructions for: receiving, at the computerized ticket exchange system, a second request from the second user to post, at the electronic bet ticket exchange marketplace, a second sale offer to sell a second portion of ownership interest in the second electronic bet ticket, the second sale offer specifying a second set of terms, including a second purchase price, a second win amount; processing the second request; posting, in response to processing the second request, the second sale offer at the electronic bet ticket exchange marketplace; and enabling the third user to access the online electronic bet ticket exchange marketplace and view a plurality of offers posted to the electronic bet ticket exchange marketplace, including the first sale offer and second sale offer.

Additional method(s), system(s) and/or computer program product(s) may be further operable to cause at least one processor to execute additional instructions for: enabling the first user to create a first marketplace account at the electronic bet ticket exchange system; enabling the first user to initiate linking of the first sportsbook account and the first marketplace account; accessing the first sportsbook system database and identifying the first electronic bet ticket assigned to the first user account; updating a database of the ticket exchange system to create a first link or association between the first electronic bet ticket and the first marketplace account; enabling the second user to create a second marketplace account at the electronic bet ticket exchange system; enabling the second user to initiate linking of the second sportsbook account and the second marketplace account; accessing the second sportsbook system database and identifying the second electronic bet ticket assigned to the second user account; and updating the database of the ticket exchange system to create a second link or association between the second electronic bet ticket and the second marketplace account.

Additional method(s), system(s) and/or computer program product(s) may be further operable to cause at least one processor to execute additional instructions for: processing a first payment transaction relating to the first electronic bet ticket sale transaction; and causing a first portions of funds associated with the first payment transaction to be routed to a financial account associated with the first sportsbook system.

Additional method(s), system(s) and/or computer program product(s) may be further operable to cause at least one processor to execute additional instructions for: calculating a first purchase amount which is to be paid by the third user in connection with the first electronic bet ticket sale transaction; and transmitting additional instructions to the first sportsbook system for causing the first sportsbook system to debit the third user account for the first purchase amount.

Additional method(s), system(s) and/or computer program product(s) may be further operable to cause at least one processor to execute additional instructions for: receiving, at the computerized ticket exchange system, a second request from the second user to post, at the electronic bet ticket exchange marketplace, a second sale offer to sell a second portion of ownership interest in the second electronic bet ticket, the second sale offer specifying a second set of terms, including a second purchase price, a second win amount; processing the second request; posting, in response to processing the second request, the second sale offer at the electronic bet ticket exchange marketplace; receiving, at the ticket exchange system, a fourth request from the third user to purchase the second portion of ownership interest in the second electronic bet ticket in accordance with the second set of terms; processing the fourth request; executing, in response to processing the fourth request, a second plurality of operations for facilitating execution of a second electronic bet ticket sale transaction relating to a sale of the second portion of ownership interest in the second electronic bet ticket to the third user, in accordance with the second sale offer, the second plurality of operations including: determining whether the second electronic bet ticket sale transaction relates to a whole bet sale of a 100% portion of ownership interest in the second electronic bet ticket, or a fractional bet sale of less than a 100% portion of ownership interest in the second electronic bet ticket; calculating a second amount of proceeds of the second electronic bet ticket sale transaction which are due to the second user; transmitting, to the second sportsbook system, a second set of transaction details relating to the second electronic bet ticket sale transaction; transmitting additional instructions to the second sportsbook system for causing the second sportsbook system to distribute funds or credits relating to the second amount of proceeds to the second user account; transmitting additional instructions to the second sportsbook system for causing the second sportsbook system to update a status of the of the second electronic bet ticket to reflect that the second electronic bet ticket is settled or closed; transmitting additional instructions to the second sportsbook system for causing the second sportsbook system to create a fifth electronic bet ticket at the second sportsbook system representing the second portion of ownership interest in the second electronic bet ticket, using the second set of transaction details; transmitting additional instructions to the second sportsbook system for causing the second sportsbook system to update the second sportsbook system database to associate ownership of the fifth electronic bet ticket with a fourth user account at the second sportsbook system, wherein the fourth user account is associated with the third user; if it is determined that the second electronic bet ticket sale transaction relates to the fractional bet sale of less than a 100% portion of ownership interest in the second electronic bet ticket, calculating an updated win amount for the second electronic bet ticket which is retained by the second user after execution of the second electronic bet ticket sale transaction; if it is determined that the second electronic bet ticket sale transaction relates to the fractional bet sale of less than a 100% portion of ownership interest in the second electronic bet ticket, transmitting additional instructions to the second sportsbook system for causing the second sportsbook system to create a sixth electronic bet ticket at the second sportsbook system representing a remainder portion of ownership interest in the second electronic bet ticket which is retained by the second user after execution of the second electronic bet ticket sale transaction, using the second set of transaction details; and if it is determined that the second electronic bet ticket sale transaction relates to the fractional bet sale of less than a 100% portion of ownership interest in the second electronic bet ticket, transmitting additional instructions to the second sportsbook system for causing the second sportsbook system to update the second sportsbook system database to associate ownership of the sixth electronic bet ticket with the second user account.

Additional method(s), system(s) and/or computer program product(s) may be further operable to cause at least one processor to execute additional instructions for: receiving, at the ticket exchange system, a third request from the third user to purchase the first portion of ownership interest in the first electronic bet ticket in accordance with the first set of terms; processing the third request; executing, in response to processing the third request, a first plurality of operations for facilitating execution of a first electronic bet ticket sale transaction relating to a sale of the first portion of ownership interest in the first electronic bet ticket to the third user, in accordance with the first sale offer, the first plurality of operations, including: performing verification and regulatory compliance clearance analysis to confirm eligibility and approval for executing the first electronic bet ticket sale transaction; determining whether the first electronic bet ticket sale transaction relates to a whole bet sale of a 100% portion of ownership interest in the first electronic bet ticket, or a whole bet sale of a 100% portion of ownership interest in the first electronic bet ticket; calculating a first amount of proceeds of the first electronic bet ticket sale transaction which are due to the first user; transmitting, to the first sportsbook system, a first set of transaction details relating to the first electronic bet ticket sale transaction; transmitting instructions to the first sportsbook system for causing the first sportsbook system to distribute funds or credits relating to the first amount of proceeds to the first user account; and if it is determined that the first electronic bet ticket sale transaction relates to the whole bet sale of a 100% portion of ownership interest in the first electronic bet ticket, transmitting additional instructions to the first sportsbook system for causing the first sportsbook system to update the first sportsbook system database to reassign ownership of the first electronic bet ticket to a third user account at the first sportsbook system, wherein the third user account is associated with the third user.

Additional method(s), system(s) and/or computer program product(s) may be further operable to cause at least one processor to execute additional instructions for: executing a second plurality of operations if it is determined that the first electronic bet ticket sale transaction relates to the fractional bet sale of less than a 100% portion of ownership interest in the first electronic bet ticket, including: transmitting additional instructions to the first sportsbook system for causing the first sportsbook system to update the first sportsbook system database to reassign an entirety of the first electronic bet ticket to a first escrow account; calculating an updated win amount for the first electronic bet ticket which is retained by the first user after execution of the first electronic bet ticket sale transaction; maintaining a first ledger at a database for tracking first fractional ownership information relating to the first electronic bet ticket; updating the first ledger to reflect that the second user owns a first fractional portion of the first electronic bet ticket corresponding to the first win amount; updating the first ledger to reflect that the first user owns a first fractional portion of the first electronic bet ticket corresponding to the updated win amount; identifying an outcome of the first bet upon detection that the first bet has reached maturity; determining if the outcome of the first bet represents a win condition; if it is determined that the outcome of the first that represents a win condition, distributing a first portion of funds or credits corresponding to the updated win amount to a first account associated with the first user; and if it is determined that the outcome of the first that represents a win condition, distributing a second portion of funds or credits corresponding to the first win amount to a second account associated with the second user.

Additional method(s), system(s) and/or computer program product(s) may be further operable to cause at least one processor to execute additional instructions for: executing a second plurality of operations if it is determined that the first electronic bet ticket sale transaction relates to the fractional bet sale of less than a 100% portion of ownership interest in the first electronic bet ticket, including: transmitting additional instructions to the first sportsbook system for causing the first sportsbook system to update a status of the of the first electronic bet ticket to reflect that the first electronic bet ticket is settled or closed; transmitting additional instructions to the first sportsbook system for causing the first sportsbook system to create a third electronic bet ticket at the first sportsbook system representing the first portion of ownership interest in the first electronic bet ticket, using the first set of transaction details; transmitting additional instructions to the first sportsbook system for causing the first sportsbook system to update the first sportsbook system database to associate ownership of the third electronic bet ticket with a third user account at the first sportsbook system, wherein the third user account is associated with the third user; calculating an updated win amount for the first electronic bet ticket which is retained by the first user after execution of the first electronic bet ticket sale transaction; transmitting additional instructions to the first sportsbook system for causing the first sportsbook system to create a fourth electronic bet ticket at the first sportsbook system representing a remainder portion of ownership interest in the first electronic bet ticket which is retained by the first user after execution of the first electronic bet ticket sale transaction, using the first set of transaction details; and transmitting additional f instructions to the first sportsbook system for causing the first sportsbook system to update the first sportsbook system database to associate ownership of the fourth electronic bet ticket with the first user account.

Various objects, features and advantages of the various aspects described or referenced herein will become apparent from the following descriptions of its example embodiments, which descriptions should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

Moreover, it will be appreciated that, via the use of specifically configured computer hardware and software, the problems which are solved and/or overcome by the various WagerWire techniques described herein are necessarily rooted in computer technology in order to overcome problems specifically arising in the realm of computer networks. For example, as described previously, numerous problems and limitations are typically encountered when attempting to use conventional systems to implement environments. Such problems and limitations specifically arise in the realm of computer networks, and the solutions to these environment problems and limitations (e.g., as described herein) are necessarily rooted in computer technology.

Various aspects described or referenced herein are directed to different methods, systems, computer program products, and graphical user interfaces for facilitating online sale, transfer, and/or exchange of whole or fractional ownership interests of wager-based, sports related electronic bet tickets originating from different sportsbook providers.

The various WagerWire techniques described herein provide an innovative online, peer-peer electronic bet ticket exchange marketplace where users can buy and sell online sports bets at any time before the outcome of the wager is determined. In at least one embodiment, a special-purpose WagerWire computing system is configured or designed to include functionality for providing an online electronic bet ticket exchange marketplace where different electronic bet tickets originating from different Sportsbook entities may be offered for purchase or sale by different end users. In at least one embodiment, one or more WagerWire applications (e.g., mobile application, and/or browser-based application) may be provided to enable end users to access the online electronic bet ticket exchange marketplace, view electronic bet ticket offerings (“secondary market offerings”), post offers to sell electronic bet tickets originating from different sportsbook entities; submit offers to buy electronic bet tickets originating from different sportsbook entities; sell electronic bet tickets originating from different sportsbook entities (“secondary electronic bet ticket sales”; buy electronic bet tickets originating from different sportsbook entities (“secondary electronic bet ticket purchases”); etc.

In some embodiments, WagerWire may contract with licensed online sportsbook operators, and the WagerWire marketplace may be configured or designed such that users may only sell bets that originated from one of the contracted operators.

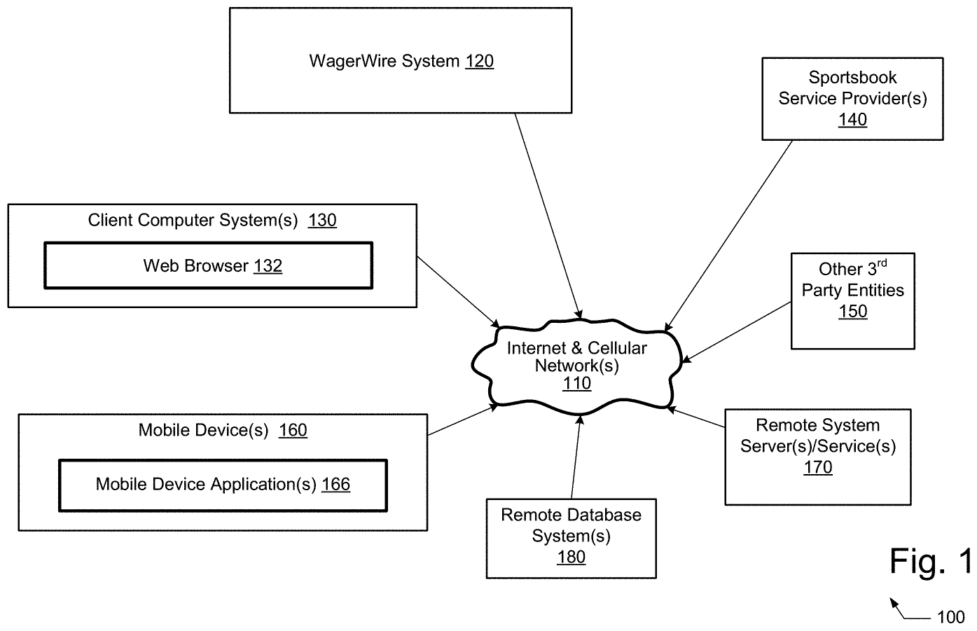

FIG. 1 illustrates a simplified block diagram of a specific example embodiment of an Electronic Sports Wager Exchange System 100 which may be implemented in via a computerized data network.

According to different embodiments, the Electronic Sports Wager Exchange System 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the Electronic Sports Wager Exchange System may include one or more of the following types of systems, components, devices, processes, etc. (or combinations thereof):
WagerWire system 120—In at least one embodiment, the WagerWire system may be operable to perform and/or implement various types of functions, operations, actions, and/or other features such as those described or referenced herein. An example embodiment of a WagerWire System is under development by Wire Industries Inc. (dba WagerWire).
Sportsbook Service Provider(s) 140
Client Computer System (s) 130
3^{rd} Party System(s) 150
Internet & Cellular Network(s) 110
Remote Database System(s)180
Remote System Server(s)/Service(s) 170, which, for example, may include, but are not limited to, one or more of the following (or combinations thereof):
Mobile Device(s) 160—In at least one embodiment, the Mobile Device(s) may be operable to perform and/or implement various types of functions, operations, actions, and/or other features such as those described or referenced herein.
Content provider servers/services
Media Streaming servers/services
Database storage/access/query servers/services
Financial transaction servers/services
Payment gateway servers/services
Electronic commerce servers/services
Event management/scheduling servers/services
Etc.

As described in greater detail herein, different embodiments of WagerWire systems (also referred to herein as “WW” or “WW System” or “WagerWire”) may be configured, designed, and/or operable to provide various different types of operations, functionalities, and/or features generally relating to WagerWire system technology. Further, as described in greater detail herein, many of the various operations, functionalities, and/or features of the WagerWire system(s) disclosed herein may provide may enable or provide different types of advantages and/or benefits to different entities interacting with the WagerWire system(s).

According to different embodiments, at least some WagerWire system(s) may be configured, designed, and/or operable to provide a number of different advantages and/or benefits and/or may be operable to initiate, and/or enable various different types of operations, functionalities, and/or features, such as, for example, one or more of those described and/or referenced herein.

According to different embodiments, at least some WagerWire system(s) may be configured, designed, and/or operable to provide a number of different advantages and/or benefits and/or may be operable to initiate, and/or enable various different types of operations, functionalities, and/or features, which, for example, may include one or more of the following (or combinations thereof):
Functionality for providing electronic bet ticket exchange/transfer capabilities.
Functionality for enabling a user to link their WagerWire sportsbook account with multiple different partner sportsbook systems.
Functionality for providing syncing of data of user's electronic bet tickets from multiple different sportsbook accounts associated with different sportsbook entities.
Functionality for providing automatic and dynamic calculation of WagerWire Deal Scores, which may be based, at least partially on real-time conditions/events.
Functionality for providing transparent payment processing and distribution. E.g., User provides payment to WW System, then funds automatically transferred to originating sportsbook for credit to seller's account.
Functionality for providing fractional electronic bet ticket purchases, offers, and sales.
Functionality for providing portfolio value tracker (real time & historical).
Functionality for enabling Users able to auto-create accounts with partner sportsbooks using their account credentials previously stored on WagerWire system.
Functionality for providing bet auctions. E.g., allow prospective buyers to make bids on a wager listing for set period of time.
Functionality for providing dynamically generated suggested pricing for electronic bet ticket offers, which may be based, at least partially on real-time conditions/events. E.g., WagerWire may be configured or designed to suggest a price to users listing their bet for sale, based on the Implied Value of a bet.
Functionality for providing dynamic updating of Offer/Sales Prices. E.g., WagerWire may be configured or designed to update your sales price in real time to ensure your bet sells for a fair price (you set your preferred percentage discount to the current consensus odds).
Functionality for automatically and/or dynamically generating a suggested fractional bet offer listing for an electronic bet ticket owned by a user, wherein the suggest listing price and win amount for the fractional bet offer listing are specifically tailored to allow the user to recoup the initial amount wagered on the bet.
Functionality for automatically and/or dynamically generating and posting, on behalf of a user, an offer listing for selling a whole or fractional portion of a user's electronic bet ticket, and for enabling the user to pre-define one or more triggering events and/or conditions for granularly controlling the automated execution of this feature.
Functionality for providing automated and dynamic adjustment of a win amount value associated with an active electronic bet ticket sale listing.
Functionality for providing automated and dynamic adjustment of the offered fractional ownership value associated with an active electronic bet ticket sale listing.
WagerWire “escrow ledger” functionality. E.g., Permit movement of electronic bet tickets between users through a WW ledger with final bet holder only taking ownership after event occurs.
Functionality for providing automatic and dynamic removal of electronic bet ticket offer listing. E.g., seller can set parameters to pull the listing down (e.g., upon start of game, when line moves more than x %, etc.).
Functionality for enabling prospective buyers to generate and post buy requests' for certain bet at a certain price; sellers can then fill the buy offer.
Functionality for automatically and dynamically generating instant Cash Out options for electronic bet ticket offers meeting specific criteria.
Functionality for enabling conditional purchasing. E.g., Buyer can set parameters to automatically buy a specific type of bet at certain price (such as ‘Buy any Lakers to win Championship graded A or better, less than $1000).
Functionality for providing customized notifications. E.g., User can set parameters to be notified (e.g. for line movements, good deals on watch list, etc.)
Functionality for providing sign up promotions. E.g., new users and/or referrers receive a free/promotional random electronic bet ticket(s).
Etc.

According to different embodiments, at least a portion of the various functions, actions, operations, and activities performed by one or more component(s) of the WagerWire system may be initiated in response to detection of one or more conditions, events, and/or other criteria satisfying one or more different types of minimum threshold criteria, such as, for example, one or more of those described and/or referenced herein.

According to different embodiments, at least a portion of the various types of functions, operations, actions, and/or other features provided by the WagerWire system may be implemented at one or more client systems(s), at one or more mobile device(s), at one or more System Servers (s), and/or combinations thereof.

According to different embodiments, the WagerWire system 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the WagerWire system may include one or more types of systems, components, devices, processes, etc. (or combinations thereof) described and/or referenced herein.

In at least one embodiment, the WagerWire system may be operable to utilize and/or generate various different types of data and/or other types of information when performing specific tasks and/or operations. This may include, for example, input data/information and/or output data/information. For example, in at least one embodiment, the WagerWire system may be operable to access, process, and/or otherwise utilize information from one or more different types of sources, such as, for example, one or more local and/or remote memories, devices and/or systems. Additionally, in at least one embodiment, the WagerWire system may be operable to generate one or more different types of output data/information, which, for example, may be stored in memory of one or more local and/or remote devices and/or systems. Examples of different types of input data/information and/or output data/information which may be accessed and/or utilized by the WagerWire system may include, but are not limited to, one or more of those described and/or referenced herein.

According to specific embodiments, multiple instances or threads of the WagerWire system may be concurrently implemented and/or initiated via the use of one or more processors and/or other combinations of hardware and/or hardware and software. For example, in at least some embodiments, various aspects, features, and/or functionalities of the WagerWire system may be performed, implemented and/or initiated by one or more of the various systems, components, systems, devices, procedures, processes, etc., described and/or referenced herein.

In at least one embodiment, a given instance of the WagerWire system may access and/or utilize information from one or more associated databases. In at least one embodiment, at least a portion of the database information may be accessed via communication with one or more local and/or remote memory devices. Examples of different types of data which may be accessed by the WagerWire system may include, but are not limited to, one or more of those described and/or referenced herein.

According to different embodiments, various different types of encryption/decryption techniques may be used to facilitate secure communications between devices in WagerWire system(s) and/or WagerWire Network(s). Examples of the various types of security techniques which may be used may include, but are not limited to, one or more of the following (or combinations thereof): random number generators, SHA-1 (Secured Hashing Algorithm), MD2, MDS, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well known hardware-based and/or software-based security components, and/or any other known or yet to be devised security and/or hardware and encryption/decryption processes implemented in hardware and/or software.

According to different embodiments, one or more different threads or instances of the WagerWire system may be initiated in response to detection of one or more conditions or events satisfying one or more different types of minimum threshold criteria for triggering initiation of at least one instance of the WagerWire system. Various examples of conditions or events which may trigger initiation and/or implementation of one or more different threads or instances of the WagerWire system may include, but are not limited to, one or more of those described and/or referenced herein.

The following example is intended to help illustrate some of the various types of functions, operations, actions, and/or other features which may be enabled and/or provided by the WagerWire system:

| | Example |
|---|---|
| Feature/Functionality | API Source(s) |
| Bet transfer capability | Partner sportsbook |
| List a bet for sale | |
| Buy a bet (buy now) | |
| “Make an offer” for a bet that is listed for sale | |
| Search bar | |
| User account login (username/password creation) | |
| Users link sportsbook account' from partner sportsbooks | Partner sportsbook |
| Sync data of user's bets from partner sportsbook accounts | Partner sportsbook |
| Payment process: User inputs payment to WW, then price is transferred to sportsbook for credit | Partner sportsbook |
| to seller's account | |
| WagerWire Deal Score calculator | Sports data company |
| Consensus odds display | Sports data company |
| Forgot Password function for user's to retrieve lost credentials | |
| Browse bets without logging in (viewing mode only) | |
| Bottom navigation bar (Home/MyWire/Portfolio/Profile) | |
| Users that must create sportsbook accounts to complete a purchase are routed to partners | Partner sportsbook |
| sportsbook website | |
| WagerWire point system to gamify and incentivize activity (e.g. earn points for selling and | |
| buying bets) | |
| Refer-a-friend program for users | |
| Badges awarded to users for achieving certain goals or activity levels | |
| Portfolio value tracker (real time & historical) | Partner sportsbook + |
| | Sports data company |
| Basic bet analytics (price history; changes based on line moves) | |
| Transaction Feed (Venmo style - users publish bet activity with a brief message; display choice | |
| public/private) | |
| Watch list for bets you are tracking | |
| Bet/transaction history for the user | |
| Sign up promotion: new users receive a free random bet (like Robinhood free random stock) | Partner sportsbook |
| Post to directly social media (sale listings; buys) | Social Media |
| Seller can see how many people have viewed their listing, placed on watchlist, etc | |
| Customized Notifications: User can set parameters to be notified (e.g. for line movements, good | Sports data company |
| deals on watch list) | |
| Game schedules displayed | Sports data company |
| Live game scores displayed | Sports data company |
| Partial bet selling/buying | Partner sportsbook |
| Personalized user profile with ‘my teams’ | |
| Advanced bet analytics | Sports data company |
| Bonuses/incentives to users for selling bets | |
| Premium subscription model for unlimited free transactions and access to premium features | |
| Leaderboard of most successful bettors on the platform | |
| Users able to auto-create accounts with partner sportsbooks using their WagerWire account | Partner sportsbook |
| credentials and information | |
| Buyers can see how many times this bet has been viewed in the last hour | |
| Prospective buyers can make ‘buy requests’ for certain bet at a certain price; sellers can then | |
| fill the buy offer | |
| Offer instant Cash Out option for certain bets | |
| Dynamic Sales Price - WagerWire will update your sales price in real time to ensure your bet | Sports data company |
| sells for a fair price (you set your preferred percentage discount to the current consensus odds) | |
| Auto purchase: Buyer can set parameters to automatically buy a specific type of bet at certain | |
| price | |
| Dynamic removal of listing: seller can set parameters to pull the listing down (e.g. when game | Sports data company |
| starts, or line moves more than x %) | |
| Reward stacking. Each time a bet is sold it rewards the seller with progressively more points. | |
| Earn Casino/sportsbook loyalty points for transaction activity | Partner sportsbook |
| Tournaments for users such as most profit, best ROI, etc during a specified timeframe | |
| Partnership skins - users can select brands to earn loyalty points (teams or just random | |
| advertisers e.g. Wendy's) | |
| Streak for Cash: Users win additional prizes for X number of consecutive winning bets | |
| Social feature where users can ‘follow’ their favorite bettors | |
| Multiplayer/team competitions where users form teams and compete with other teams over | |
| combine betting results | |
| Game idea: Hot Potato - whoever holds the electronic bet ticket last loses and users are | |
| rewarded for holding or trading the electronic bet ticket as much as possible | |
| Buy Action feature where users can ‘back’ successful bettors similar to backing a poker player | |

It will be appreciated that the WagerWire system of FIG. 1 is but one example from a wide range of WagerWire system embodiments which may be implemented. Other embodiments of the WagerWire system (not shown) may include additional, fewer and/or different components/features that those illustrated in the example WagerWire system embodiment of FIG. 1.

Additionally, for purposes of illustration, the various WagerWire system and electronic bet ticket exchange techniques disclosed herein are described by way of example illustrations with respect to the purchase and sale of electronic bet tickets originating at traditional sportsbook entities such as, for example, Caesars®, Ballys®, MGM®, DraftKing®, Fandual®, etc. However, it will be appreciated that the various WagerWire system and electronic bet ticket exchange techniques disclosed herein may also be applied and/or utilized in other types of electronic bet ticket environments/networks, including, for example:
Networks originating parimutuel electronic bet tickets
Networks originating racing-type electronic bet tickets (e.g., horse racing)
Direct pier-pier exchange networks
Networks originating fantasy-related electronic bet tickets
Networks originating competition/tournament related electronic bet tickets
Networks originating iGaming electronic bet tickets
and/or other types of electronic bet ticket networks and/or marketplaces

Generally, the WagerWire techniques described herein may be implemented in hardware and/or hardware+software. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Hardware and/or software+hardware hybrid embodiments of the WagerWire techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, System Servers, cloud computing systems, network devices, etc.

It will be appreciated that, via the use of specifically configured computer hardware and software, the problems which are solved and/or overcome by the various WagerWire techniques described herein are necessarily rooted in computer technology in order to overcome problems specifically arising in the realm of computer networks. For example, as described previously, numerous problems and limitations are typically encountered when attempting to use conventional online sports wagering systems to conduct secondary sales of whole or partial ownership of electronic betting slips originating from one or more Sportsbook entities. Such problems and limitations specifically arise in the realm of computer networks, and the solutions to the various existing problems and limitations for seamlessly and transparently enabling and facilitating transactions relating to secondary sales of whole or partial ownership of electronic betting slips (e.g., as described herein) are necessarily rooted in computer technology.

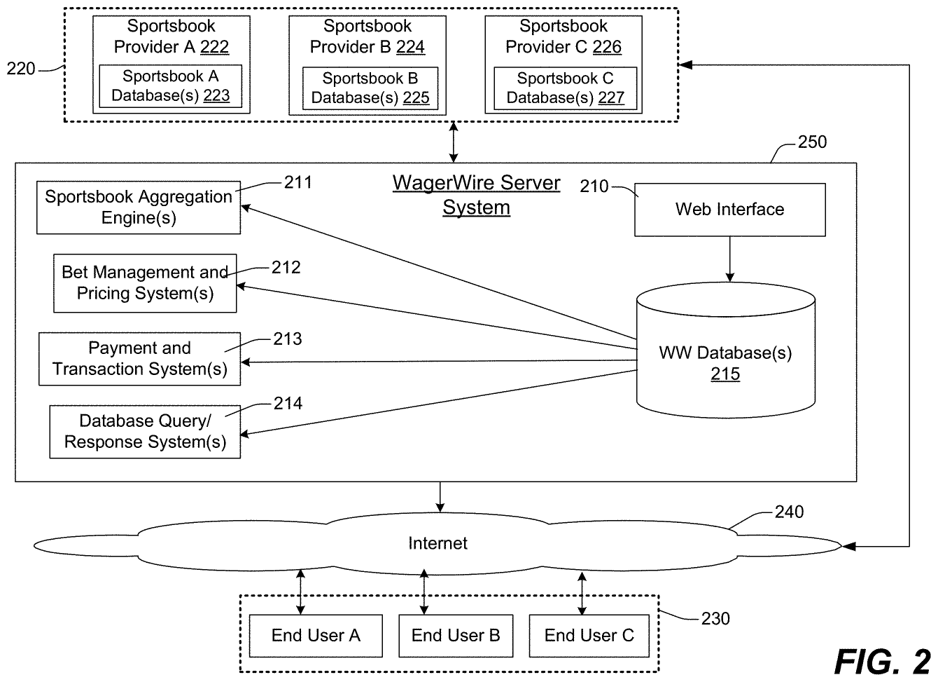

FIG. 2 shows an alternate example embodiment of an Electronic Sports Wager Exchange System which may be utilized for implementing various aspects, described herein.

As illustrated in the example embodiment of FIG. 2, the Electronic Sports Wager Exchange System may include a plurality of different types of components, devices, modules, processes, systems, etc., which, for example, may be implemented and/or instantiated via the use of hardware and/or combinations of hardware and software. For example, as illustrated in the example embodiment of FIG. 2, the Electronic Sports Wager Exchange System may include one or more of the following types of systems, components, devices, processes, etc. (or combinations thereof):
WagerWire Server System 250—In at least one embodiment, the WagerWire Server System may be operable to perform and/or implement various types of functions, operations, actions, and/or other features such as those described or referenced herein.
Sportsbook Service Providers and respective database system(s) 220
End User Devices 230
Internet & Wireless Data Network(s) 240
Etc.

In at least one embodiment, the interaction diagram of FIG. 2 illustrates the technical aspects of how the WagerWire Server System 250 initiates and/or performs a variety of different types of WagerWire Server operations and/or activities such as those described herein.

According to specific embodiments, the WagerWire Server System may be accessible to various entities such as, for example: individual persons, corporate or business entities, system administrators, online content providers, online publishers, merchants, artists, copyright holders, etc.

In at least one embodiment, the WagerWire Server System may include a plurality of components operable to perform and/or implement various types of functions, operations, actions, and/or other features such as, for example, one or more of those described and/or referenced herein.

According to specific embodiments, the WagerWire Server System may be accessible to various entities such as, for example: individual persons, corporate or business entities, system administrators, online content providers, online publishers, merchants, artists, copyright holders, etc.

As illustrated in the example embodiment of FIG. 2, WagerWire Server System may include one or more of the following types of systems, components, devices, processes, etc. (or combinations thereof):
Database(s) 214
Web Interface(s) 210
Sportsbook Aggregation Engine(s) 211
Bet Management and Pricing System(s) 212
Payment and Transaction System(s) 213
Database Query/Response System(s) 215
And/or other systems, components, devices, functionality described and/or referenced herein.

In at least one embodiment, one or more of the databases may be queried via the use of various types of programming languages and/or protocols such as, for example, one or more of the following (or combinations thereof):
HTML
XML
MySQL
Perl
Ajax
JavaScript
Etc.

In at least one embodiment, the WagerWire Server System functionality may be operable to perform and/or implement various types of functions, operations, actions, and/or other features such as, for example, one or more of the following (or combinations thereof):
Monitor user behaviors and activities;
Identify brand-related information associated with user-accessible content that the user is accessing; has requested access to; and/or has interest in;
Facilitate online sale, transfer, and/or exchange of whole or fractional ownership interests of electronic sports wager transactions across multiple sportsbook services providers;
Manage and track bets;
Manage reporting;
Transact online ordering and purchasing;
Transact Database queries/responses
Aggregate open bets across multiple different online Sportsbook service providers.
Manage sportsbook registration and login services;
Provide query disambiguation;
Facilitate order management and tracking;
Etc.

According to specific embodiments, multiple instances or threads of the WagerWire Server System functionality may be concurrently implemented and/or initiated via the use of one or more processors and/or other combinations of hardware and/or hardware and software. For example, in at least some embodiments, various aspects, features, and/or functionalities of the WagerWire Server System mechanism(s) may be performed, implemented and/or initiated by one or more systems, components, systems, devices, procedures, processes, etc. (or combinations thereof) described and/or referenced herein.

According to specific embodiments, multiple instances or threads of the WagerWire Server System functionality may be concurrently implemented and/or initiated via the use of one or more processors and/or other combinations of hardware and/or hardware and software. For example, in at least some embodiments, various aspects, features, and/or functionalities of the WagerWire Server System mechanism(s) may be performed, implemented and/or initiated by one or more of the following types of systems, components, systems, devices, procedures, processes, etc. (or combinations thereof):
Inventory Management system(s)
Online Order management/tracking system(s);
Shopping cart system(s);
Databases
Database query interface(s)
Merchant interface component(s)
Publisher/Content Provider interface component(s)
Customer Interface component(s)
Administrative interface component(s)
Sales channel partner interface component(s)
etc.

According to different embodiments, one or more different threads or instances of the WagerWire Server System functionality may be initiated in response to detection of one or more conditions or events satisfying one or more different types of minimum threshold criteria for triggering initiation of at least one instance of the WagerWire Server System functionality. Various examples of conditions or events which may trigger initiation and/or implementation of one or more different threads or instances of the WagerWire Server System functionality may include, but are not limited to, one or more types of conditions and/or events described or referenced herein.

According to different embodiments, one or more different threads or instances of the WagerWire Server System functionality may be initiated in response to detection of one or more conditions or events satisfying one or more different types of minimum threshold criteria for triggering initiation of at least one instance of the WagerWire Server System functionality. Various examples of conditions or events which may trigger initiation and/or implementation of one or more different threads or instances of the WagerWire Server System functionality may include, but are not limited to, one or more of the following (or combinations thereof):
Detection of user interest in particular artist, brand and/or other criteria
Identification of user;
Detection of user input;
Detection of merchant input;
Identification of available merchandise matching selected criteria such as, for example, artist criteria, brand criteria, etc.;
Detection of user's interest in purchasing merchandise (e.g., user clicks on WagerWire icon)
Identification of merchandise that user desires to purchase;
Detection completed purchase/order transaction;
Determination of revenue sharing distributions;
Receiving database query communication from external server (e.g., Content Provider Server)
Etc.

In at least one embodiment, a given instance of the WagerWire Server System functionality may access and/or utilize information from one or more associated databases. In at least one embodiment, at least a portion of the database information may be accessed via communication with one or more local and/or remote memory devices. Examples of different types of data which may be accessed by the WagerWire Server System functionality may include, but are not limited to, one or more different types of data, metadata, and/or other information described and/or referenced herein.

In at least one embodiment, a given instance of the WagerWire Server System functionality may access and/or utilize information from one or more associated databases. In at least one embodiment, at least a portion of the database information may be accessed via communication with one or more local and/or remote memory devices. Examples of different types of data which may be accessed by the WagerWire Server System functionality may include, but are not limited to, one or more of the following (or combinations thereof):
Brand-related information;
Merchandise availability information;
Pricing information;
User behavior and analytic information;
Performance information;
Inventory information;
Merchant information;
Supplier information;
Brand related taxonomy information;
Merchant subscription information;
Ecommerce related transaction information;
Order information;
Publisher/Content Provider information;
User profile information;
Merchant-brand association information;
Etc.

It will be appreciated that the various embodiments of the WagerWire Server Systems disclosed herein are but a few examples from a wide range of WagerWire Server System embodiments which may be implemented. Other embodiments of the WagerWire Server System (not shown) may include additional, fewer and/or different components/features that those illustrated and described herein.

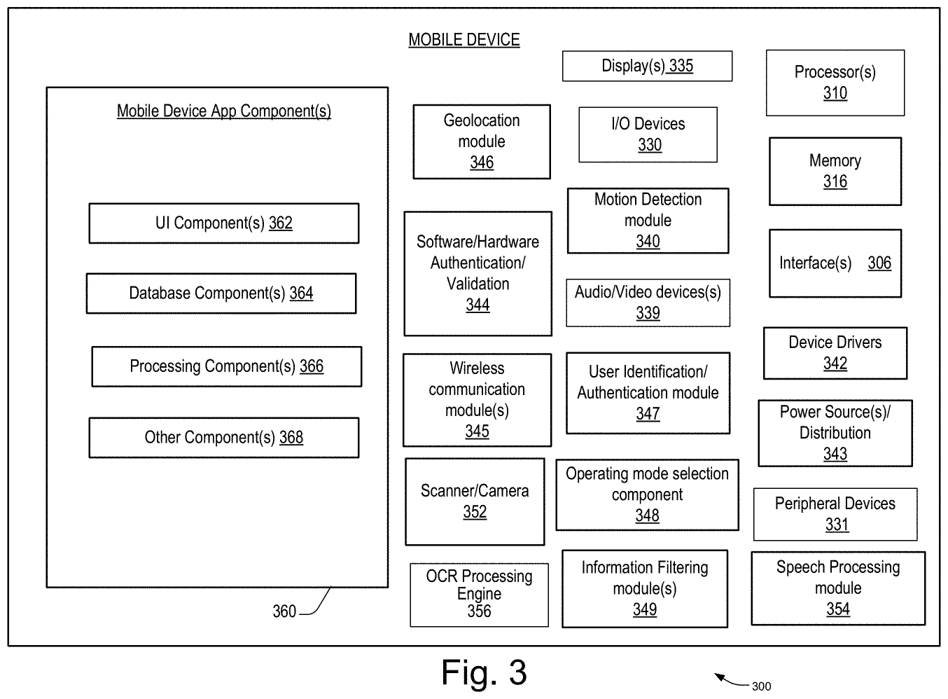

FIG. 3 is a simplified block diagram of an exemplary client system 300 in accordance with a specific embodiment. In at least one embodiment, the client system may include WagerWire Mobile Device App Component(s) which have been configured or designed to provide functionality for enabling or implementing at least a portion of the various WagerWire techniques at the client system.

According to specific embodiments, various aspects, features, and/or functionalities of the Mobile Device may be performed, implemented and/or initiated by one or more of the following types of systems, components, systems, devices, procedures, processes, etc. (or combinations thereof):
Processor(s) 310
Device Drivers 342
Memory 316
Interface(s) 306
Power Source(s)/Distribution 343
Geolocation module 346
Display(s) 335
I/O Devices 330
Audio/Video devices(s) 339
Peripheral Devices 331
Motion Detection module 340
User Identification/Authentication module 347
Client App Component(s) 360
Other Component(s) 368
UI Component(s) 362
Database Component(s) 364
Processing Component(s) 366
Software/Hardware Authentication/Validation 344
Wireless communication module(s) 345
Information Filtering module(s) 349
Operating mode selection component 348
Speech Processing module 354
Scanner/Camera 352
OCR Processing Engine 356
etc.

As illustrated in the example of FIG. 3 Mobile Device 300 may include a variety of components, modules and/or systems for providing various functionality. For example, as illustrated in FIG. 3, Mobile Device 300 may include Mobile Device Application components (e.g., 360), which, for example, may include, but are not limited to, one or more of the following (or combinations thereof):
UI Components 362 such as those illustrated, described, and/or referenced herein.
Database Components 364 such as those illustrated, described, and/or referenced herein.
Processing Components 366 such as those illustrated, described, and/or referenced herein.
Other Components 368 which, for example, may include components for facilitating and/or enabling the Mobile Device to perform and/or initiate various types of operations, activities, functions such as those described herein.

In at least one embodiment, the Mobile Device Application component(s) may be operable to perform and/or implement various types of functions, operations, actions, and/or other features such as, for example, one or more of those described and/or referenced herein.

According to specific embodiments, multiple instances or threads of the Mobile Device Application component(s) may be concurrently implemented and/or initiated via the use of one or more processors and/or other combinations of hardware and/or hardware and software. For example, in at least some embodiments, various aspects, features, and/or functionalities of the Mobile Device Application component(s) may be performed, implemented and/or initiated by one or more systems, components, systems, devices, procedures, processes, etc. (or combinations thereof) described and/or referenced herein.

According to different embodiments, one or more different threads or instances of the Mobile Device Application component(s) may be initiated in response to detection of one or more conditions or events satisfying one or more different types of minimum threshold criteria for triggering initiation of at least one instance of the Mobile Device Application component(s). Various examples of conditions or events which may trigger initiation and/or implementation of one or more different threads or instances of the Mobile Device Application component(s) may include, but are not limited to, one or more types of conditions and/or events described or referenced herein.

In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more different types of data, metadata, and/or other information described and/or referenced herein.

According to different embodiments, Mobile Device 300 may further include, but is not limited to, different types of components, modules and/or systems (or combinations thereof) such as, for example, one or more of those described and/or referenced herein.

According to different embodiments, Mobile Device 300 may further include, but is not limited to, one or more of the following types of components, modules and/or systems (or combinations thereof):
At least one processor 310. In at least one embodiment, the processor(s) 310 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 316, which, for example, may include volatile memory (e.g., RAM), non-volatile memory (e.g., disk memory, FLASH memory, EPROMs, etc.), unalterable memory, and/or other types of memory. In at least one implementation, the memory 316 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various WagerWire techniques described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the WagerWire techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 306 which, for example, may include wired interfaces and/or wireless interfaces. In at least one implementation, the interface(s) 306 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected electronic game tables, computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Device driver(s) 342. In at least one implementation, the device driver(s) 342 may include functionality similar to at least a portion of functionality implemented by one or more computer system driver devices such as those described herein and/or generally known to one having ordinary skill in the art.
At least one power source (and/or power distribution source) 343. In at least one implementation, the power source may include at least one mobile power source (e.g., battery) for allowing the client system to operate in a wireless and/or mobile environment. For example, in one implementation, the power source 343 may be implemented using a rechargeable, thin-film type battery. Further, in embodiments where it is desirable for the device to be flexible, the power source 343 may be designed to be flexible.
Geolocation module 346 which, for example, may be configured or designed to acquire geolocation information from remote sources and use the acquired geolocation information to determine information relating to a relative and/or absolute position of the client system.
Motion detection component 340 for detecting motion or movement of the client system and/or for detecting motion, movement, gestures and/or other input data from user. In at least one embodiment, the motion detection component 340 may include one or more motion detection sensors such as, for example, MEMS (Micro Electro Mechanical System) accelerometers, that can detect the acceleration and/or other movements of the client system as it is moved by a user.
User Identification/Authentication module 347. In one implementation, the User Identification module may be adapted to determine and/or authenticate the identity of the current user or owner of the client system. For example, in one embodiment, the current user may be required to perform a log in process at the client system in order to access one or more features. Alternatively, the client system may be adapted to automatically determine the identity of the current user based upon one or more external signals such as, for example, an RFID tag or badge worn by the current user which provides a wireless signal to the client system for determining the identity of the current user. In at least one implementation, various security features may be incorporated into the client system to prevent unauthorized users from accessing confidential or sensitive information.
One or more display(s) 335. According to various embodiments, such display(s) may be implemented using, for example, LCD display technology, OLED display technology, and/or other types of conventional display technology. In at least one implementation, display(s) 335 may be adapted to be flexible or bendable. Additionally, in at least one embodiment the information displayed on display(s) 335 may utilize e-ink technology (such as that available from E Ink Corporation, Cambridge, Mass., www.eink.com), or other suitable technology for reducing the power consumption of information displayed on the display(s) 335.
One or more user I/O Device(s) 330 such as, for example, keys, buttons, scroll wheels, cursors, touchscreen sensors, audio command interfaces, magnetic strip reader, optical scanner, etc.
Audio/Video device(s) 339 such as, for example, components for displaying audio/visual media which, for example, may include cameras, speakers, microphones, media presentation components, wireless transmitter/receiver devices for enabling wireless audio and/or visual communication between the client system 300 and remote devices (e.g., radios, telephones, computer systems, etc.). For example, in one implementation, the audio system may include componentry for enabling the client system to function as a cell phone or two-way radio device.
Other types of peripheral devices 331 which may be useful to the users of various client systems, such as, for example: PDA functionality; memory card reader(s); fingerprint reader(s); image projection device(s); social networking peripheral component(s); etc.
Information filtering module(s) 349 which, for example, may be adapted to automatically and dynamically generate, using one or more filter parameters, filtered information to be displayed on one or more displays of the mobile device. In one implementation, such filter parameters may be customizable by the player or user of the device. In some embodiments, information filtering module(s) 349 may also be adapted to display, in real-time, filtered information to the user based upon a variety of criteria such as, for example, geolocation information, contextual activity information, and/or other types of filtering criteria described and/or referenced herein.
Wireless communication module(s) 345. In one implementation, the wireless communication module 345 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Software/Hardware Authentication/validation components 344 which, for example, may be used for authenticating and/or validating local hardware and/or software components, hardware/software components residing at a remote device, game play information, wager information, user information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.
Operating mode selection component 348 which, for example, may be operable to automatically select an appropriate mode of operation based on various parameters and/or upon detection of specific events or conditions such as, for example: the mobile device's current location; identity of current user; user input; system override (e.g., emergency condition detected); proximity to other devices belonging to same group or association; proximity to specific objects, regions, zones, etc. Additionally, the mobile device may be operable to automatically update or switch its current operating mode to the selected mode of operation. The mobile device may also be adapted to automatically modify accessibility of user-accessible features and/or information in response to the updating of its current mode of operation.
Scanner/Camera Component(s) (e.g., 352) which may be configured or designed for use in scanning identifiers and/or other content from other devices and/or objects such as for example: mobile device displays, computer displays, static displays (e.g., printed on tangible mediums), etc.
OCR Processing Engine (e.g., 356) which, for example, may be operable to perform image processing and optical character recognition of images such as those captured by a mobile device camera, for example.
Speech Processing module (e.g., 354) which, for example, may be operable to perform speech recognition, and may be operable to perform speech-to-text conversion.
Etc.

According to a specific embodiment, the mobile device may be adapted to implement at least a portion of the features associated with the mobile game service system described in U.S. patent application Ser. No. 10/115,164, which is now U.S. Pat. No. 6,800,029, issued Oct. 5, 2004, (previously incorporated by reference in its entirety). For example. in one embodiment, the mobile device 300 may be comprised of a hand-held game service user interface device (GSUID) and a number of input and output devices. The GSUID is generally comprised of a display screen which may display a number of game service interfaces. These game service interfaces are generated on the display screen by a microprocessor of some type within the GSUID. Examples of a hand-held GSUID which may accommodate the game service interfaces are manufactured by Symbol Technologies, Incorporated of Holtsville, N.Y.

The game service interfaces may be used to provide a variety of game service transactions and gaming operations services. The game service interfaces, including a login interface, an input/output interface, a transaction reconciliation interface, a ticket validation interface, a prize services interfaces, a food services interface, an accommodation services interfaces, a gaming operations interfaces, a multi-game/multi-denomination meter data transfer interface, etc. Each interface may be accessed via a main menu with a number of sub-menus that allow a game service representative to access the different display screens relating to the particular interface. Using the different display screens within a particular interface, the game service representative may perform various operations needed to provide a particular game service. For example, the login interface may allow the game service representative to enter a user identification of some type and verify the user identification with a password. When the display screen is a touch screen, the user may enter the user/operator identification information on a display screen comprising the login interface using the input stylus and/or using the input buttons. Using a menu on the display screen of the login interface, the user may select other display screens relating to the login and registration process. For example, another display screen obtained via a menu on a display screen in the login interface may allow the GSUID to scan a finger print of the game service representative for identification purposes or scan the finger print of a game player.

The user identification information and user validation information may allow the game service representative to access all or some subset of the available game service interfaces available on the GSUID. For example, certain users, after logging into the GSUID (e.g. entering a user identification and a valid user identification information), may be able to access a variety of different interfaces, such as, for example, one or more of: input/output interface, communication interface, food services interface, accommodation services interface, prize service interface, gaming operation services interface, transaction reconciliation interface, voice communication interface, gaming device performance or metering data transfer interface, etc.; and perform a variety of services enabled by such interfaces. While other users may be only be able to access the award ticket validation interface and perform EZ pay ticket validations. The GSUID may also output game service transaction information to a number of different devices (e.g., card reader, printer, storage devices, gaming machines and remote transaction servers, etc.).

In addition to the features described above, various embodiments of mobile devices described herein may also include additional functionality for displaying, in real-time, filtered information to the user based upon a variety of criteria such as, for example, geolocation information, casino data information, player tracking information, etc.

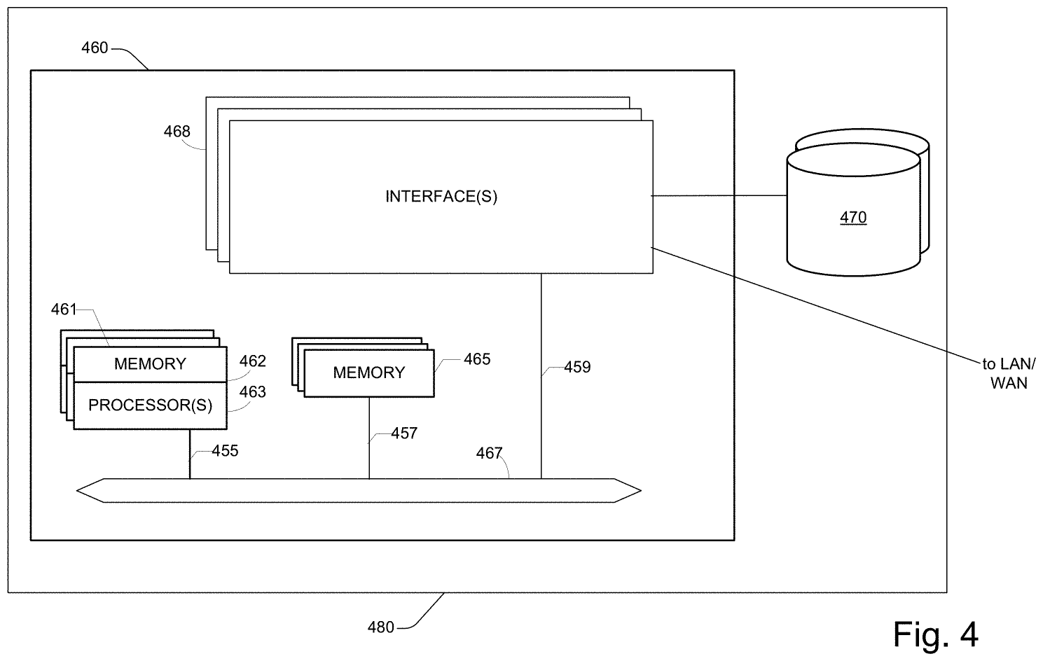

FIG. 4 illustrates an example embodiment of a System Server 480 which may be used for implementing various aspects/features described herein. In at least one embodiment, the System Server 480 includes at least one network device 460, and at least one storage device 470 (such as, for example, a direct attached storage device).

In one embodiment, System Server 480 may be suitable for implementing at least some of the WagerWire techniques described herein.

In according to one embodiment, network device 460 may include a master central processing unit (CPU) 462, interfaces 468, and a bus 467 (e.g., a PCI bus). When acting under the control of appropriate software or firmware, the CPU 462 may be responsible for implementing specific functions associated with the functions of a desired network device. For example, when configured as a server, the CPU 462 may be responsible for analyzing packets; encapsulating packets; forwarding packets to appropriate network devices; instantiating various types of virtual machines, virtual interfaces, virtual storage volumes, virtual appliances; etc. The CPU 462 preferably accomplishes at least a portion of these functions under the control of software including an operating system (e.g. Linux), and any appropriate system software (such as, for example, AppLogic™ software).

CPU 462 may include one or more processors 463 such as, for example, one or more processors from the AMD, Motorola, Intel and/or MIPS families of microprocessors. In an alternative embodiment, processor 463 may be specially designed hardware for controlling the operations of System Server 480. In a specific embodiment, a memory 461 (such as non-volatile RAM and/or ROM) also forms part of CPU 462. However, there may be many different ways in which memory could be coupled to the system. Memory block 461 may be used for a variety of purposes such as, for example, caching and/or storing data, programming instructions, etc.

The interfaces 468 may be typically provided as interface cards (sometimes referred to as “line cards”). Alternatively, one or more of the interfaces 468 may be provided as on-board interface controllers built into the system motherboard. Generally, they control the sending and receiving of data packets over the network and sometimes support other peripherals used with the System Server 480. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 4G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for communication intensive tasks, these interfaces allow the master microprocessor 462 to efficiently perform routing computations, network diagnostics, security functions, etc.

In at least one embodiment, some interfaces may be configured or designed to allow the System Server 480 to communicate with other network devices associated with various local area network (LANs) and/or wide area networks (WANs). Other interfaces may be configured or designed to allow network device 460 to communicate with one or more direct attached storage device(s) 470.

Although the system shown in FIG. 4 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 465, which, for example, may include random access memory (RAM)) configured to store data, program instructions for the general-purpose network operations and/or other information relating to the functionality of the various WagerWire techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as tangible read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

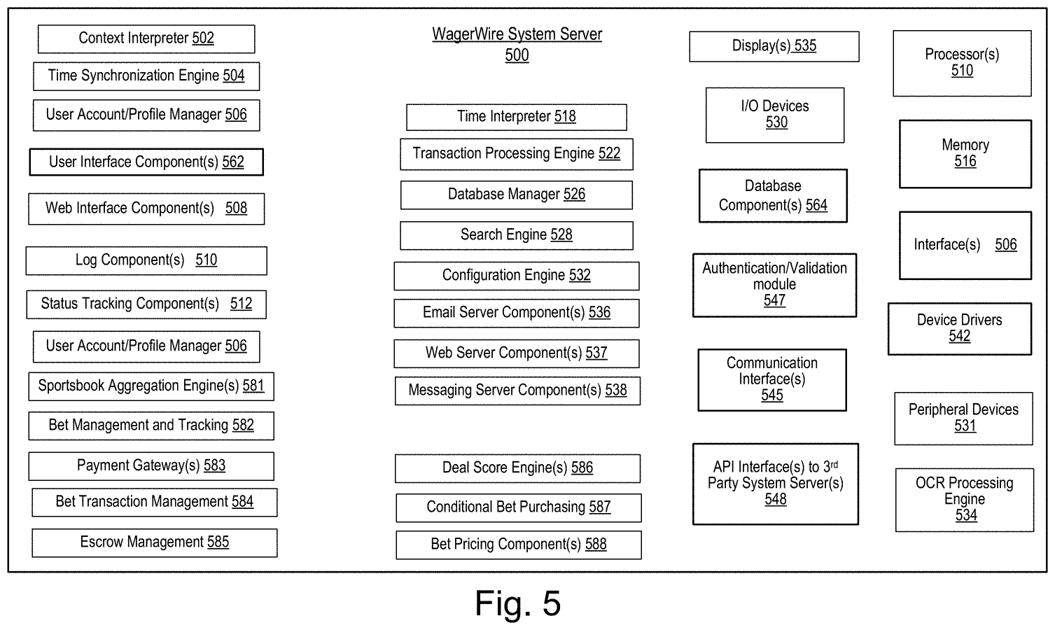

FIG. 5 illustrates an example of a functional block diagram of a WagerWire system Server in accordance with a specific embodiment. In at least one embodiment, the WagerWire system Server may be operable to perform and/or implement various types of functions, operations, actions, and/or other features, such as, for example, one or more of those described and/or referenced herein.

In at least one embodiment, the WagerWire system Server may include a plurality of components operable to perform and/or implement various types of functions, operations, actions, and/or other features such as, for example, one or more of the following (or combinations thereof):
Sportsbook Aggregation Engine(s) 581
Bet Management and Tracking Component(s) 582
Payment Gateway Component(s) 583
Bet Transaction Management Component(s) 584
Escrow Management Component(s) 585
Deal Score Engine(s) Component(s) 586
Conditional Bet Purchasing Component(s) 587
Bet Pricing Component(s) 588
Context Interpreter (e.g., 502) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof):
   location-based criteria (e.g., geolocation of client device, geolocation of agent device, etc.)
   time-based criteria
   identity of user(s)
   user profile information
   transaction history information
   recent user activities
   proximate business-related criteria (e.g., criteria which may be used to determine whether the client device is currently located at or near a recognized business establishment such as a bank, gas station, restaurant, supermarket, etc.)
   etc.
Time Synchronization Engine (e.g., 504) which, for example, may be operable to manages universal time synchronization (e.g., via NTP and/or GPS)
Search Engine (e.g., 528) which, for example, may be operable to search for transactions, logs, items, accounts, options in the WagerWire databases
Configuration Engine (e.g., 532) which, for example, may be operable to determine and handle configuration of various customized configuration parameters for one or more devices, component(s), system(s), process(es), etc.
Time Interpreter (e.g., 518) which, for example, may be operable to automatically and/or dynamically modify or change identifier activation and expiration time(s) based on various criteria such as, for example, time, location, transaction status, etc.
Authentication/Validation Component(s) (e.g., 547) (password, software/hardware info, SSL certificates) which, for example, may be operable to perform various types of authentication/validation tasks such as, for example, one or more of the following (or combinations thereof):
Verifying/authenticating devices,
Verifying passwords, passcodes, SSL certificates, biometric identification information, and/or other types of security-related information
Verify/validate activation and/or expiration times
Etc.

In one implementation, the Authentication/Validation Component(s) may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning The user's biometric information (e.g., fingerprints, face, voice, eye/iris, etc.). In at least one implementation, various security features may be incorporated into the mobile client system to prevent unauthorized users from accessing confidential or sensitive information.
Transaction Processing Engine (e.g., 522) which, for example, may be operable to handle various types of transaction processing tasks such as, for example, one or more of the following (or combinations thereof):
Identifying/determining transaction type
Determining which payment gateway(s) to use
Associating databases information to identifiers
Etc.
OCR Processing Engine (e.g., 534) which, for example, may be operable to perform image processing and optical character recognition of images such as those captured by a mobile device camera, for example.
Database Manager (e.g., 526) which, for example, may be operable to handle various types of tasks relating to database updating, database management, database access, etc. In at least one embodiment, the Database Manager may be operable to manage TISS databases, WagerWire Device Application databases, etc.
Log Component(s) (e.g., 510) which, for example, may be operable to generate and manage transactions history logs, system errors, connections from APIs, etc.
Status Tracking Component(s) (e.g., 512) which, for example, may be operable to automatically and/or dynamically determine, assign, and/or report updated transaction status information based, for example, on the state of the transaction. In at least one embodiment, the status of a given transaction may be reported as one or more of the following (or combinations thereof): Completed, Incomplete, Pending, Invalid, Error, Declined, Accepted, etc.
Gateway Component(s) (e.g., 514) which, for example, may be operable to facilitate and manage communications and transactions with external Payment Gateways.
Web Interface Component(s) (e.g., 508) which, for example, may be operable to facilitate and manage communications and transactions with WagerWire web portal(s).
API Interface(s) to WagerWire system Server(s) (e.g., 546) which, for example, may be operable to facilitate and manage communications and transactions with API Interface(s) to WagerWire system Server(s)
API Interface(s) to 5rd Party System Server(s) (e.g., 548) which, for example, may be operable to facilitate and manage communications and transactions with API Interface(s) to 5rd Party System Server(s)
OCR Processing Engine (e.g., 534) which, for example, may be operable to perform image processing and optical character recognition of images such as those captured by a mobile device camera, for example.
At least one processor 510. In at least one embodiment, the processor(s) 510 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 516, which, for example, may include volatile memory (e.g., RAM), non-volatile memory (e.g., disk memory, FLASH memory, EPROMs, etc.), unalterable memory, and/or other types of memory. In at least one implementation, the memory 516 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein. Because such information and program instructions may be employed to implement at least a portion of the WagerWire system techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 506 which, for example, may include wired interfaces and/or wireless interfaces. In at least one implementation, the interface(s) 506 may include functionality similar to at least a portion of functionality implemented by one or more computer system interfaces such as those described herein and/or generally known to one having ordinary skill in the art.
Device driver(s) 542. In at least one implementation, the device driver(s) 542 may include functionality similar to at least a portion of functionality implemented by one or more computer system driver devices such as those described herein and/or generally known to one having ordinary skill in the art.
One or more display(s) 535. According to various embodiments, such display(s) may be implemented using, for example, LCD display technology, OLED display technology, and/or other types of conventional display technology. In at least one implementation, display(s) 535 may be adapted to be flexible or bendable.
Additionally, in at least one embodiment the information displayed on display(s) 535 may utilize e-ink technology (such as that available from E Ink Corporation, Cambridge, Mass., www.eink.com), or other suitable technology for reducing the power consumption of information displayed on the display(s) 535.
Email Server Component(s) 536, which, for example, may be configured or designed to provide various functions and operations relating to email activities and communications.
Web Server Component(s) 537, which, for example, may be configured or designed to provide various functions and operations relating to web server activities and communications.
Messaging Server Component(s) 538, which, for example, may be configured or designed to provide various functions and operations relating to text messaging and/or other social network messaging activities and/or communications.
Etc.

The various WagerWire techniques described herein provide an innovative digital marketplace where users can buy and sell online sports bets at any time before the outcome of the wager is determined. WagerWire contracts with licensed online sportsbook operators and users can only sell bets that were placed with a contracted operator.

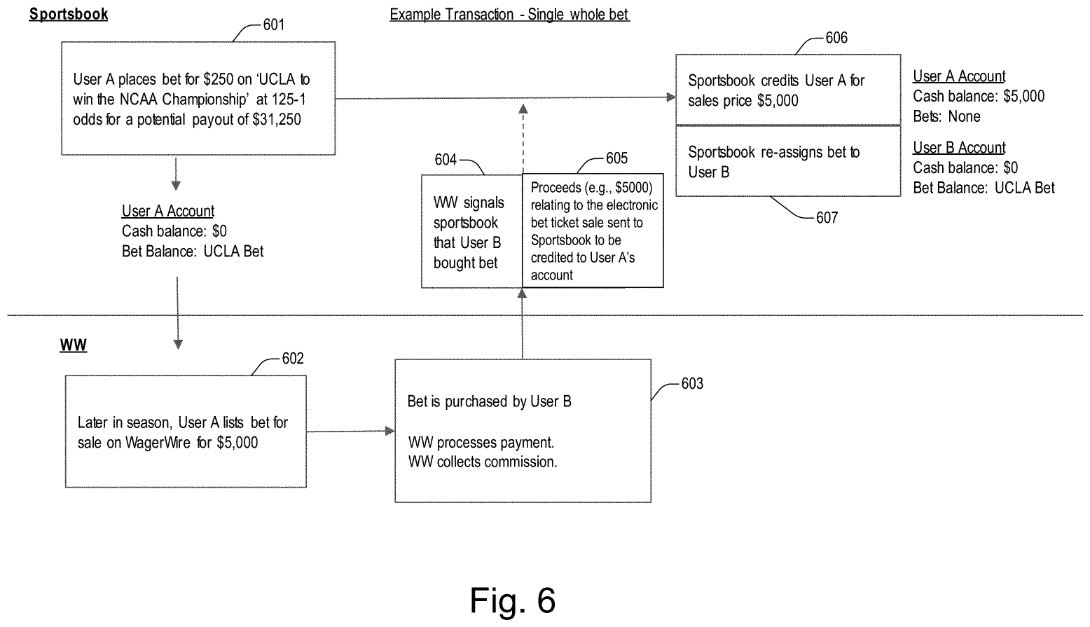

By way of illustration, the following walkthrough example is provided, with reference to FIGS. 6-9F of the drawings, to help illustrate some of the various features and functionalities of the WagerWire App, which may be implemented on mobile devices and/or other computing devices (e.g., via web browser).

### Example Walk-Through of Single Whole Bet Ticket Sale/Purchase Via WagerWire Marketplace

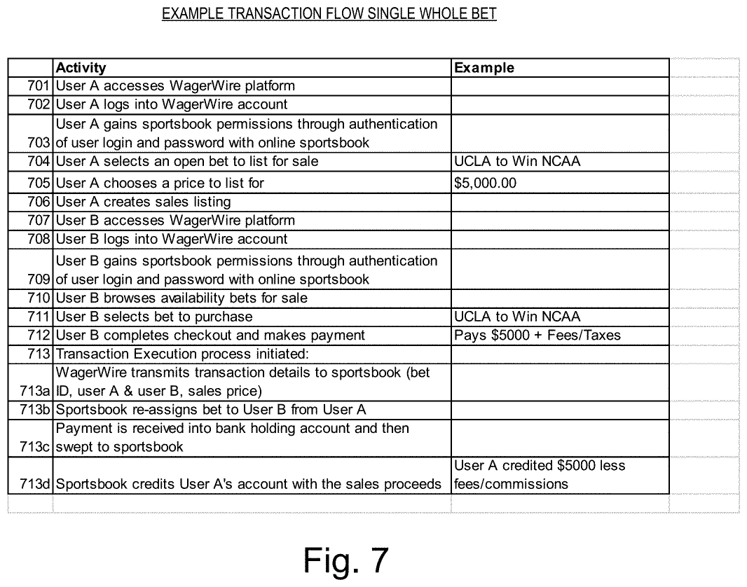

FIGS. 6-7 illustrate a simplified example walk-through embodiment of single whole bet ticket sale/purchase transaction flow which may be implemented via the WagerWire marketplace.

Referring first to FIG. 6, an example walk-through embodiment of single whole bet ticket sale/purchase transaction is illustrated. In this specific example, it is assumed that User A purchases a first electronic sports bet ticket via a first sportsbook entity, and executes a sale of the first electronic sports bet ticket to User B via an electronic ticket exchange marketplace such as, for example, a WagerWire marketplace hosted, for example, by the WagerWire system.

As shown at 601, User A places a bet for $250 on ‘UCLA to win the NCAA Championship’ at 125-1 odds for a potential payout of $31,250. The sportsbook system updates User A's account accordingly, assigning 100% ownership of the newly created sports bet ticket to User A.

Later in the season, User A lists (602) the electronic bet ticket for sale via WagerWire marketplace for $5,000.

As shown at 603, bet ticket is purchased by User B via WagerWire marketplace. In at least one embodiment, the WagerWire system handles processing of the payment from User B for executing the electronic bet ticket sale/exchange transaction. In at least some embodiments, the WagerWire marketplace may also collect a commission or fee for facilitating execution of this electronic bet ticket exchange transaction. According to different embodiments, commissioned/fees may be paid by User A, User B, and/or the Sportsbook entity originating the electronic bet ticket.

As shown at 604, the WagerWire system notifies Sportsbook that User B has acquired 100% ownership of the electronic bet ticket. Additionally, the WagerWire system causes (605) proceeds (e.g., $5000) relating to the electronic bet ticket sale to be sent to the Sportsbook to be credited to User A's account.

As shown at 606, the Sportsbook credits the received proceeds for the electronic bet ticket sale to User A's account. Additionally, Sportsbook system automatically re-assigns (607) 100% ownership of the electronic bet ticket to User B.

In at least some embodiments, as described in greater detail herein, the WagerWire system provides functionality for enabling fractional ownership sale of an existing electronic bet ticket. In at least one embodiment, the WagerWire marketplace enables User A to sell a fractional portion of his Sportsbook electronic bet ticket to User B. In one such embodiment where User B buys less than 100% ownership interest in User A's electronic bet ticket, the WagerWire system may record the respective ownership interests of both User A and User B with respect to the identified Sportsbook electronic bet ticket, and may provide such ownership interest information to the Sportsbook system in order to cause the Sportsbook system to automatically update its database to record the respective ownership interests of both User A and User B with respect to the identified Sportsbook electronic bet ticket.

FIG. 7 illustrates a simplified example embodiment showing various activities, actions, steps and/or operations which may occur with respect to the single whole bet ticket sale/purchase transaction example of FIG. 6.

FIGS. 8A-F and 9A-F illustrate example WagerWire GUI screenshots which may be generated and displayed on User A's and User B's respective mobile devices in connection with the single whole bet ticket sale/purchase transaction example of FIG. 6. In at least one embodiment, at least a portion of the WagerWire GUIs may be generated via a respective WagerWire Application running on User A's and User B's respective mobile devices and/or other computing devices (e.g., via web browser).

By way of illustration in FIGS. 7, 8A-F and 9A-F:

### Seller-Side Activity (Seller=User A) May Include:

User A accesses WagerWire platform (701, 8A)
User A logs into WagerWire account (702, 8B)
User A gains sportsbook permissions through authentication of user login and password with online sportsbook (703, 8C). In at least one embodiment, this step may occur before or during checkout.
User A selects an open bet to list for sale (e.g., UCLA to Win NCAA) (704, 8D)
User A configures pricing parameters (e.g., $5000) (705, 8E). In at least one embodiment, the WagerWire system may include functionality for dynamically calculating and recommending suggested prices and/or for providing dynamic pricing functionality.
User A creates sales listing (706, 8F)

### Buyer-Side Activity (Buyer=User B) May Include:

User B accesses WagerWire platform (707, 9A)
User B logs into WagerWire account (708, 9B)
User B gains sportsbook permissions through authentication of user login and password with online sportsbook (709, 9C)
User B browses availability bets for sale (710, 9D)
User B selects bet to purchase (e.g., UCLA to Win NCAA) (711, 9E)
User B completes checkout and makes payment (e.g., Pays $5000+taxes+fees/commissions) (712, 9F). In at least one embodiment, may be implemented as direct point of sale transaction (credit/debit card, etc) and/or with pre-loaded funds.
   System Activities (e.g., WagerWire system and/or Sportsbook system) may include:
Transaction Execution process initiated (713):
   WagerWire transmits transaction details to sportsbook (data may include, for example, Bet ID, User A ID & User B ID, sales price, etc.) (713a)
   Sportsbook re-assigns bet to User B from User A (713b) (whole bet sale example)
   Payment is received into bank holding account and then swept to Sportsbook (713c)
   Sportsbook credits User A's account with the sales proceeds (713d)

### Example Walk-Through of WagerWire Application

Many of the features, functions, and benefits of the various WagerWire electronic bet ticket exchange techniques disclosed herein may be accessed and executed via interaction with a WagerWire application, which provides a plurality of graphical user interfaces (GUIs) for facilitating user interaction with the WagerWire system as well as Sportsbooks and/or other wagering systems/networks. In some embodiments, at least a portion of the WagerWire GUIs disclosed herein may be generated via a respective WagerWire Application running on a user's mobile device and/or other computing devices (e.g., via web browser).

In at least one embodiment, when a user accesses the WagerWire application (e.g., WagerWire mobile app), a Homepage GUI may be displayed which highlights the best available deals as well as live games and upcoming scheduled games. Users can also keep tabs on their favorite teams, and review advanced analytics via one or more WagerWire GUIs. For example, a user that is interested in buying one or more existing NFL electronic bet tickets could navigate to an NFL page GUI. Here the user may view the NFL games currently in play and can browse all different types of NFL electronic bet ticket purchasing opportunities offered from various sellers in the WagerWire marketplace. In at least some embodiments, presentation of at least a portion of the available NFL bets may be sorted based on WagerWire deal score values. In at least one embodiment, the WagerWire system may include functionality for automatically and/or dynamically calculating WagerWire deal score values for one or more electronic bet ticket wagering opportunities. In one embodiment, the WagerWire application may automatically navigate the user to a listings page which displays the average sportsbook odds versus what listings are available to buy via the WagerWire system.

For purposes of illustration, it is assumed that the user scrolls through the electronic bet ticket offerings listed on the Hottest Deals GUI, and selects a bet type he wishes to purchase (e.g., “Baylor to win NCAA Championship”). The user selects the listing to purchase and advances to an electronic bet ticket details page to review the details of the bet, the purchase price, fee, etc. In at least one embodiment, the user can make an offer below the listing price or buy it now at full price. In the present example, it is assumed that the user selects to buy now at full price.

In at least one embodiment, to complete checkout, the user may be required to be registered with the online Sportsbook entity that originated the selected electronic bet ticket (e.g., Bally). In at least one embodiment, the WagerWire app displays a Sportsbook Login/Registration GUI, which enables the user to either sign in to their Bally Bet sports book account (e.g., if the user is already registered with Bally Sportsbook), or instantly create a Bally Sportsbook account. In one embodiment, the on-boarding process to sign up a new user with one or more online Sportsbook entities may be facilitated by the WagerWire system by auto-populating forms with the user's WagerWire account information.

After the user has signed in to his/her online Sportsbook account, the user can complete the purchase of their selected electronic bet ticket, and the electronic bet ticket may then be re-assigned into the user's Bally Sportsbook account. Thereafter, the user may choose to re-list it for sale on WagerWire, in whole or in part, or hold the electronic bet ticket through maturity.

In at least some embodiments, the user may receive promotional credits or other rewards for transactions that meet certain parameters. These credits and rewards can be viewed and tracked on the user's profile page. The profile page also has links to the user's portfolio of bets, betting history, bet watchlist, and social interactions.

Using the WagerWire application, the user may navigate to their WagerWire portfolio page to view all his open bets across all contracted, thereby serving as a universal wallet for electronic bet tickets.

In at least some embodiments, a WagerWire Portfolio GUI functionality is configured to track and display information relating to the user's open bets across all contracted sportsbooks, including, for example the total or aggregated amount wagered across all of the user's active bets (e.g., amount wagered), as well as the market value of what the user's bets would be worth to sell now (e.g., present market value).

In at least one embodiment, the WagerWire system is configured or designed to include functionality for enabling the user to sell one or more of his open wagers via the WagerWire marketplace (e.g., also referred to herein as “WagerWire exchange” or “WagerWire electronic bet ticket exchange”). For example, the user may select an electronic bet ticket from his portfolio (e.g., “UCLA to Win NCAA Championship”) to initiate an electronic bet ticket sale offer listing (e.g., or listing offer) process.

The WagerWire system includes automated functionality for dynamically determining and suggesting a recommended price of what the electronic bet ticket is worth, which the user can accept or select his own price. The user can also choose to sell only a fraction of his bet, for example, if the user wants to recoup his initial bet amount but retain a portion of the upside. In the present example, the user selects to sell the entire bet (e.g., 100%). The user may receive promotional credits or other rewards for transactions that meet certain parameters.

After listing the electronic bet ticket for the sale, the user returns to the portfolio page and sees his bet is now marked as listed on the WagerWire marketplace. When a second user purchases the bet, the first user is notified, and the sales price is credited into his sportsbook account.

The user can navigate to a Transaction History GUI to view all his past activity and accumulated results. The user can also visit the social feed to interact with other users and share about his bets. The user can also set alerts and track interesting bets in on his watchlist.

### Example Embodiments of WagerWire Graphical User Interfaces (GUIs)

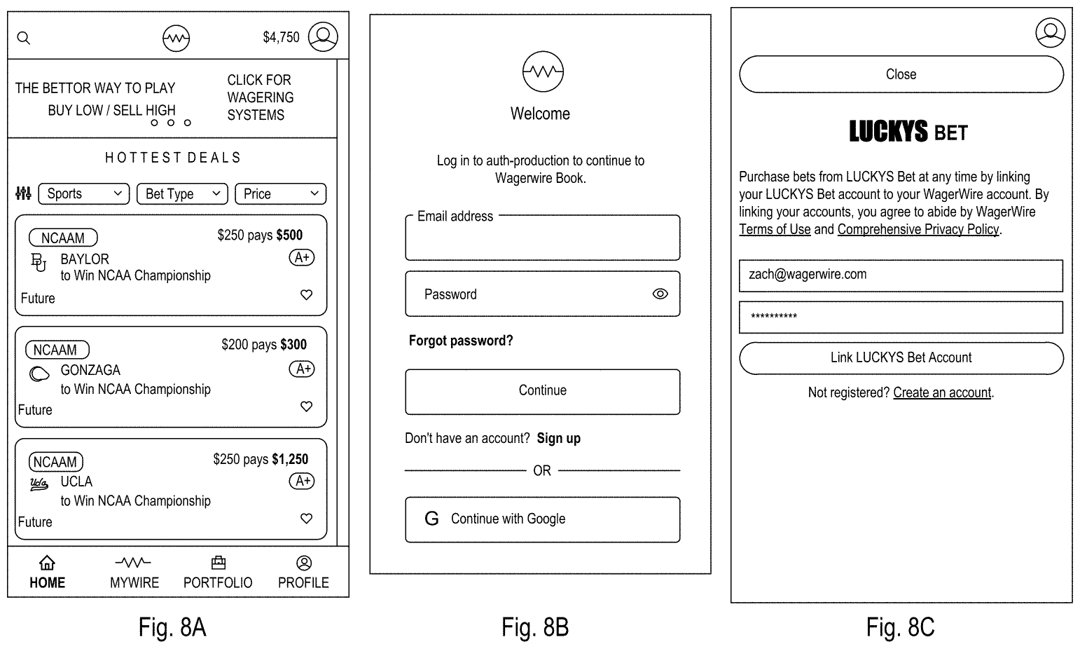

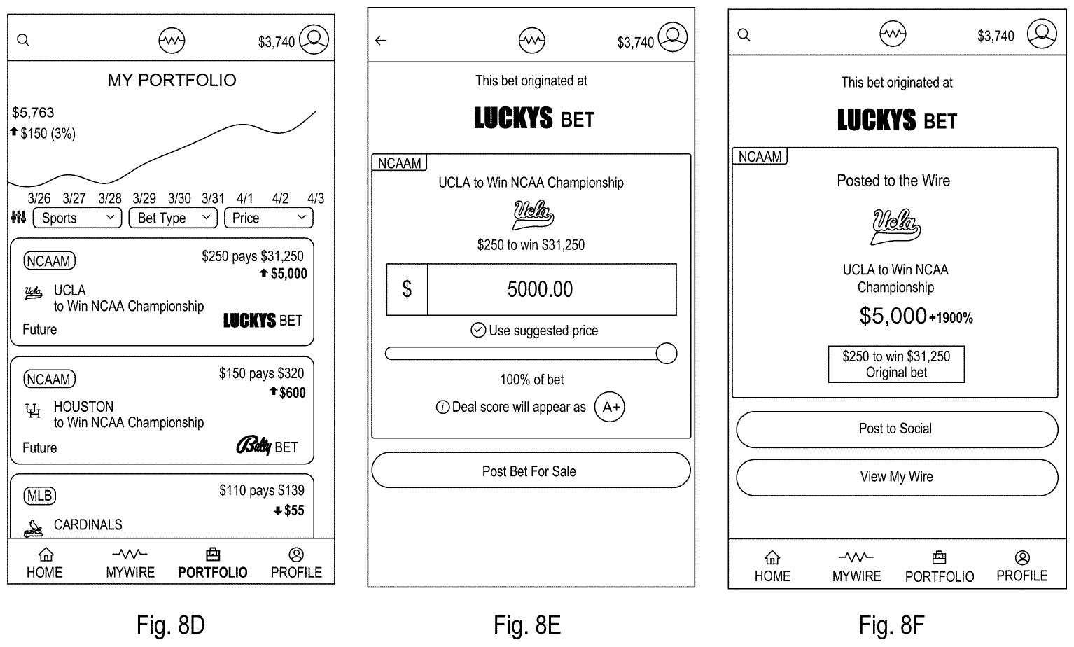

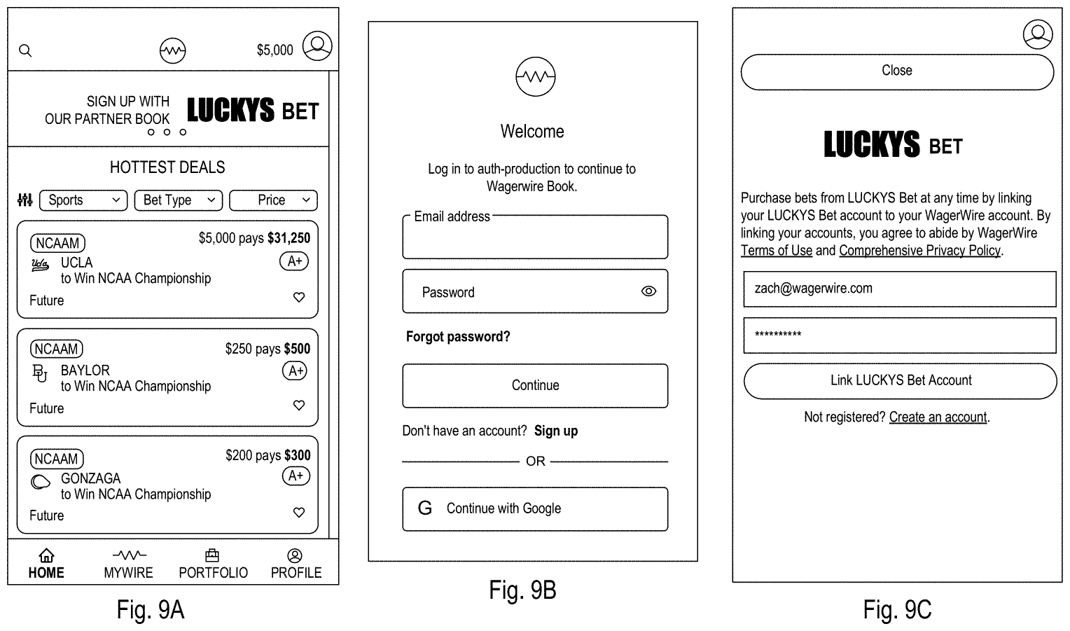

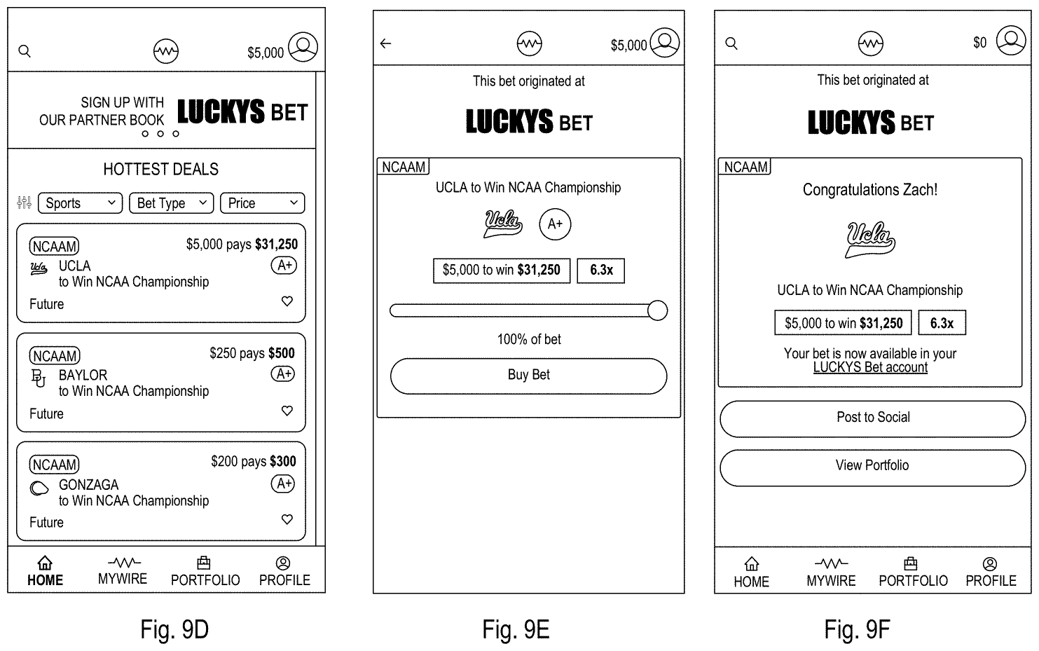

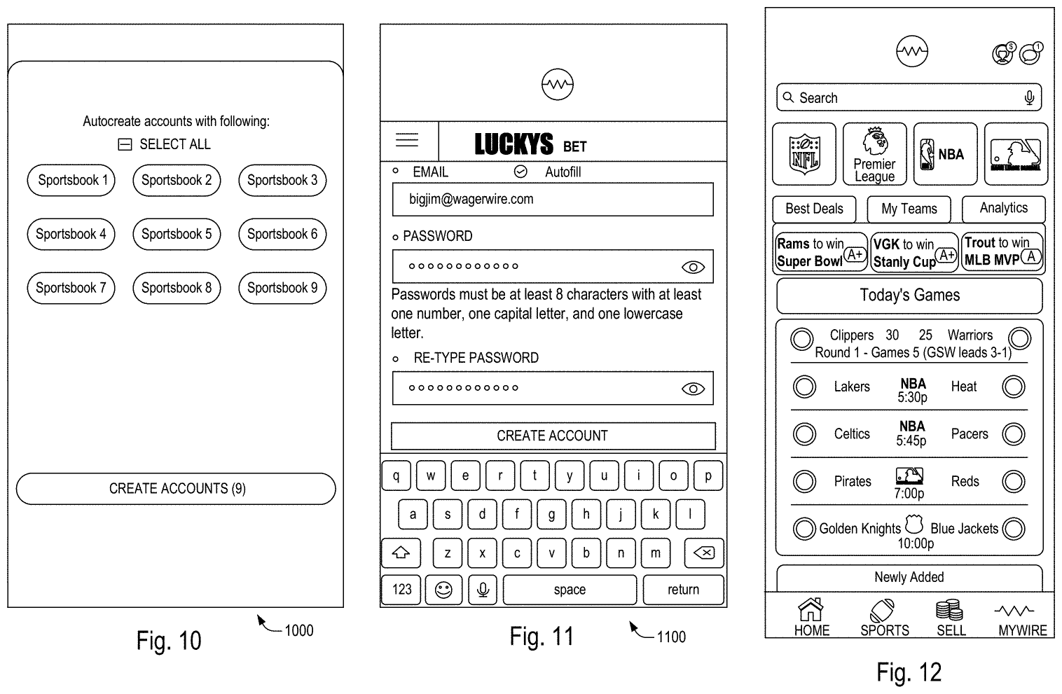

FIGS. 10-27 illustrate example screenshots of various GUIs which may be used for facilitating activities relating to one or more of the electronic bet ticket exchange aspects disclosed herein. In at least one embodiment, at least a portion of the GUIs may be configured or designed for use at one or more mobile devices.

In some embodiments, a WagerWire application may be installed on an end user's mobile device or smartphone, and used to access an online WagerWire marketplace which is configured or designed to facilitate the sale, purchase, and/or exchange of electronic bet tickets originating from one or more different Sportsbook entities (such as, for example, Caesar's, Bally's, Wynn, etc.).

In some embodiments, the WagerWire marketplace may be implemented and presented to end-users as a third-party marketplace which is separate from the Sportsbook entities. Users may access the WagerWire marketplace via the WagerWire application, and may create/log-in to their WagerWire account.

In other embodiments, functionality provided by the WagerWire system for facilitating the sale, purchase, and/or exchange of electronic bet tickets may be integrated into one or more Sportsbook mobile applications in manner which is transparent to the end-user. In at least some of such embodiments, the end user may be unaware that at least a portion of the electronic bet ticket exchange functionality (and GUIs) provided by the Sportsbook mobile application is being handled by the WagerWire system.

In at least some embodiments, the WagerWire application may include functionality for enabling an end-user to link their WagerWire account to one or more Sportsbook accounts associated with that user. For example, FIGS. 10 and 11 illustrate example screenshots of GUIs which may be provided by the WagerWire application to enable an end-user to link their WagerWire account to one or more Sportsbook accounts associated with that user.

For example, the example GUI embodiment of FIG. 10 provides functionality for facilitating automated processes for registering accounts for a single user across multiple sportsbooks with a single sign-up form. In at least one embodiment, a user may interact with the GUI 1000 to initiate account registration processes with one or more Sportsbook entities. Illustrative examples of activities which may be performed via interaction with GUI 1000 may include:
User is prompted to create a username and password.
User is prompted to submit personal information, which, for example, may include: User's first & last name, email address, phone number, mailing address, date of birth, last 4 digits of social security number, answers to selected security questions, etc.
User authorizes WagerWire system to automatically initiate and complete registration account(s) at WagerWire's partner Sportsbooks for which the user does not already have an account.
User acknowledges and accepts the terms and conditions of each Sportsbook.
Following completion of forms, the system uses encryption technology to securely transmit the user's personal information to each Sportsbook.
Accounts are registered at each Sportsbook in the user's name.

The example GUI embodiment of FIG. 11 provides functionality for facilitating streamlined account registration by pre-populating forms with the user's information that is securely stored. Illustrative examples of activities which may be performed via interaction with GUI 1100 may include:
During initial sign up to WagerWire, the user submits personal information, which, for example, may include: User's first & last name, email address, phone number, mailing address, date of birth, last 4 digits of social security number, answers to selected security questions, etc.
WagerWire system utilizes encryption technology to securely store the user's account information.
Subsequently when the user attempts to register a sportsbook account on the WagerWire platform, the system will auto-populate the forms to provide a streamlined user experience.

In one embodiment, when creating a new Sportsbook account, WagerWire may auto-populate the Sportsbook login/signup forms with the user's personal information (e.g., stored in the user's WagerWire account profile). After the user's new Sportsbook account has been created, WagerWire system may automatically and dynamically take appropriate action to link the user's new Sportsbook account with the user's WW account, and enable the user to proceed with purchase of the desired electronic bet ticket. In at least one embodiment, once the electronic bet ticket purchase transaction has been completed, the WagerWire system may take appropriate action to cause the purchased electronic bet ticket to be recorded in the user's newly created Sportsbook account.

FIGS. 12-27 illustrate additional example screenshots of various GUIs which may be generated by the WagerWire system and/or WagerWire application and used for facilitating activities relating to one or more of the electronic bet ticket exchange aspects disclosed herein.

FIG. 12 shows an example embodiment of a screenshot of a Homepage GUI 1200. In at least one embodiment, the Homepage GUI may be configured as a main landing page for the WagerWire application, where system presents the hottest deals, today's games, live games, content, and more. Various features and functionality of the Homepage GUI 1200 may include, for example:
Buttons for navigating to specific league and sport landing pages.
Tabs for navigating to best deals, my favorite teams, and analytics.
Functionality for presenting the hottest deals & popular bet listings.
Functionality for displaying today's games with all live games highlighted.
Functionality for displaying new or recently added bet listings.
And/or other information.

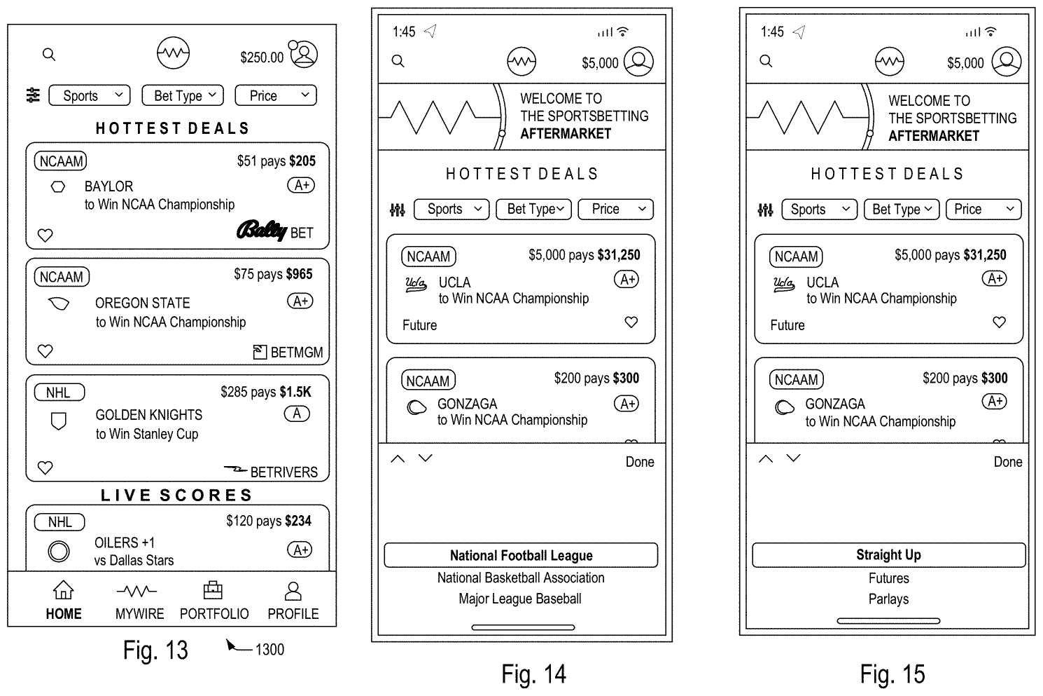

FIG. 13 shows an alternate embodiment of an example screenshot of a Homepage GUI embodiment 1300. Various features and functionality of the Homepage GUI may include, for example:
Info banner rotating content, promotions, and ads for sportsbook partners.
Functionality for enabling electronic bet ticket listings to be displayed and sorted into categories.
Functionality for displaying electronic bet ticket listing details, such as, for example: bet type, sport, league, team, event, market, price, payout, deal score (e.g., based upon relative value to the consensus odds amongst Sportsbooks), etc.
Functionality for enabling electronic bet ticket listings to be added to a user's watchlist.

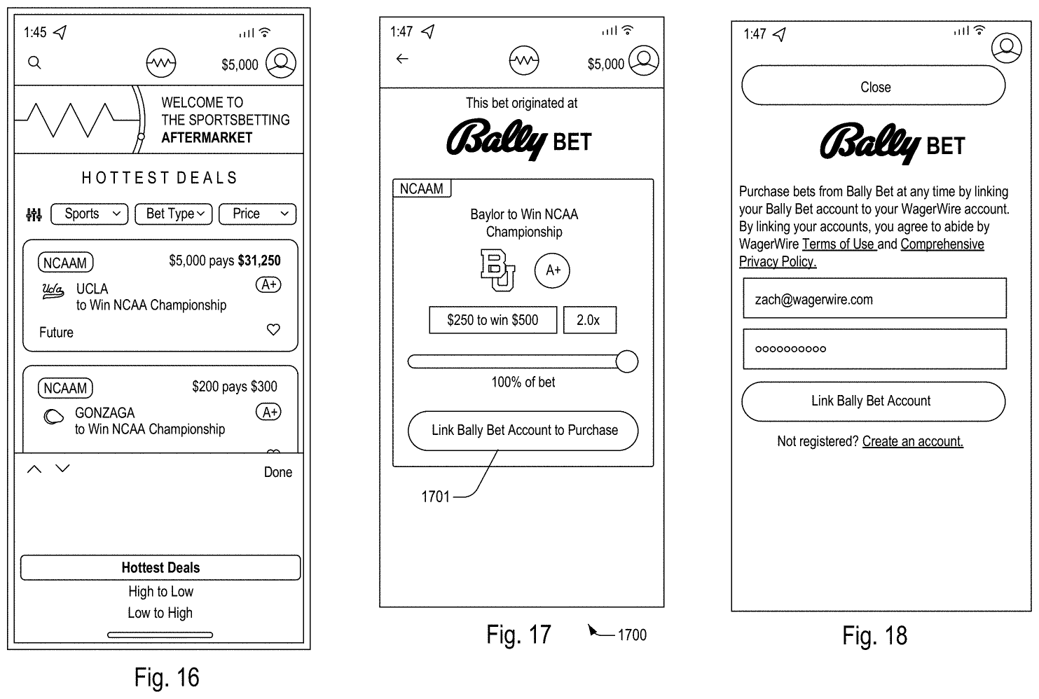

In at least one embodiment, the Homepage GUI may be configured or designed to include functionality for enabling the electronic bet ticket sales listings to be filtered or sorted according to different criteria, such as, for example, by sport (e.g., FIG. 14), bet type (e.g., FIG. 15), price (high to low/low to high), hottest deals (e.g., FIG. 16), etc.

FIG. 17 shows an example screenshot of an Electronic Bet Ticket Details GUI 1700. Various features and functionality of the Electronic Bet Ticket Details GUI 1700 may include, for example:
System displays the details of a selected electronic bet ticket. In the example embodiment of FIG. 17, it is assumed that the electronic bet ticket originated from a first Sportsbook entity (e.g., Bally Bet™), and that the WagerWire system has not yet established an authorized connection (or link or sync) with the user's Bally Bet™ account. In at least one embodiment, to initiate a purchase of the electronic bet ticket, the system may be required to obtain authorization from the user to establish a link (or sync) with the user's Bally Bet™ account, which, for example, may be initiated by the user engaging with the “Link Bally Bet Account to Purchase” button 1701.
Display information relating to the user's account balance(s) & profile(s). In some embodiments, the WagerWire system may be configured or designed to include functionality for retrieving user account information and profile information from linked/synced sportsbook accounts, and the WagerWire application may be configured or designed to include functionality for enabling the user to view user account information and/or profile information associated with the user's WagerWire account and/or associated with one or more linked/synced sportsbook accounts.
Displayed information indicating sportsbook of origin for identified electronic bet ticket.
Electronic bet ticket details displayed, such as, for example: event, market, risk amount, payout, odds, etc.
Fractional buy slider for enabling prospective buyer to configure and submit a buy offer (or buy counteroffer) to purchase a whole or fractional interest in the identified electronic bet ticket.

FIG. 18 shows an example screenshot of a Sportsbook Account Access GUI, which, for example, may be displayed or accessed on occasions when the user may need to connect or link to one of the user's sportsbook accounts. In the specific example embodiment of FIG. 18, the Sportsbook Account Access GUI prompts the user to provide the user's sportsbook account username and password to authenticate and authorize the user for sell/buy/purchase activity via the WagerWire system. Various other features and functionality of the Sportsbook Account Access GUI may include, for example:
iFrame popup window or overlay layer providing a user interactive or form for enabling the user to link to the user's sportsbook account.
Form to input username and password, which, for example, may be autofilled by the system if returning user.
Button to authorize linking of sportsbook account.
Upon submission of form, credentials are passed to the sportsbook for authentication & authorization to allow user to engage in buy/sell transactions via the WagerWire marketplace and on behalf of the user's sportsbook account.
Create an account link for enabling the user to create a new account at the identified sportsbook, if the user does not already have an account with that sportsbook.

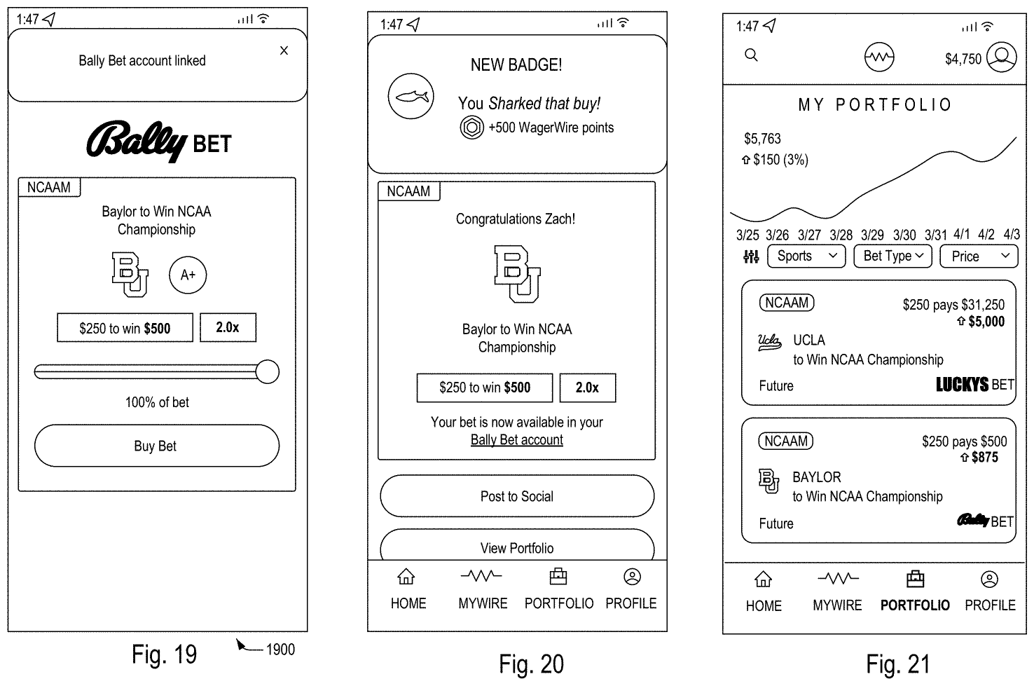

FIG. 19 shows an example screenshot of an Electronic Bet Ticket Checkout GUI 1900. Various features and functionality of the Electronic Bet Ticket Checkout GUI may include, for example:
System displays the details of a selected electronic bet ticket. In the example embodiment of FIG. 19, it is assumed that the electronic bet ticket originated from a first Sportsbook entity (e.g., Bally Bet™), and that the WagerWire system has established an authorized connection (or link or sync) with the user's Bally Bet™ account. Users that have already synced their sportsbook account are permitted to initiate checkout.
Notification for successfully syncing sportsbook account.
Electronic bet ticket details displayed, such as, for example: event, market, risk amount, payout, odds, etc.
Fractional buy slider for enabling prospective buyer to configure and submit a buy offer (or buy counteroffer) to purchase a whole or fractional interest in the identified electronic bet ticket.
“Buy Bet” Button for enabling the user to initiate a buy or purchase transaction of the identified electronic bet ticket.

FIG. 20 shows an example screenshot of an Electronic Bet Ticket Purchase Confirmation GUI, which, for example, may be displayed after the system executes the checkout process and transaction settlement is completed. Various features and functionality of the Electronic Bet Ticket Purchase Confirmation GUI may include, for example:
Notification of completed electronic bet ticket purchase.
Electronic bet ticket purchase transaction details.
Notification of badges and/or points earned (e.g., for gamification)
Buttons that facilitate posting to third party apps and sharing via sms, web, or within the WagerWire app.
Bottom nav bar for enabling quick and easy access to other WagerWire application GUIs such as, for example, Home, My Wire, Portfolio, Profile, History, Messages, etc.

FIG. 21 shows an example screenshot of a User Portfolio GUI. In at least one embodiment, the User Portfolio GUI may be configured or designed to include functionality for displaying some or all of the user's open electronic bet tickets across all synced sportsbooks. In at least some embodiments, the WagerWire system may be configured or designed to include functionality for tracking, analyzing, and displaying information (e.g., including analytical data, graphs, charts, and other visualizations) relating to the user's open electronic bet tickets across all synced sportsbooks. Various features and functionality of the User Portfolio GUI may include, for example:
Top navigation bar for enabling quick and easy access to other WagerWire application GUIs such as, for example, search, account balance(s), user profile(s), Home page, etc.
Portfolio value tracker functionality, which may be configured or designed to include functionality for analyzing, calculating and displaying the current or real-time market value of the user's electronic bet ticket positions across some or all synced sportsbooks.
   Functionally for displaying change in value of user's portfolio over specified time period(s)
   Functionally for providing the user with notifications, indicators and calls to action.
Functionality for listing all of the users electronic bet ticket holdings across multiple synced sportsbooks. In at least one embodiment, each displayed electronic bet ticket record may include the name or logo of the originating sportsbook, current market price, change in value in last 24 hrs, percentage of ownership held by the user, etc.

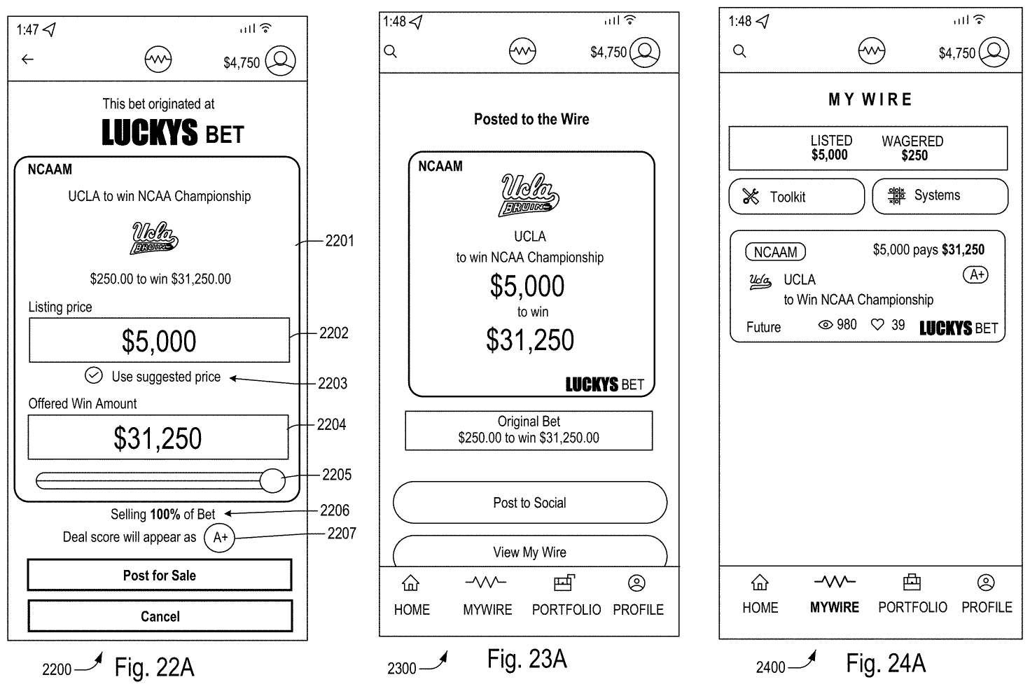

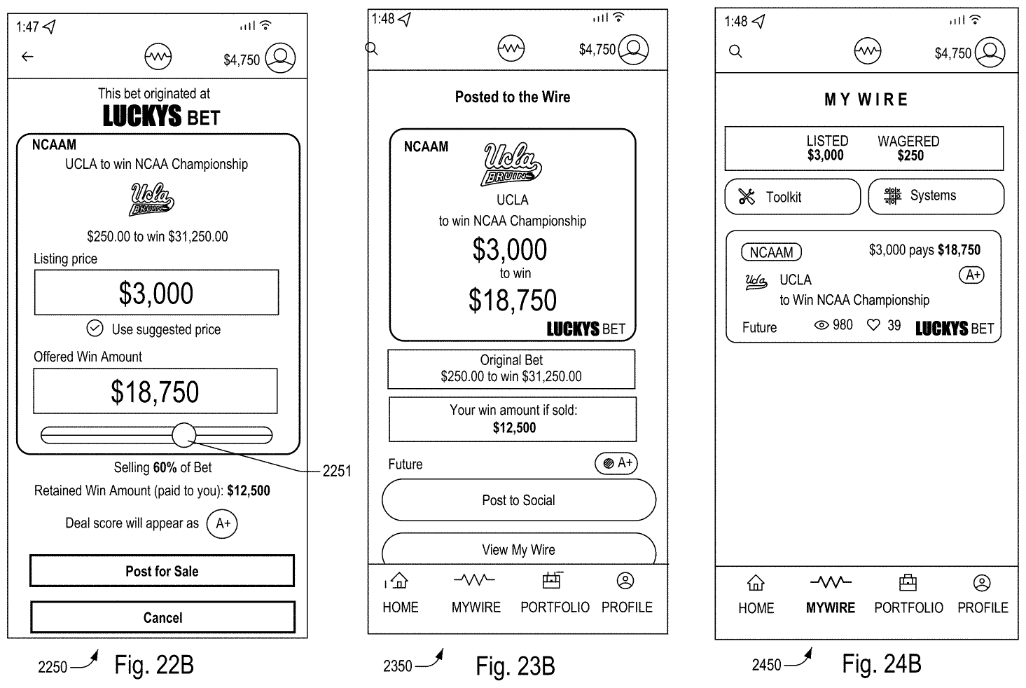

FIGS. 22A, 23A and 24A show example screenshots of various WagerWire application GUIs which may be configured or designed to provide functionality for enabling a user to post, view, and manage details relating to one or more electronic bet ticket sale listings and/or offers initiated by the user. In the specific example embodiments of FIGS. 22A, 23A and 24A, it is assumed that the user has initiated a “whole bet” sale offer to purchase 100% of an identified electronic bet ticket.

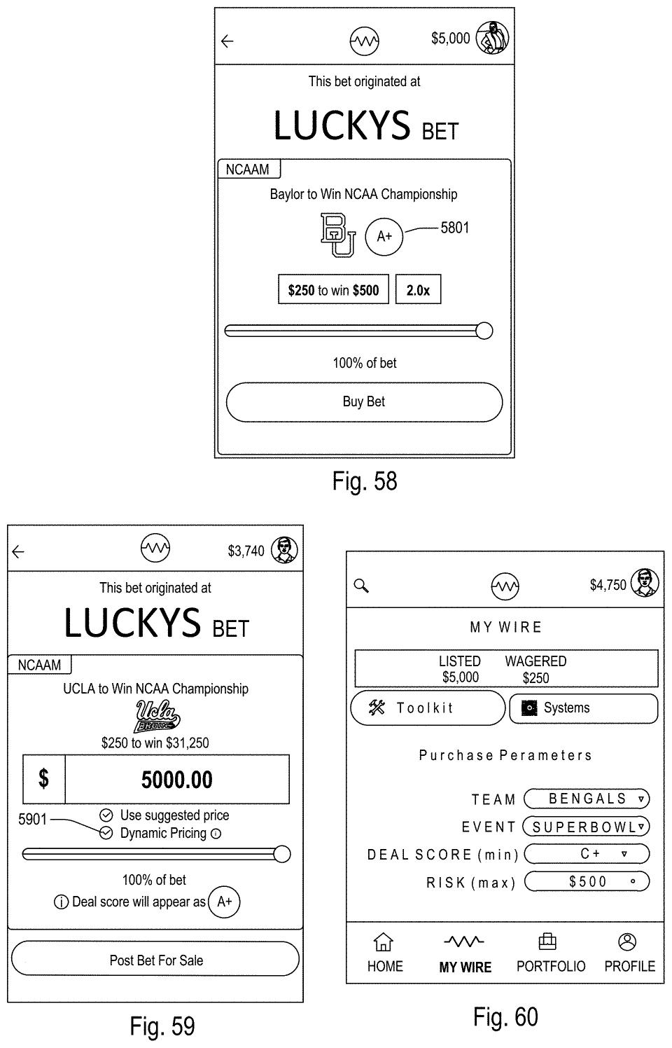

FIG. 22A shows an example screenshot of an Offer Configuration GUI 2200. In at least one embodiment, the Offer Configuration GUI may be configured or designed to include functionality for enabling the user to post a listing or offer for selling a selected electronic bet ticket owned by the user at one or more synced sportsbook accounts. Various features and functionality of the Offer Configuration GUI may include, for example:
Functionality for displaying details of the identified electronic bet ticket, and for enabling the user to initiate posting of the electronic bet ticket for sale, for example, via a WagerWire powered electronic bet ticket exchange marketplace and/or via other electronic bet ticket exchange marketplaces.
Top navigation bar for enabling quick and easy access to other WagerWire application GUIs such as, for example, search, account balance(s), user profile(s), Home page, etc.
Displayed information indicating sportsbook of origin for identified electronic bet ticket.
Listing interface 2201 for enabling the user to configure various parameters of the electronic bet ticket listing, such as, for example, offer price, win amount, percentage of ownership interest offered for sale, offer expiration, and/or other parameters. In at least one embodiment, the listing interface may include:
   Listing offer price field 2202 which is configurable by the user.
   “Suggested price” checkbox 2203 which may be configured or designed to provide functionality for enabling the user to optionally elect to have the system suggest an offer price which is dynamically determined (e.g., in real-time) by the WagerWire system. Additional details relating to the automated suggested price functionality are described in greater detail herein, for example, with respect to FIG. 27.
   Offered Win Amount field 2204 which is configurable by the user. In at least one embodiment, the WagerWire application may restrict or limit the range of values which may be entered into the Offered Win Amount field such that the maximum permissible value does not exceed the win amount value of the electronic bet ticket being offered for sale. For example, in the example of FIG. 22A, the win amount value of the electronic bet ticket being offered for sale is $31,250. Accordingly, in at least one embodiment, the system may be configured or designed to not accept Offered Win Amount values exceeding $31,250.
   Fractional slider 2205, which may be configured or designed to include functionality for enabling the user to configure the electronic bet ticket listing as either a “whole bet” sale offer to purchase 100% of the electronic bet ticket, or as a “fractional bet” sale offer to purchase a fractional ownership portion (e.g., less than 100%) of the electronic bet ticket. In at least one embodiment, the user may use the slider button 2205 to quickly and easily adjust the offered win amount value. In the specific example embodiment of FIG. 22A, if the value of the offered win amount is equal to the full win amount of the original electronic bet ticket (e.g., $31,250), the electronic bet ticket listing may be classified as a “whole bet” sale offer. Alternatively, if the value of the offered win amount is less than the full win amount of the original electronic bet ticket (e.g., $31,250), the electronic bet ticket listing may be classified as a “fractional bet” sale offer. In at least one embodiment, fractional slider button 2205 may be used to adjust the percentage of ownership interest in the electronic bet ticket being offered for sale. In at least some embodiments, the Offer Configuration GUI may be configured or designed to include functionality for automatically and dynamically populating the values of the listing offer price and/or offered win amount in response to the user engaging with the fractional slider button 2205, for example, as the user slides the slider button to the left/right.
Percentage details 2206 representing a percentage of the electronic bet ticket being offered for sale. In at least one embodiment, the percentage value may be dynamically calculated by the WagerWire application using data relating to the active electronic bet ticket, the relative position of the fractional slider button, and/or the offered win amount value.
Deal score details 2207. In at least one embodiment, the WagerWire system may be configured or designed to include functionality for automatically and/or dynamically calculating (e.g., in real-time) a “Deal Score” value which may be used to represent how good of a “deal” this prospective electronic bet ticket sale offer is relative to other electronic bet ticket sale offers in the marketplace. Additional details relating to the Deal Score functionality are described in greater detail herein, for example, with respect to FIG. 58.
“Post bet for sale” button

FIG. 23A shows an example screenshot of an Offer Posting Confirmation GUI 2300. In at least one embodiment, the Offer Posting Confirmation GUI may be configured or designed to include functionality for verifying and signaling confirmation that the user's electronic bet ticket offer has been posted to the electronic bet ticket exchange marketplace. Various features and functionality of the Offer Posting GUI may include, for example:
Top navigation bar for enabling quick and easy access to other WagerWire application GUIs such as, for example, search, account balance(s), user profile(s), Home page, etc.
Displayed information confirming that the electronic bet ticket sale listing has been posted to the electronic bet ticket exchange marketplace.
Displayed information indicating sportsbook of origin for electronic bet ticket offer listing.
Displayed details about the newly posted listing, including, for example: event, market, buy amount, win amount, originating sportsbook, % gain for user if sold at listed price, and/or other related data.
Displayed details about the originating electronic bet ticket.
Buttons for enabling user to initiate “Post to Social” activities and/or “View My Wire” activities.
Bottom nav bar for enabling quick and easy access to other WagerWire application GUIs such as, for example, Home, My Wire, Portfolio, Profile, History, Messages, etc.

FIG. 24A shows an example screenshot of a My Wire GUI 2400. In at least one embodiment, the My Wire GUI may be configured or designed to include functionality for accessing and displaying all the users active electronic bet ticket offerings currently listed across one or more electronic bet ticket marketplace(s). For example, in at least one embodiment, the My Wire GUI may display all the users active electronic bet ticket offerings currently listed on the WagerWire marketplace and other marketplaces associated with one or more linked/synced sportsbook accounts. Additionally, in at least some embodiments, the My Wire GUI may be configured or designed to include functionality for enabling the user to view and track statistics and to perform analytics relating to one or more of the user's electronic bet ticket offerings. In some embodiments, the My Wire GUI may provide links for enabling the user to access various content, betting systems, and/or betting tools such as conditional purchases.

Various features and functionality of the My Wire GUI may include, for example:
Top display shows user statistics such as listed bets and original amount(s) wagered
Toolkit Button for enabling user to create personalized notifications, conditional purchases, etc.
Systems Button for providing the user with access to analytical content and tips on how to maximize profits using the WagerWire system.
List of active electronic bet ticket offerings and related details. In at least some embodiments, the list of offerings displayed may include electronic bet ticket sale offerings and/or electronic bet ticket buy offerings initiated by the user. As illustrated in the example embodiment of FIG. 24A, the displayed list of the user's electronic bet ticket offerings is shown to include the fractional bet sale offering which was posted in FIG. 23A.

FIGS. 22B, 23B and 24B show example screenshots of alternate embodiments of WagerWire application GUIs which may be configured or designed to provide functionality for enabling a user to post, view, and manage details relating to one or more electronic bet ticket sale listings and/or offers initiated by the user. In the specific example embodiments of FIGS. 22B, 23B and 24B, it is assumed that the user has initiated a “fractional bet” sale offer for a prospective buyer to purchase a fractional ownership portion (e.g., less than 100%) of an identified electronic bet ticket.

FIG. 22B shows an example screenshot of an Offer Configuration GUI 2250. In at least one embodiment, the Offer Configuration GUI may be configured or designed to include functionality for enabling the user to post a listing or offer for selling a selected electronic bet ticket owned by the user at one or more synced sportsbook accounts. Various features and functionality of the Offer Configuration GUI may include, for example:
Functionality for displaying details of the identified electronic bet ticket, and for enabling the user to initiate posting of the electronic bet ticket for sale, for example, via a WagerWire powered electronic bet ticket exchange marketplace and/or via other electronic bet ticket exchange marketplaces.
Top navigation bar for enabling quick and easy access to other WagerWire application GUIs such as, for example, search, account balance(s), user profile(s), Home page, etc.
Displayed information indicating sportsbook of origin for identified electronic bet ticket.
Listing interface for enabling the user to configure various parameters of the electronic bet ticket listing, such as, for example, offer price, win amount, percentage of ownership interest offered for sale, offer expiration, and/or other parameters. In at least one embodiment, the listing interface may include:
   Listing offer price field which is configurable by the user.
   “Suggested price” checkbox which may be configured or designed to provide functionality for enabling the user to optionally elect to have the system suggest an offer price which is dynamically determined (e.g., in real-time) by the WagerWire system.
   Offered Win Amount field which is configurable by the user, for example, via manual numeric entry, or by specifying a percentage of the total win amount.
   Fractional slider 2251, which may be configured or designed to include functionality for enabling the user to configure the electronic bet ticket listing as either a “whole bet” sale offer to purchase 100% of the electronic bet ticket, or as a “fractional bet” sale offer to purchase a fractional ownership portion (e.g., less than 100%) of the electronic bet ticket. In at least one embodiment, the user may use the slider button 2251 to adjust the offered win amount value and/or the percentage of the electronic bet ticket being offered for sale. In the specific example embodiment of FIG. 22B, it is assumed that the user has positioned the fractional slider button such that the offered win amount value is set at $18,750, representing a “fractional bet” sale offer. In some embodiments, the fractional slider button may be used to adjust the percentage of ownership interest in the electronic bet ticket being offered for sale. Additionally, in some embodiments, the WagerWire application may be configured or designed to include functionality for automatically and dynamically calculating and populating the values of the listing offer price and/or offered win amount in response to the user engaging with the fractional slider button.
Percentage details representing a percentage of the electronic bet ticket being offered for sale (e.g., 60% in FIG. 22B). In at least one embodiment, the percentage value may be dynamically calculated by the WagerWire application using data relating to the active electronic bet ticket, the relative position of the fractional slider button, and/or the offered win amount value.
Deal score details. In at least one embodiment, the WagerWire system may be configured or designed to include functionality for automatically and/or dynamically calculating (e.g., in real-time) a “Deal Score” value which may be used to represent how good of a “deal” this prospective electronic bet ticket sale offer is relative to other electronic bet ticket sale offers in the marketplace.
“Post bet for sale” button

FIG. 23B shows an example screenshot of an Offer Posting Confirmation GUI 2350. In at least one embodiment, the Offer Posting Confirmation GUI may be configured or designed to include functionality for verifying and signaling confirmation that the user's electronic bet ticket offer has been posted to the electronic bet ticket exchange marketplace. Various features and functionality of the Offer Posting GUI may include, for example:
Top navigation bar for enabling quick and easy access to other WagerWire application GUIs such as, for example, search, account balance(s), user profile(s), Home page, etc.
Displayed information confirming that the electronic bet ticket sale listing has been posted to the electronic bet ticket exchange marketplace.
Displayed information indicating sportsbook of origin for electronic bet ticket offer listing.
Displayed details about the newly posted listing, including, for example: event, market, buy amount, win amount, originating sportsbook, % gain for user if sold at listed price, and/or other related data.
Displayed details about the originating electronic bet ticket.
Displayed details about any win amount and/or percentage ownership of the electronic bet ticket which is retained by the seller.
Buttons for enabling user to initiate “Post to Social” activities and/or “View My Wire” activities.
Bottom nav bar for enabling quick and easy access to other WagerWire application GUIs such as, for example, Home, My Wire, Portfolio, Profile, History, Messages, etc.

FIG. 24B shows an example screenshot of a My Wire GUI 2450. In at least one embodiment, the My Wire GUI may be configured or designed to include functionality for accessing and displaying all the users active electronic bet ticket offerings currently listed across one or more electronic bet ticket marketplace(s). The various features and functions of the My Wire GUI 2450 may be substantially similar to those of My Wire GUI 2400 of FIG. 24A. As illustrated in the example embodiment of FIG. 24B, the displayed list of the user's electronic bet ticket offerings is shown to include the fractional bet sale offering which was posted in FIG. 23B.

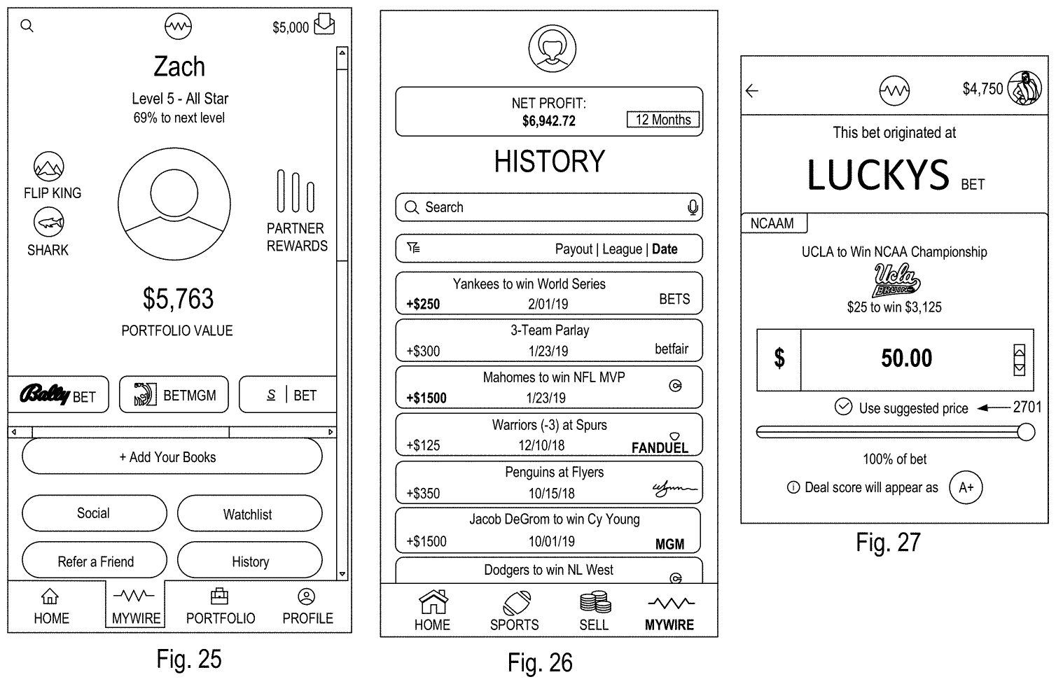

FIG. 25 shows an example screenshot of a User Account Profile GUI. In at least one embodiment, the User Account Profile GUI may be configured or designed to include functionality for enabling the user to access, display, and manage the user's profile information, account level and points, sportsbook accounts, and other settings and information. Various features and functionality of the User Account Profile GUI may include, for example:
Functionality for enabling the user to access, display, and manage the user's profile information, including, for example:
   Username
   User identity data
   User contact data
   User address data
   User location data
   User age data
   Status level
   Earned badges & loyalty points
   User's progress towards achieving the next status level (e.g., points progress circle around avatar)
Portfolio value(s), which, for example, may include an aggregated portfolio value across multiple different sportsbook accounts, as well as separate portfolio values corresponding to the user's WagerWire account and synced sportsbook accounts.
Functionality for enabling the user to access, display, and manage the user's profile information relating to one or more of the following (or combinations thereof) synced sportsbooks accounts.
   Linked book accounts displayed
   Button to “Add your books”
Functionality for enabling the user to access, display, and manage other types of information and/or content which may be personalized a customized by the user such as, for example:
   User's Social Media
   User's Watchlist
   Refer a Friend/History
   Access to Leaderboard(s)
   Electronic bet ticket purchase/sale transaction history
   Messaging communications
   Payment/Funding details (e.g., credit card information, banking information, etc.)
   Etc.

FIG. 26 shows an example screenshot of a Betting Transaction History GUI. In at least one embodiment, the Betting Transaction History GUI may be configured or designed to include functionality for enabling the user to view and download data relating to the user's transaction logs and betting history. Various features and functionality of the Betting Transaction History GUI may include, for example:
Functionality for enabling the user to view and download data relating to all of a user's bet's that have been resolved, such as, for example, buys, sells, wins, losses, canceled bets, cashed out bets, etc.
Functionality for enabling the user to view details relating to electronic bet tickets which the user has purchased and/or sold, along with related information such as, for example, originating sportsbook, bet outcome/results, gains/losses, etc.
Functionality for enabling the user to sort and filter displayed data according to various user selectable criteria such as, for example, by date, bet type, sport, league, etc.

### Dynamic Calculation of Bet Pricing

FIG. 27 shows an example screenshot of a Suggest Pricing GUI. In at least one embodiment, the Suggest Pricing GUI may be configured or designed to include functionality for automatically and dynamically calculating and displaying a suggested fair market price for selling a given electronic bet ticket selected by the user. This feature helps to simplify the listing process for users selling bets and/or for buyers submitting buy offers.

In at least one embodiment, the WagerWire system may be configured or designed to include functionality for automatically and dynamically calculating (e.g., in real-time) a suggested fair market price for selling a given electronic bet ticket selected by the user. In at least one embodiment, the dynamic calculation of the suggested price value may be based, at least in part, on real-time game conditions and/or market conditions.

For example, in one embodiment, in performing the dynamic calculation of the suggested price value, the WagerWire system may be configured or designed to utilize at least one basis for valuation, such as, for example, the implied value of the electronic bet ticket. In one embodiment, the implied value of an electronic bet ticket may be equated to the ‘replacement’ value of the bet, that is, how much money would need to be wagered (e.g., at the present time, and with current market odds) in order to receive the same payout as the original bet?

In other embodiments, the implied value of a bet may be calculated as the current probability of winning the bet times the payout if the bet wins. In one embodiment, a suitable and convenient proxy for win probability is the current sportsbook odds for that same event.

Presented below are example calculations for Implied Value (“IV”) of a bet, which may be dynamically performed by the WagerWire system.
Implied Value=(Probability of winning bet)*(Payout if bet wins)
Probability of winning=1/Decimal Odds
Implied Value=Payout/Decimal Odds
   Example 1: Calculation with Decimal Odds:
   Implied Value=Payout/Decimal Odds
   Example: Bet with $100 total payout at 2.5 odds
   Implied Value=100/2.5
   IV=$40
   Example 2: American Odds Underdog (+AmOdds):
   Decimal Odds=1+(AmOdds/100)
   Implied Value=Payout/(1+(AmOdds/100))
   Example: $100 payout with +150 odds
   Implied Value=100/((150/100)+1)
   IV=100/(1.5+1)
   IV=100/2.5
   IV=$40
   Example 3: American Odds Favorite (−AmOdds):
   Decimal Odds=((1/(1−(AmOdds/100))
   Implied Value=Payout/(1−(AmOdds/100))
   Example: $100 payout with −150 odds
   Implied Value=100/((1/(150/100))+1)
   IV=100/(1/1.5+1)
   IV=100/(5/3)
   IV=100*3/5
   IV=$60

In at least one embodiment, the WagerWire system may dynamically calculate the Suggested Price value according to:

Suggested Price Value=(Implied Value of Bet)×(Weighted Percentage), where:

Implied Value=(Payout of bet)/(Current Consensus Decimal Odds);

Payout of bet=(Original Decimal Odds)*(Original Amount Bet);

Weighted Percentage=Percentage value determined based on specific criteria/factors.

For example, in one embodiment, the WagerWire system may assign a default Weighted Percentage value=90%, which will result in the electronic bet ticket sale listing receiving an “A” Deal Score value. Accordingly, if the WagerWire system determines that a given that an identified electronic bet ticket has an Implied Value of $100, the WagerWire system may dynamically calculate a Suggested Price of $100*(90%)=$90. The user may choose to accept the Suggested Price or may choose disregard the Suggested Price and list the electronic bet ticket for any price they wish.

In some embodiments, when calculating the Suggested Price value, the WagerWire system may also take into account other factors such as, for example, one or more of the following (or combinations thereof):
Time value (e.g., longer expiration=>decreased price; shorter expiration=>increased price)
Competitive pricing analysis, for example, based on listings of similar-type bets for sale across one or more electronic bet ticket marketplaces
Updated odds data published or provided by sportsbooks and/or other entities;
Real-time event(s)/condition(s) which may affect or influence bet event outcome;
Current or past event(s)/condition(s) which may affect or influence bet event outcome;
Minimum desired Deal Score value (e.g., specified by the user)
Etc.

### Automated and Conditional Offer Functionality

In at least one embodiment, the WagerWire system may be configured or designed to include functionality for automatically and dynamically generating a suggested fractional bet offer listing for an electronic bet ticket owned by a user, wherein the suggest listing price and win amount for the fractional bet offer listing are specifically tailored to allow the user to recoup the initial amount wagered on the bet. For reference purposes, this type of offer may be referred to as a “Make Me Whole” offer.

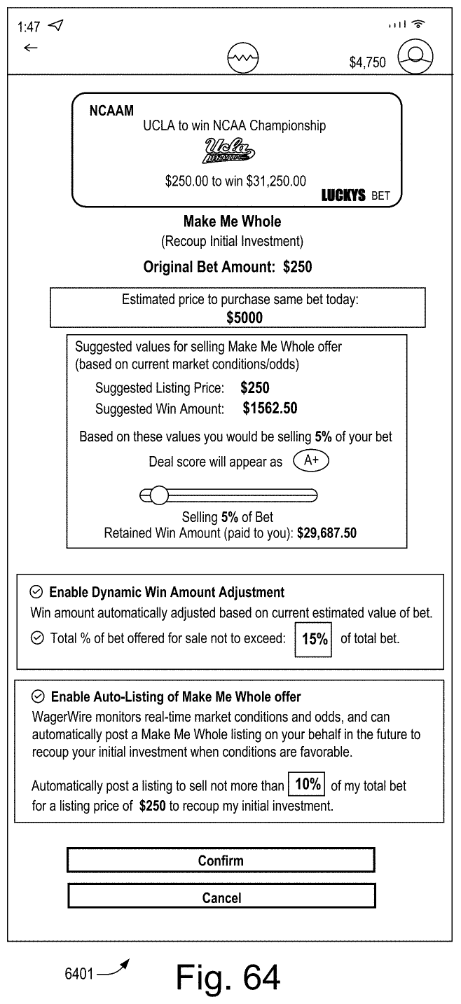

FIG. 64 shows an example screenshot of a Make Me Whole Offer Configuration GUI 6401 in accordance with one embodiment. In at least one embodiment, the Make Me Whole Offer Configuration GUI may be configured or designed to enable a user to access, configure, and manage various types of functional features provided by the Wager Wire system/WagerWire application, including, but not limited to, one or more of the following:
Functionality for automatically and/or dynamically generating a suggested fractional bet offer listing for an electronic bet ticket owned by a user, wherein the suggest listing price and win amount for the fractional bet offer listing are specifically tailored to allow the user to recoup the initial amount wagered on the bet. In one embodiment, the Wager Wire system may offer suggested listing price and/or win amount values values for configuring a Make Me Whole offer for selling a fractional portion of an identified electronic bet ticket owned by the user. The suggested pricing may be based, at least partially on current or real-time market conditions, odds, estimated price to purchase similar bet at present time, etc.
Functionality for automatically and/or dynamically generating and posting, on behalf of a user, an offer listing for selling a whole or fractional portion of a user's electronic bet ticket, and for enabling the user to pre-define one or more triggering events and/or conditions for granularly controlling the automated execution of this feature. In one embodiment, the WagerWire system may monitor real-time market conditions and odds, and can automatically post, at a future time/date, a Make Me Whole listing on user's behalf to enable the user to recoup their initial investment when conditions are favorable. In at least one embodiment, GUI 6401 may enable the user to configure various parameters relating to this feature, such as, for example, “automatically post a listing to sell not more than X % of my total bet”.
Functionality for providing automated and dynamic adjustment of a win amount value associated with an active electronic bet ticket sale listing. In at least one embodiment, offered win amount for an active fractional bet sale listing may be automatically adjusted based on current estimated value of bet.
Functionality for providing automated and dynamic adjustment of the offered fractional ownership value associated with an active electronic bet ticket sale listing. In some embodiments, the GUI 6401 may enable the user to configure various parameters relating to this feature, such as, for example, total percentage value of bet offered for sale is not to exceed X % of total bet.

### Example Procedures and Flow Diagrams

FIGS. 6-7 and 28-45 illustrate various example embodiments of different procedures and/or procedural flows which may be used for facilitating activities relating to one or more of the electronic bet ticket exchange techniques disclosed herein (herein referred to as “WagerWire flows” or “WagerWire procedures”).

According to different embodiments, at least a portion of the various types of functions, operations, actions, and/or other features provided by the WagerWire procedures disclosed herein may be implemented at one or more client systems(s), at one or more system servers(s), and/or combinations thereof.

In at least one embodiment, one or more of the WagerWire procedures may be operable to utilize and/or generate various different types of data and/or other types of information when performing specific tasks and/or operations. This may include, for example, input data/information and/or output data/information. For example, in at least one embodiment, the WagerWire procedures may be operable to access, process, and/or otherwise utilize information from one or more different types of sources, such as, for example, one or more local and/or remote memories, devices and/or systems. Additionally, in at least one embodiment, the WagerWire procedures may be operable to generate one or more different types of output data/information, which, for example, may be stored in memory of one or more local and/or remote devices and/or systems. Examples of different types of input data/information and/or output data/information which may be accessed and/or utilized by the WagerWire procedures may include, but are not limited to, one or more of those described and/or referenced herein.

In at least one embodiment, a given instance of the WagerWire procedures may access and/or utilize information from one or more associated databases. In at least one embodiment, at least a portion of the database information may be accessed via communication with one or more local and/or remote memory devices. Examples of different types of data which may be accessed by the WagerWire procedures may include, but are not limited to, one or more of those described and/or referenced herein.

According to specific embodiments, multiple instances or threads of the WagerWire procedures may be concurrently implemented and/or initiated via the use of one or more processors and/or other combinations of hardware and/or hardware and software. For example, in at least some embodiments, various aspects, features, and/or functionalities of the WagerWire procedures may be performed, implemented and/or initiated by one or more of the various systems, components, systems, devices, procedures, processes, etc., described and/or referenced herein.

According to different embodiments, one or more different threads or instances of the WagerWire procedures may be initiated in response to detection of one or more conditions or events satisfying one or more different types of minimum threshold criteria for triggering initiation of at least one instance of the WagerWire procedures. Various examples of conditions or events which may trigger initiation and/or implementation of one or more different threads or instances of the WagerWire procedures may include, but are not limited to, one or more of those described and/or referenced herein.

According to different embodiments, one or more different threads or instances of the WagerWire procedures may be initiated and/or implemented manually, automatically, statically, dynamically, concurrently, and/or combinations thereof. Additionally, different instances and/or embodiments of the WagerWire procedures may be initiated at one or more different time intervals (e.g., during a specific time interval, at regular periodic intervals, at irregular periodic intervals, upon demand, etc.).

In at least one embodiment, initial configuration of a given instance of the WagerWire procedures may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the WagerWire procedures may correspond to and/or may be derived from the input data/information.

It will be appreciated that the procedural diagrams of FIGS. 6-7 and 28-45 are merely specific examples of procedural flows and/or other activities which may be implemented to achieve one or more aspects of the various WagerWire techniques described herein. Other embodiments of procedural flows (not shown) may include additional, fewer and/or different steps, actions, and/or operations than those illustrated in the example procedural diagrams of FIGS. 6-7 and 28-45.

### WagerWire Transaction Flow Models

As described in greater detail herein, the WagerWire system and WagerWire application may utilize different types of front-end user experience models and transaction settlement methods for integrating with different Sportsbook entities.

Examples of different front end user experience models may include, but are not limited to:
WagerWire Marketplace model.
In-Sportsbook Integration model (white label).
Dual Channel model.

In at least one embodiment of the WagerWire Marketplace model, users access the WagerWire marketplace via the WagerWire application, and create a WagerWire account. The WagerWire application generates WagerWire-branded GUIs which enable users (e.g., both buyers and sellers) to view and browse electronic bet ticket offerings/listings originating from multiple different Sportsbook entities. Sales and purchases of electronic bet tickets are initiated by users via the WagerWire marketplace. In order to buy or sell an electronic bet ticket originating from a specific sportsbook (e.g. Sportsbook A), the WagerWire application provides GUIs for enabling the user to link or sync the user's Sportsbook A account with the user's WagerWire account. From a user experience perspective, the WagerWire application front end functions as a “one-stop-shop” marketplace where users can view, buy, and sell electronic bet ticket offerings originating from multiple different Sportsbook entities. FIG. 12 illustrates an example screenshot of a WagerWire application GUI which is branded according to one embodiment of the WagerWire Marketplace model.

At the back-end, the WagerWire system tracks and manages electronic bet ticket offers, sales, and purchase transactions conducted via the WagerWire marketplace, and periodically reports relevant transactional information to the appropriate Sportsbook entities. The WagerWire system is also configured or designed to seamlessly and transparently handle (e.g., on behalf of both buyers and sellers) back-end communications, payment transactions, and electronic bet ticket settlement transactions with the different originating Sportsbook entity systems.

In at least one embodiment, the In-Sportsbook Integration model may be configured or designed to function as a “white label” service provided by the WagerWire system to partnered Sportsbook entities. A white-label product or service is a product or service produced by one company (e.g., WagerWire) that other companies (e.g., Sportsbook entities) rebrand to make it appear to end users as if each Sportsbook entity is hosting their own electronic bet ticket exchange marketplace. In at least one embodiment of the In-Sportsbook Integration model, the WagerWire application may be configured or designed to function as a “white label” product which empowers each partner Sportsbook entity to host a respective electronic bet ticket marketplace under its own branding.

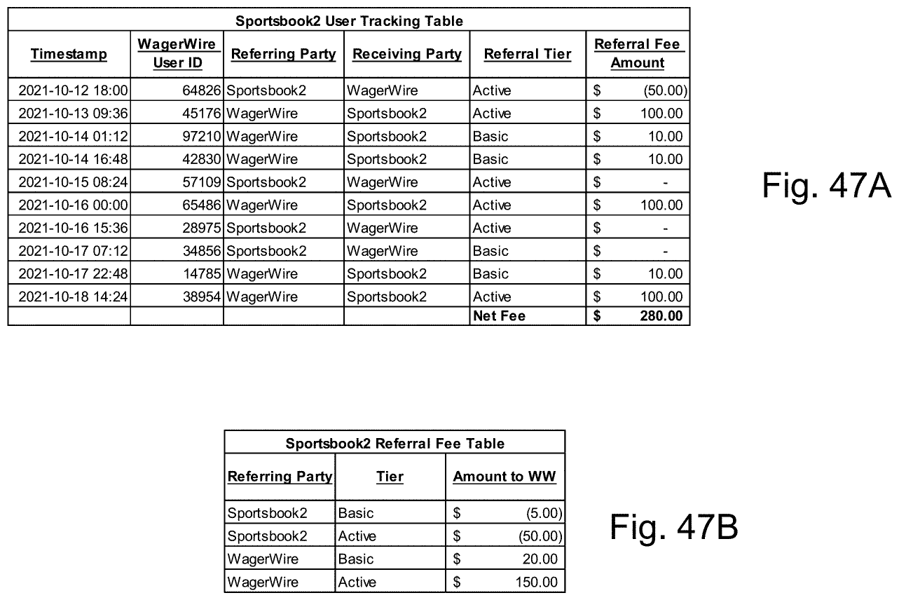

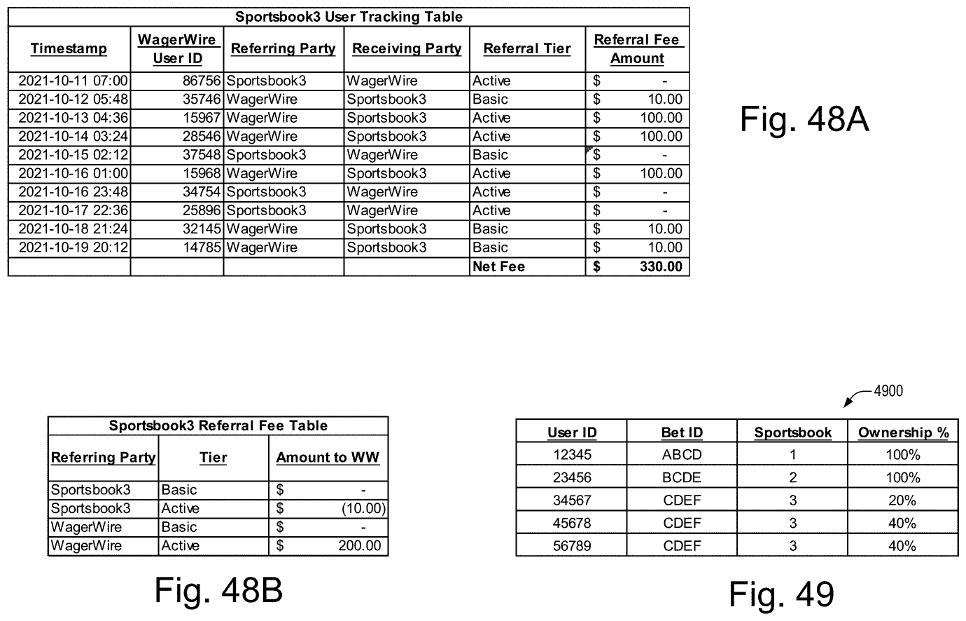

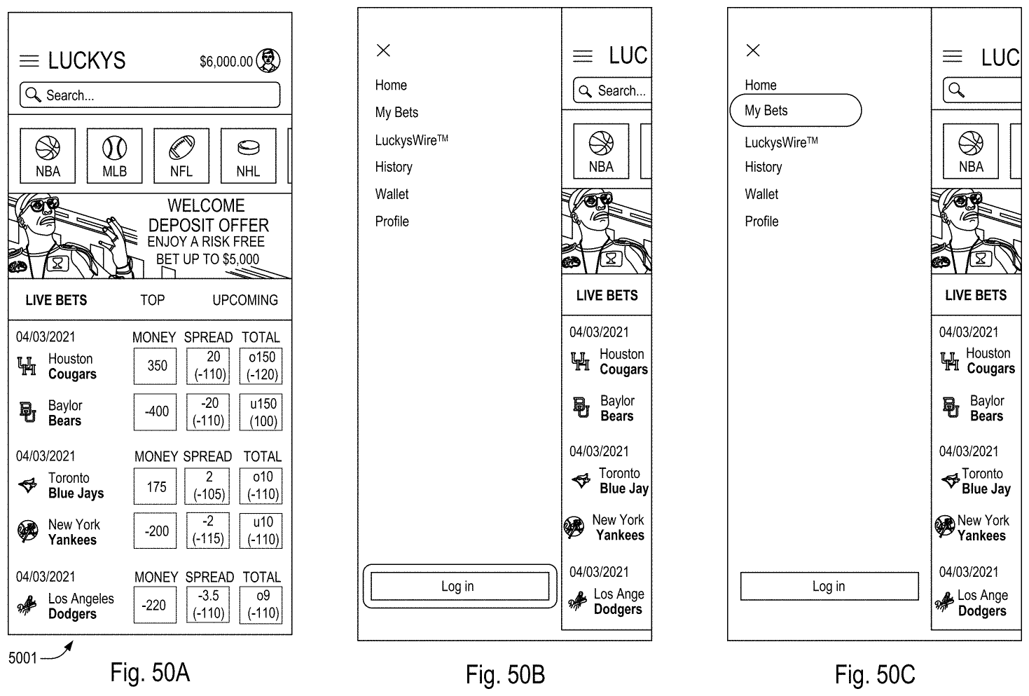

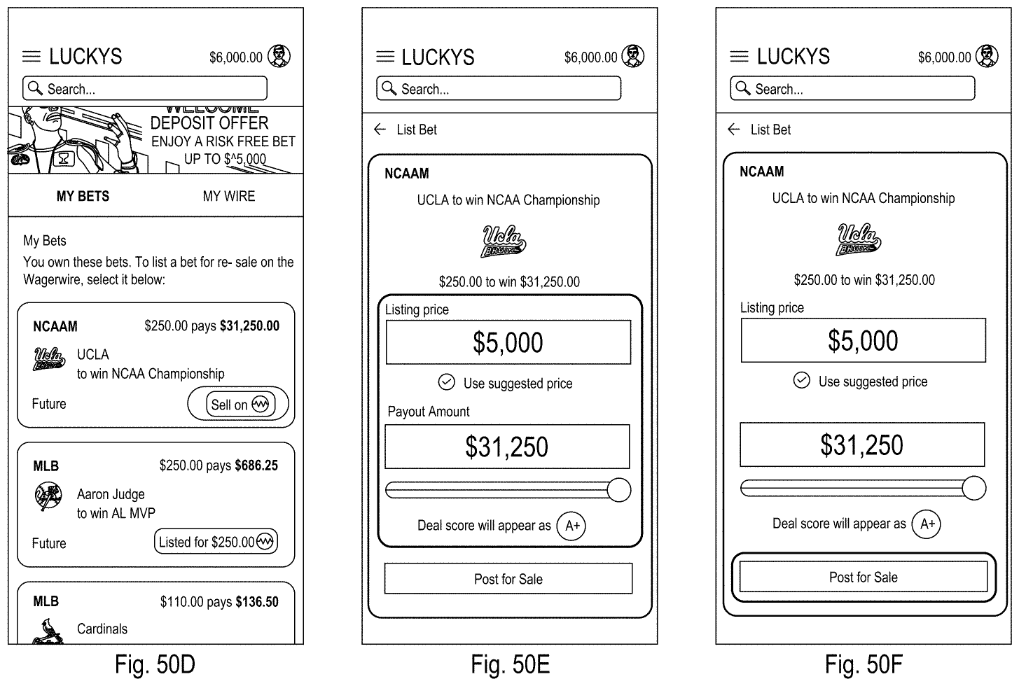

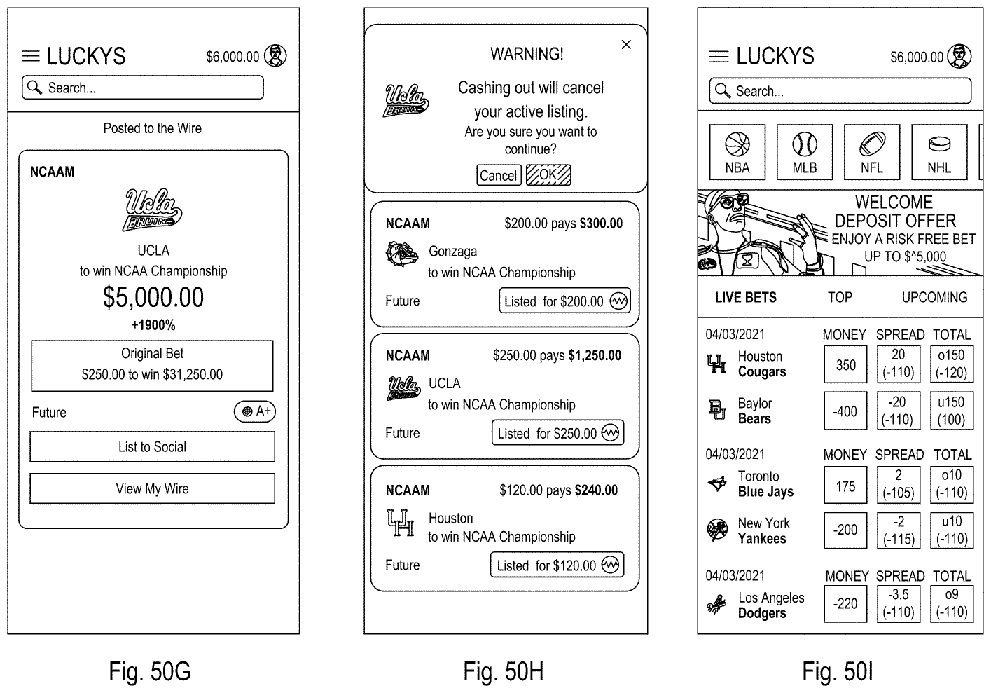

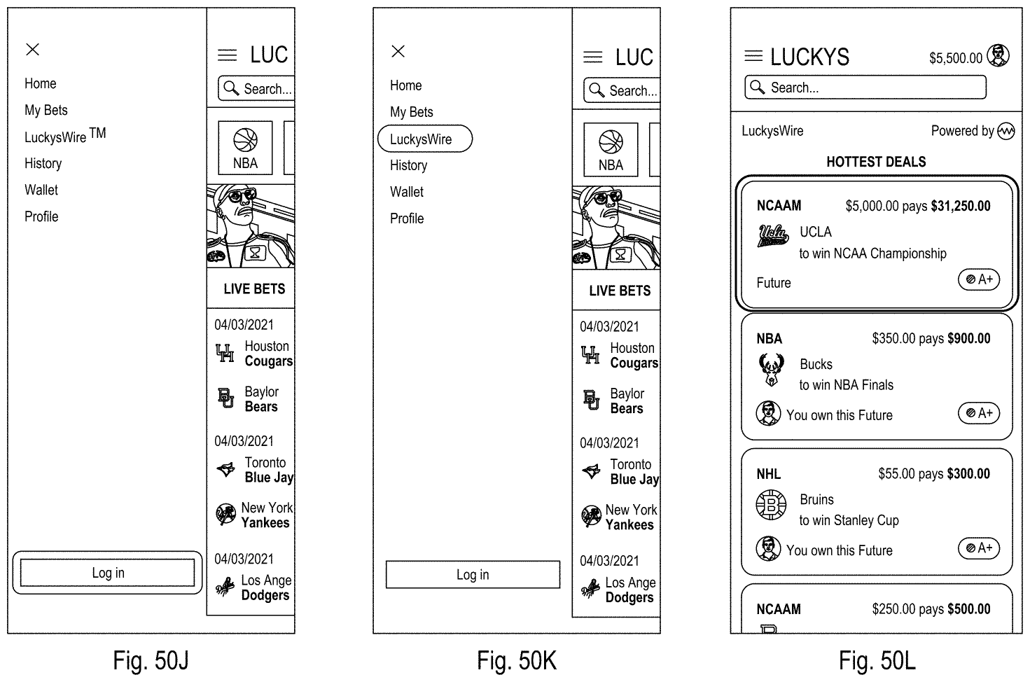

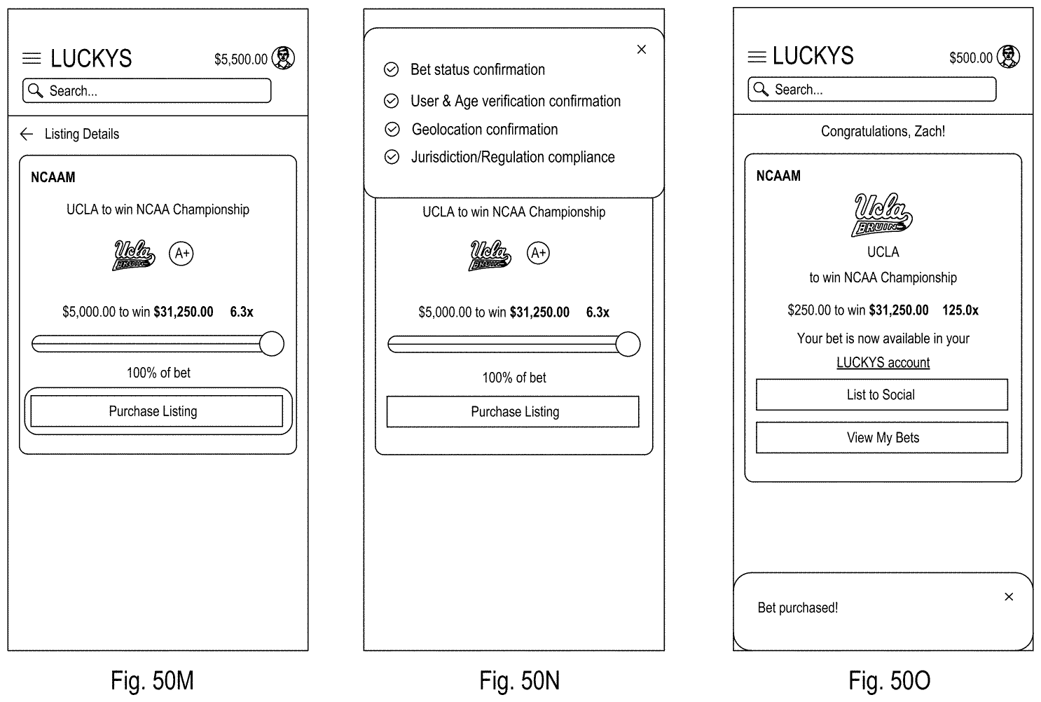

FIG. 50D illustrates an example screenshot of a WagerWire application GUI which is branded according to one embodiment of the In-Sportsbook Integration model, where the WagerWire application has been configured and re-branded to appear as a Luckys-brand electronic bet ticket exchange marketplace application (“Luckys-WW Application”) hosted by (or associated with) the Luckys Sportsbook entity.

In at least one embodiment, Luckys Sportsbook may already have an existing sportsbook application (“Lucky Sportsbook application”) which enables users to purchase electronic bet tickets originating only from the Luckys Sportsbook. In some embodiments, the WagerWire system and re-branded WagerWire application may be configured or designed to integrate with the Lucky Sportsbook application in a manner which enables users of the Lucky Sportsbook application to seamlessly and transparently access a Luckys-branded electronic bet ticket exchange marketplace which is powered at the back-end by the WagerWire system. In some embodiments, the Luckys-branded electronic bet ticket exchange marketplace may be configured or designed to enable users to purchase and sell only electronic bet tickets originating from the Luckys Sportsbook. In other embodiments, the Luckys-branded electronic bet ticket exchange marketplace may be configured or designed to enable users to purchase and sell electronic bet tickets originating from multiple different sportsbook entities.

In at least one embodiment of the Dual Channel model, the WagerWire system and WagerWire application may be configured or designed to provide both WagerWire marketplace functionality and In-Sportsbook Integration functionality. For example, in at least one embodiment of the Dual Channel model functionality may be provided for:
Enabling a first user (e.g., “seller”) to use a first sportsbook application (e.g., Sportsbook A application) to identify an electronic bet ticket which the user purchased from Sportsbook A, and to create and post (via the Sportsbook A application) an offer to sell the identified electronic bet ticket (e.g., SBA-Tix1) via the WagerWire marketplace. In at least one embodiment, the seller may initiate all these activities via interaction with the Sportsbook A application. In at least one embodiment, the seller may initiate all these activities without having to use the WagerWire application.
Enabling a second user (e.g., “buyer”) to use the Sportsbook A application to purchase the SBA-Tix1 electronic bet ticket from the seller from the WagerWire marketplace. In at least one embodiment, the buyer may initiate these activities via interaction with the Sportsbook A application, without having to use the WagerWire application.
Enabling a first user (e.g., “seller”) to use the WagerWire application to identify an electronic bet ticket (e.g., SBA-Tix1) which the user purchased from Sportsbook A, and to create and post (via the WagerWire application) an offer to sell the SBA-Tix1 electronic bet ticket on the WagerWire marketplace.
Enabling a second user (e.g., “buyer”) to use the WagerWire application to purchase (via the WagerWire application) the SBA-Tix1 electronic bet ticket from the WagerWire marketplace.
Enabling a first user (e.g., “buyer”) to use a first sportsbook application (e.g., Sportsbook A application) to identify an electronic bet ticket which a different user (“user A”) purchased from Sportsbook A, and to create and post (via the Sportsbook A application) an offer to buy the identified electronic bet ticket (e.g., SBA-Tix1) via the WagerWire marketplace. In at least one embodiment, the buyer may initiate all these activities via interaction with the Sportsbook A application. In at least one embodiment, the seller may initiate all these activities without having to use the WagerWire application.
Enabling user A (e.g., “seller”) to use the Sportsbook A application to accept the buy offer from the buyer, and to sell the SBA-Tix1 electronic bet ticket to the buyer via the WagerWire marketplace. In at least one embodiment, the seller may initiate these activities via interaction with the Sportsbook A application, without having to use the WagerWire application.
Enabling a first user (e.g., “buyer”) to use the WagerWire application to identify an electronic bet ticket (e.g., SBA-Tix1) which a different user (“user A”) purchased from Sportsbook A, and to create and post (via the WagerWire application) an offer to buy the SBA-Tix1 via the WagerWire marketplace.
Enabling user A (e.g., “seller”) to use the WagerWire application to accept the buy offer from the buyer, and to sell the SBA-Tix1 electronic bet ticket to the buyer via the WagerWire marketplace.

As described in greater detail herein, the WagerWire system may utilize different types of electronic bet ticket transaction settlement methods for settling selected electronic bet ticket purchase/sale transactions with different Sportsbook entities.

Examples of different electronic bet ticket transaction settlement methods which may be utilized may include, but are not limited to:
Escrow method
Reassignment method
Settle/Relist method

By way of illustration, the following example embodiment procedural flow illustrates a WagerWire-powered electronic whole bet ticket exchange transaction which is implemented in accordance with one embodiment of an escrow settlement method:
User A (“Seller) purchases original electronic bet ticket from Sportsbook
Seller lists electronic bet ticket for sale via online electronic bet ticket exchange marketplace (e.g., WagerWire marketplace).
In at least one embodiment, the online marketplace listings may be maintained by WagerWire system backend and stored in a WagerWire system database.
The listed electronic bet ticket is purchased by a second user (User B, “Buyer) via online marketplace powered by WagerWire. According to different embodiments, the payment transaction relating to the purchase of the electronic bet ticket by User B may be processed by the WagerWire system, the Sportsbook system, or a third-party payment gateway system (e.g., via credit card). In some embodiments where the WagerWire system handles the payment transaction, funds/payment for the sales price amount (and any applicable transaction fee(s) and/or taxes) may be collected from User B and routed by the WagerWire system into a financial institution holding account, and subsequently automatically transferred to the Sportsbook's bank account (or other financial institution account associated with the Sportsbook). In some embodiments where the Sportsbook system handles the payment transaction, the Sportsbook system may collect funds/payment for the sales price amount (and any applicable transaction fee(s) and/or taxes) from User B, and/or may debits User B's Sportsbook account for the sales price amount (and any applicable transaction fee(s) and/or taxes). According to different embodiments, WagerWire and Sportsbook(s) may split collected transaction fee(s) at a predetermined rate(s) per contractual agreement.
WagerWire system transmits to the Sportsbook purchase transaction details relating to the electronic bet ticket purchase. In response, the Sportsbooks re-assigns the identified electronic bet ticket to an escrow/holding account. Status of electronic bet ticket remains set as “active”.
In at least one embodiment, the WagerWire system maintains ledger identifying the user(s) that purchased the electronic bet ticket. In at least one embodiment, the electronic bet ticket may be bought and relisted/sold unlimited times until maturity. In the WagerWire system database, the most recent buyer of the electronic bet ticket will have a credit for the electronic bet ticket in their account, which allows that user to relict the electronic bet ticket for sale if desired.
If bet wins, the user who is the current owner of the electronic bet ticket (held in escrow) may be required to create an account at the Sportsbook (e.g., if an account does not already exist), or may be required to verify the login credentials of their existing Sportsbook account.
If the electronic bet ticket is a winner, payout is deposited in the sportsbook account corresponding to the current owner of the electronic bet ticket.
If bet loses, no action is necessary.

By way of illustration, the following example embodiment procedural flow illustrates a WagerWire-powered electronic fractional bet ticket exchange transaction which is implemented in accordance with one embodiment of an escrow settlement method:
User A (“Seller) purchases original electronic bet ticket from Sportsbook
Seller lists a fractional ownership portion of the electronic bet ticket for sale via online marketplace (e.g., WagerWire marketplace).
Fractional portion of electronic bet ticket is purchased by a second user.
WagerWire system transmits to the Sportsbook purchase transaction details relating to the electronic bet ticket purchase. In response, the Sportsbooks re-assigns the identified electronic bet ticket to an escrow/holding account. Status of electronic bet ticket remains set as “active”.
In at least one embodiment, the WagerWire system maintains ledger identifying the user(s) who have purchased fractional interests in the electronic bet ticket, as well as each purchasor's respective fractional ownership interest in the identified electronic bet ticket. In at least one embodiment, any of the fractional ownership interests of the electronic bet ticket may be bought and relisted/sold unlimited times until maturity.
If bet wins, the user who is the current owner of the electronic bet ticket (held in escrow) may be required to create an account at the Sportsbook (e.g., if an account does not already exist), or may be required to verify the login credentials of their existing Sportsbook account.
If the electronic bet ticket is a winner, payout is proportionally credited to the respective Sportsbook account(s) of all fractional interest holders/owners.
If bet loses, no action is necessary.
In at least one embodiment, the WagerWire system and/or Sportsbook system may initiate at least one reconciliation procedure to confirm that the aggregate of all fractional interest electronic bet ticket holders totals 100% of bet, and that all proportional payouts of win amounts have been correctly distributed into the appropriate Sportsbook accounts.

By way of illustration, the following example embodiment procedural flow illustrates a WagerWire-powered electronic bet ticket exchange transaction which is implemented in accordance with one embodiment of a reassignment settlement method:
User A (“Seller”) purchases original electronic bet ticket (“EBT”) from Sportsbook Seller lists a whole or fractional ownership portion of the electronic bet ticket (“EBT1”) for sale via electronic bet ticket exchange marketplace (e.g., via WagerWire marketplace). Status of EBT electronic bet ticket remains set as “active”.
In at least one embodiment, the WagerWire system tracks and manages electronic bet ticket offers, sales, and purchase transactions conducted via the electronic bet ticket exchange marketplace. For example, in at least one embodiment, as part of the process of posting the EBT1 listing to the electronic bet ticket exchange marketplace, the WagerWire system may create a new record in a WagerWire database which corresponds to the EBT1 listing. In at least one embodiment, the Sportsbook system need not make any modifications or updates to the EBT-related record(s) stored in its database(s) in response to the EBT1 listing being posted to the electronic bet ticket exchange marketplace. In some embodiments, the Sportsbook system may only need to make modifications or updates to the EBT-related database record(s) in response to the EBT1 electronic bet ticket being purchased.
EBT1 electronic bet ticket is purchased by a second user (e.g., User B, “Buyer”), via the WagerWire marketplace, for example.
WagerWire system transmits transaction details of the EBT1 purchase transaction (e.g., User A ID, User B ID, EBT Bet ID, EBT1 Win Amount, EBT1 ownership percentage, EBT1 Sales Price, etc.) to the Sportsbook. According to different embodiments, the payment transaction relating to the purchase of the electronic bet ticket by User B may be processed by the WagerWire system, the Sportsbook system, or a third-party payment gateway system (e.g., via credit card). In some embodiments where the WagerWire system handles the payment transaction, funds/payment for the sales price amount (and any applicable transaction fee(s) and/or taxes) may be collected from User B and routed by the WagerWire system into a financial institution holding account, and subsequently automatically transferred to the Sportsbook's bank account (or other financial institution account associated with the Sportsbook). In some embodiments where the Sportsbook system handles the payment transaction, the Sportsbook system may collect funds/payment for the sales price amount (and any applicable transaction fee(s) and/or taxes) from User B, and/or may debits User B's Sportsbook account for the sales price amount (and any applicable transaction fee(s) and/or taxes). According to different embodiments, WagerWire and Sportsbook(s) may split collected transaction fee(s) at a predetermined rate(s) per contractual agreement.
Sportsbook receives confirmation of the payment/funds transfer, and credits User A's account for the sales price of the EBT1 electronic bet ticket.
If the EBT1 electronic bet ticket purchase corresponds to a whole bet purchase (e.g., where the buyer is acquiring 100% ownership of the original EBT, or where the EBT1 Win Amount=the EBT Win Amount), the WagerWire system may cause the Sportsbook system to credit the User A Sportsbook account for an amount equal to the sales price of the EBT1 bet ticket, and to update the Sportsbook database to re-assign ownership of the EBT electronic bet ticket to User B. Status of EBT ticket remains set as “active”.
Alternatively, if the EBT1 electronic bet ticket purchase corresponds to a fractional bet purchase (e.g., where the buyer is acquiring less than 100% ownership of the original EBT, or where the EBT1 Win Amount<the EBT Win Amount), the WagerWire system may cause the Sportsbook system to perform one or more of the following operations:
   Determine the EBT1 risk amount (e.g., EBT1 risk amount=EBT1 sales price).
   Determine the EBT1 win amount (e.g., as specified in the EBT1 sale offer).
   Determine the percentage ownership interest in the EBT bet ticket that User B has acquired via purchase of the EBT1 bet ticket.
   Create a new electronic bet ticket (EBT2) data record in the Sportsbook database, and populate the EBT2 data record with data derived from the EBT1 electronic bet ticket purchase transaction data and/or data associated with the EBT electronic bet ticket, including, for example: EBT2 risk amount=EBT1 sales price; EBT2 win amount=EBT1 win amount; EBT2 bet details=EBT; etc.
   Assign ownership of the EBT2 electronic bet ticket to User B.
   Set status of EBT2 ticket as “active”.
   Credit User A Sportsbook account for an amount equal to the sales price of the EBT1 bet ticket.
   Determine remaining percentage of ownership interest that User A has in the EBT bet ticket, after sale of EBT1 bet ticket.
   Determine an updated risk amount value for EBT bet ticket. For example, if the terms of the original EBT electronic bet ticket specified a risk amount of $100 to win $20,000, and User A sold a 60% fractional ownership interest in the EBT bet ticket to User B for $500, the system would determine that User A has retained a 40% ownership interest in the EBT bet ticket. Accordingly, in one embodiment, the system may determine the updated risk amount value of the EBT bet ticket to be 40% of $100=$40.
   Determine an updated win amount value for EBT bet ticket. For example, if the terms of the original EBT electronic bet ticket specified a risk amount of $100 to win $20,000 (original EBT win amount), and User A sold a 60% fractional ownership interest in the EBT bet ticket to User B, the system would determine that User A has retained a 40% ownership interest in the EBT bet ticket. Accordingly, in one embodiment, the system may determine the updated win amount value of the EBT bet ticket to be 40% of $20,000=$8,000.
   Change or update the Sportsbook database record(s) relating to the EBT electronic bet ticket to reflect the updated risk amount value (e.g., $40) and updated win amount value (e.g., $8000). Additionally, in at least some embodiments, the Sportsbook database may also be updated to reflect that User A currently has a 40% ownership interest in the EBT bet ticket. Status of EBT ticket remains set as “active”.

In at least some embodiments which utilize the escrow settlement method and/or reassignment settlement method, the status of the original electronic bet ticket may remain set as “active” throughout the entire electronic bet ticket sale/purchase transaction process. Stated another way, in at least some embodiments utilizing either the escrow settlement method or reassignment settlement method, the status of the original electronic bet ticket may be set as “active” (i) before the electronic bet ticket is listed for sale; (ii) while the electronic bet ticket (or fractional portion thereof) is listed for sale on the electronic bet ticket exchange marketplace; and (iii) after a buyer has purchased a whole or fractional portion of the electronic bet ticket.

By way of illustration, the following example embodiment procedural flow illustrates a WagerWire-powered electronic bet ticket exchange transaction which is implemented in accordance with one embodiment of a settle/relist settlement method:
User A (“Seller”) purchases original electronic bet ticket (“EBT”) from Sportsbook Seller lists a whole or fractional ownership portion of the electronic bet ticket (“EBT1”) for sale via electronic bet ticket exchange marketplace (e.g., via WagerWire marketplace). Status of EBT electronic bet ticket remains set as “active”.
In at least one embodiment, the WagerWire system tracks and manages electronic bet ticket offers, sales, and purchase transactions conducted via the electronic bet ticket exchange marketplace. For example, in at least one embodiment, as part of the process of posting the EBT1 listing to the electronic bet ticket exchange marketplace, the WagerWire system may create a new record in a WagerWire database which corresponds to the EBT1 listing. In at least one embodiment, the Sportsbook system need not make any modifications or updates to the EBT-related record(s) stored in its database(s) in response to the EBT1 listing being posted to the electronic bet ticket exchange marketplace. In some embodiments, the Sportsbook system may only need to make modifications or updates to the EBT-related database record(s) in response to the EBT1 electronic bet ticket being purchased.
EBT1 electronic bet ticket is purchased by a second user (e.g., User B, “Buyer”), via the WagerWire marketplace, for example.
WagerWire system transmits transaction details of the EBT1 purchase transaction (e.g., User A ID, User B ID, EBT Bet ID, EBT1 Win Amount, EBT1 ownership percentage, EBT1 Sales Price, etc.) to the Sportsbook.
According to different embodiments, the payment transaction relating to the purchase of the electronic bet ticket by User B may be processed by the WagerWire system, the Sportsbook system, or a third-party payment gateway system (e.g., via credit card). In some embodiments where the WagerWire system handles the payment transaction, funds/payment for the sales price amount (and any applicable transaction fee(s) and/or taxes) may be collected from User B and routed by the WagerWire system into a financial institution holding account, and subsequently automatically transferred to the Sportsbook's bank account (or other financial institution account associated with the Sportsbook). In some embodiments where the Sportsbook system handles the payment transaction, the Sportsbook system may collect funds/payment for the sales price amount (and any applicable transaction fee(s) and/or taxes) from User B, and/or may debits User B's Sportsbook account for the sales price amount (and any applicable transaction fee(s) and/or taxes). According to different embodiments, WagerWire and Sportsbook(s) may split collected transaction fee(s) at a predetermined rate(s) per contractual agreement.
Sportsbook receives confirmation of the payment/funds transfer, and credits User A's account for the sales price of the EBT1 electronic bet ticket.
If the EBT1 electronic bet ticket purchase corresponds to a whole bet purchase (e.g., where the buyer is acquiring 100% ownership of the original EBT, or where the EBT1 Win Amount=the EBT Win Amount), the WagerWire system may cause the Sportsbook system to:
   Credit the User A Sportsbook account for an amount equal to the sales price of the EBT1 bet ticket less any transaction fees/taxes.
   Update the Sportsbook database to change the status of the EBT electronic bet ticket to “settled”.
   Create a new electronic bet ticket (EBT2) data record in the Sportsbook database representing User B's relative ownership interest in the EBT bet ticket.
   Populate the EBT2 data record with data derived from the EBT1 electronic bet ticket purchase transaction data and/or data associated with the EBT electronic bet ticket. For example, if the terms of the original EBT electronic bet ticket specified a win amount $20,000, and User B paid $750 to purchase 100% of the EBT bet ticket, the system may configure or update the EBT2 data record to indicate EBT2 risk amount=$750 and EBT2 win amount=$20,000.
   Update the Sportsbook database to assign ownership of the EBT2 electronic bet ticket to User B.
   Set status of EBT2 ticket as “active”.
Alternatively, if the EBT1 electronic bet ticket purchase corresponds to a fractional bet purchase (e.g., where the buyer is acquiring less than 100% ownership of the original EBT, or where the EBT1 Win Amount<the EBT Win Amount), the WagerWire system may cause the Sportsbook system to perform one or more of the following operations:
   Credit the User A Sportsbook account for an amount equal to the sales price of the EBT1 bet ticket less any transaction fees/taxes.
   Update the Sportsbook database to change the status of the EBT electronic bet ticket to “settled” or “closed”.
   Determine remaining percentage of ownership interest that User A has in the EBT bet ticket after sale of EBT1 bet ticket.
   Create a new electronic bet ticket (EBT3) data record in the Sportsbook database representing User A's relative ownership interest in the EBT bet ticket.
   Determine a risk amount value for EBT3 bet ticket (“EBT3 Risk Amount”) based on User A's relative ownership interest in the EBT bet ticket, data relating to the EBT bet ticket, and data relating to the EBT1 bet ticket sale transaction.
   Determine a win amount value for EBT3 bet ticket (“EBT3 Win Amount”) based on User A's relative ownership interest in the EBT bet ticket, data relating to the EBT bet ticket, and data relating to the EBT1 bet ticket sale transaction.
   Update the Sportsbook database to configure EBT3 electronic bet ticket with appropriate data/values, including, for example, EBT3 Risk Amount and EBT3 Win Amount.
   Update the Sportsbook database to assign ownership of the EBT3 electronic bet ticket to User A.
   Set status of EBT3 ticket as “active”.
   Create a new electronic bet ticket (EBT2) data record in the Sportsbook database representing User B's relative ownership interest in the EBT bet ticket.
   Determine the percentage ownership interest in the EBT bet ticket that User B has acquired via purchase of the EBT1 bet ticket.
   Determine the EBT2 risk amount (e.g., EBT2 risk amount=EBT1 bet ticket sales price).
   Determine the EBT2 win amount. In some embodiments where the EBT1 bet ticket offer specifies a specific win amount (e.g., EBT1 win amount=$8000), the system may determine that EBT2 win amount=EBT1 win amount. In other embodiments where the seller merely posts an offer to sell a fractional ownership interest (e.g. 60% ownership interest) of the EBT bet ticket, the system may determine that the EBT2 win amount=(0.60)*EBT win amount.
   Update the Sportsbook database to configure EBT2 electronic bet ticket with appropriate data/values, including, for example, EBT2 Risk Amount and EBT2 Win Amount.
   Update the Sportsbook database to assign ownership of the EBT2 electronic bet ticket to User B.
   In at least one embodiment, the WagerWire system and/or Sportsbook system may initiate at least one confirmation/reconciliation procedure to verify that the combined properties/values of the EBT2 bet ticket and EBT3 bet ticket substantially match the respective properties/values of the EBT bet ticket. For example, in at least one embodiment, the WagerWire system and/or Sportsbook system may initiate at least one confirmation/reconciliation procedure to verify that the EBT2 Win amount+EBT3 Win amount=EBT Win amount.
   In at least one embodiment, the WagerWire system and/or Sportsbook system may also initiate at least one confirmation/reconciliation procedure to verify that all account balances involved with the electronic bet ticket purchase/sale are accurately reflected.
   Set status of EBT2 ticket as “active”.

A notable and unique aspect of at least some of the electronic bet ticket exchange embodiments disclosed herein relates to the sequence and timing of the various activities and operations initiated and/or performed by the WagerWire system and/or Sportsbook system. For example, in at least some embodiments, when a seller wishes to sell a fractional portion of an electronic bet ticket originating from a specific sportsbook (e.g., EBT1 electronic bet ticket originating from Sportsbook A), the WagerWire system is configured or designed to provide functionality for enabling the seller to create and post a listing for the sale of a fractional portion of the EBT1 electronic bet ticket at an electronic bet ticket exchange marketplace without affecting the status of the EBT1 electronic bet ticket. For example, in at least some of the embodiments described above, the status of the original electronic bet ticket may remain set as “active” throughout the entire electronic bet ticket sale/purchase transaction process, including, for example: (i) before the electronic bet ticket is listed for sale; (ii) while the electronic bet ticket (or fractional portion thereof) is listed for sale on the electronic bet ticket exchange marketplace; and in at least some embodiments (iii) after a buyer has purchased a whole or fractional portion of the electronic bet ticket.

Another notable sequence/timing aspect of at least some of the electronic bet ticket exchange embodiments disclosed herein relates the relative timing of executing settlement of the original electronic bet ticket and creation of new electronic bet tickets. For example, in at least some of embodiments described herein which utilize the settle/relist settlement model, the settlement of an electronic bet ticket (e.g., EBT1 electronic bet ticket) which has been offered for sale, and corresponding creation of new electronic bet tickets, occurs after successful completion of the sale of a whole or fractional portion of the EBT1 bet ticket. This feature provides the benefit of helping to reduce the execution of unnecessary operations, as may occur in some prior art techniques. For example, according to some prior art teachings, when a user wishes to sell a fractional portion of an active bet slip, the prior art teaches the desirability of splitting up the active bet ticket into two new “fractional” bet tickets, changing the status of the original bet slip to “inactive”, and then listing one of the fractional bet tickets for sale. However, if the fractional bet ticket listed for sale does not sell, the seller is then stuck with two fractional bet tickets, which may be undesirable. In contrast, in at least some embodiments, the WagerWire system may be specifically configured or designed to prevent the electronic bet ticket settlement and corresponding creation of new “fractional” electronic bet tickets until after successful completion of the sale of a whole or fractional portion of the electronic bet ticket has occurred.

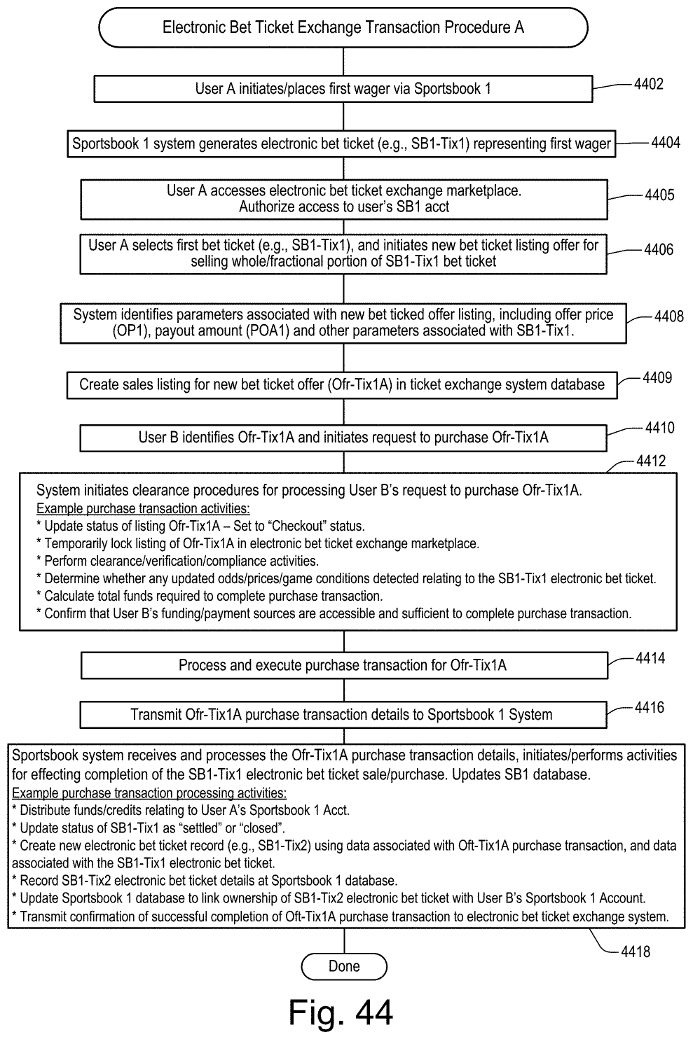

FIG. 44 shows an example embodiment of an Electronic Bet Ticket Exchange Transaction Procedure A, illustrating an example procedural flow for implementing an electronic bet ticket exchange transaction for selling/purchasing, via an electronic bet ticket exchange marketplace, a 100% ownership interest (“whole bet”) of an electronic bet ticket originating from a first sportsbook entity.

At 4402, User A initiates/places first wager via a first sportsbook entity (e.g., Sportsbook 1).

At 4404, the Sportsbook system generates or creates a first electronic bet ticket (e.g., SB1-Tix1 electronic bet ticket) representing details of the first wager, assigns ownership of the SB1-Tix1 electronic bet ticket to User A (e.g., assigned to User A's Sportsbook 1 account), and records these details in a Sportsbook 1 database.

In at least one embodiment, the SB1-Tix1 electronic bet ticket may be digitally represented using a sportsbook bet object data structure, which may be stored in non-transient memory of one or more system databases. FIG. 61 shows an example implementation of one embodiment of sportsbook bet object data structure. As illustrated in the example embodiment of FIG. 61, the sportsbook bet object data structure may be configured or designed to include a plurality of different data fields 6101 which may be populated with data relating to the SB1-Tix1 electronic bet ticket. A brief description of each of the data fields is displayed at 6103, along with representative examples of data 6102.

For purposes of illustration, a simplified representation of at least some types of data contained in the SB1-Tix1 electronic bet ticket data record may include, but is not limited to:
Bet ID 1 (e.g., 1234)
Event ID (e.g. NCAA championship)
Bet amount 1 (e.g. $250)
Bet line 1 (e.g. UCLA to win)
Odds Data (e.g., 125:1)
Payout Amount (e.g., $31,250)
Bet Type 1 (e.g., Future)
Originating entity (e.g., Sportsbook 1)
Owner ID (e.g., User A ID)
Owners Sportsbook Account ID
Creation Date.
Owner's WW Account ID
Permission granted for linking to Owner's WW Account (e.g., Y/N)
Permission granted by User to allow other users to submit offers for purchasing electronic bet tickets owned by User? (e.g., Y/N)

Returning to FIG. 44, at 4405, User A accesses online electronic bet ticket exchange marketplace (e.g., WagerWire marketplace), and provides authorization to the WagerWire system for syncing with User A's Sportsbook 1 account.

In at least one embodiment, the user may utilize a mobile application (e.g., WagerWire mobile application), desktop application, or web browser for accessing the online electronic bet ticket exchange marketplace. In some embodiments, at least a portion of the electronic bet ticket exchange marketplace services may be hosted or implemented by the WagerWire system. In other embodiments, at least some electronic bet ticket exchange marketplace service may be hosted or implemented by a sportsbook system and/or by a third-part system. In at least some embodiments, the WagerWire system and/or WagerWire application may be configured or designed to integrate with one or more sportsbook systems and/or sportsbook marketplace applications to provide various types of electronic bet ticket exchange/sale/purchase/offer functionality as described herein.

At 4406, User A selects first bet ticket (e.g., SB1-Tix1), and initiates new bet ticket listing offer for selling a whole (e.g., 100%) portion of the SB1-Tix1 bet ticket originating from Sportsbook 1. FIGS. 22A, 23A, 24A, 22B, 23B, 24B illustrate of example embodiments of various WagerWire application GUIs which may be used for enabling a user to configure, post, view, and manage details relating to one or more electronic bet ticket sale listings and/or offers initiated by the user.

At 4408 (FIG. 44), the electronic bet ticket exchange system identifies or determines parameters associated with new bet ticked offer listing, including, for example, an SB1-Tix1 bet ticket offer price (OP1), SB1-Tix1 bet ticket win or payout amount (POA1), and other parameters associated with SB1-Tix1.

At 4409, the electronic bet ticket exchange system creates a sales listing in the ticket exchange system database for a new bet ticket offer (Ofr-Tix1A) for selling the SB1-Tix1 electronic bet ticket, in accordance with the sale offer terms specified in the Ofr-Tix1A listing.

In at least one embodiment, the Ofr-Tix1A electronic bet ticket sale offer may be digitally represented using a WagerWire bet object data structure, which may be stored in non-transient memory of one or more system databases. FIG. 62 shows an example implementation of one embodiment of WagerWire bet object data structure. As illustrated in the example embodiment of FIG. 62, the WagerWire bet object data structure may be configured or designed to include a plurality of different data fields which may be populated with data relating to the Ofr-Tix1A offer. FIG. 62 also includes a brief description of each of the data fields, along with representative examples of data.

At 4410, User B identifies the Ofr-Tix1A offer via the electronic bet ticket exchange marketplace (e.g., WagerWire marketplace), and initiates a purchase request to purchase the SB1-Tix1 electronic bet ticket (or portion thereof) in accordance with the terms and conditions specified in the Oft-Tix1A offer.

At 4412, the electronic bet ticket exchange system (e.g., WagerWire system) initiates clearance procedures for processing User B's request to purchase the electronic bet ticket corresponding to the Ofr-Tix1A offer. Example clearance procedure activities may include, but are not limited to, one or more of the following (or combinations thereof):
Update status of listing Ofr-Tix1A—Set to “Checkout” status.
Temporarily lock listing of Ofr-Tix1A in electronic bet ticket exchange marketplace.
Perform clearance/verification/compliance activities, as needed. Examples of various types of clearance/verification/compliance activities may include, but are not limited to, one or more of the following (or combinations thereof):
   User B KYC confirmation and age verification.
   Perform Anti-Money Laundering (AML) verification.
   Perform verification of User B's physical geolocation.
   Perform verification and compliance with jurisdictional rules and regulations.
Determine whether any updated odds/prices/game conditions detected relating to the SB1-Tix1 electronic bet ticket.
Calculate total funds required to complete purchase transaction.
Confirm that User B's funding/payment sources are accessible and sufficient to complete purchase transaction.

Assuming no issues are detected which would prevent or block the purchase transaction, at 4414, the electronic bet ticket exchange system may process and execute the purchase transaction for Ofr-Tix1A, and update its database accordingly.

According to different embodiments, the processing of the payment transaction relating to the purchase transaction for Ofr-Tix1A may be performed by the WagerWire system, the Sportsbook system, and/or a third-party payment gateway system (e.g., via credit card). In some embodiments where the WagerWire system handles the payment transaction, funds/payment for the sales price amount (and any applicable transaction fee(s) and/or taxes) may be collected from User B and routed by the WagerWire system into a financial institution holding account, and subsequently automatically transferred to the Sportsbook's bank account (or other financial institution account associated with the Sportsbook). In some embodiments where the Sportsbook system handles the payment transaction, the Sportsbook system may collect funds/payment for the sales price amount (and any applicable transaction fee(s) and/or taxes) from User B, and/or may debits User B's Sportsbook account for the sales price amount (and any applicable transaction fee(s) and/or taxes). According to different embodiments, WagerWire and Sportsbook(s) may split collected transaction fee(s) at a predetermined rate(s) per contractual agreement.

At 4416, the electronic bet ticket exchange system may transmit the Ofr-Tix1A purchase transaction details to the Sportsbook 1 system. FIG. 63 shows an example of various types of transaction data which may be transmitted to the Sportsbook 1 system.

At 4418, the Sportsbook system receives and processes the Ofr-Tix1A purchase transaction details, initiates/performs activities for effecting completion of the SB1-Tix1 electronic bet ticket sale/purchase, and updates its database accordingly.

Example activities which may be initiated and/or performed for effecting completion of the SB1-Tix1 electronic bet ticket sale/purchase may include, but are not limited to, one or more of the following (or combinations thereof):
Distribute funds/credits relating to User A's Sportsbook 1 Acct.
Update status of SB1-Tix1 as “settled” or “closed”.
Create new electronic bet ticket record (e.g., SB1-Tix2) using data associated with Oft-Tix1A purchase transaction, and data associated with the SB1-Tix1 electronic bet ticket.
Record SB1-Tix2 electronic bet ticket details at Sportsbook 1 database.
Update Sportsbook 1 database to link ownership of SB1-Tix2 electronic bet ticket with User B's Sportsbook 1 Account.
Transmit confirmation of successful completion of Oft-Tix1A purchase transaction to electronic bet ticket exchange system.

In at least some embodiments, the WagerWire system may be configured or designed to facilitate, enable, initiate, and/or perform one or more of the above-described activities for effecting completion of the SB1-Tix1 electronic bet ticket sale/purchase.

In at least some embodiments, the WagerWire system and/or Sportsbook system may be configured or designed to execute some or all of the activities for effecting successful completion of the SB1-Tix1 electronic bet ticket sale/purchase as a multi-stepped atomic operation, where the multi-stepped atomic operation must either be performed/executed in its entirety, or not performed at all.

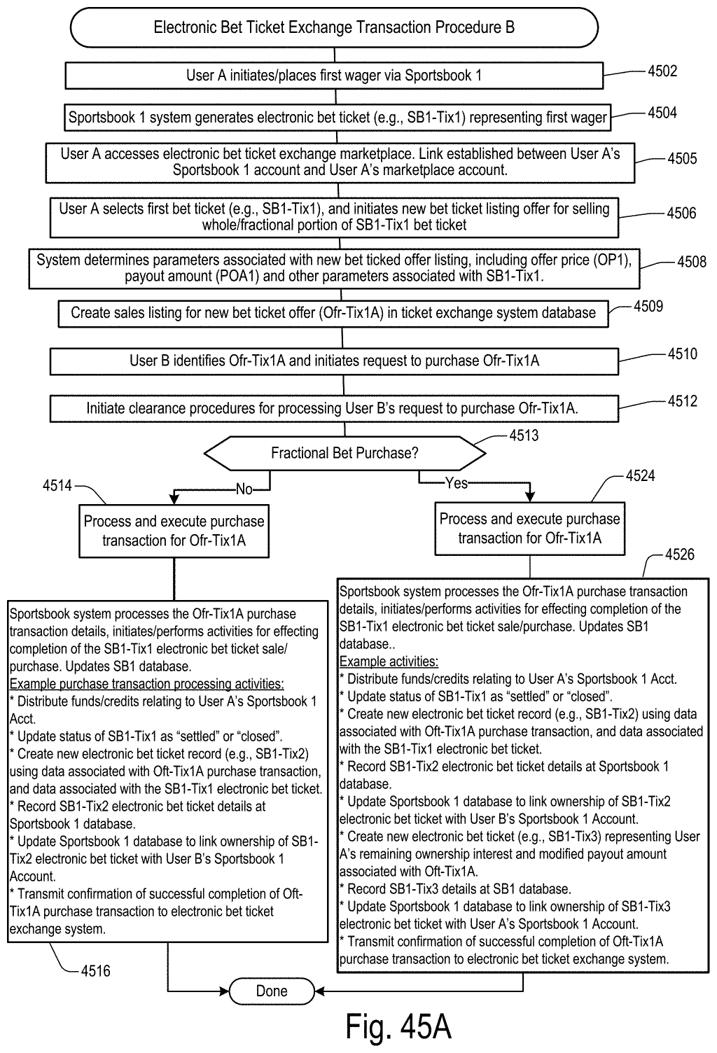

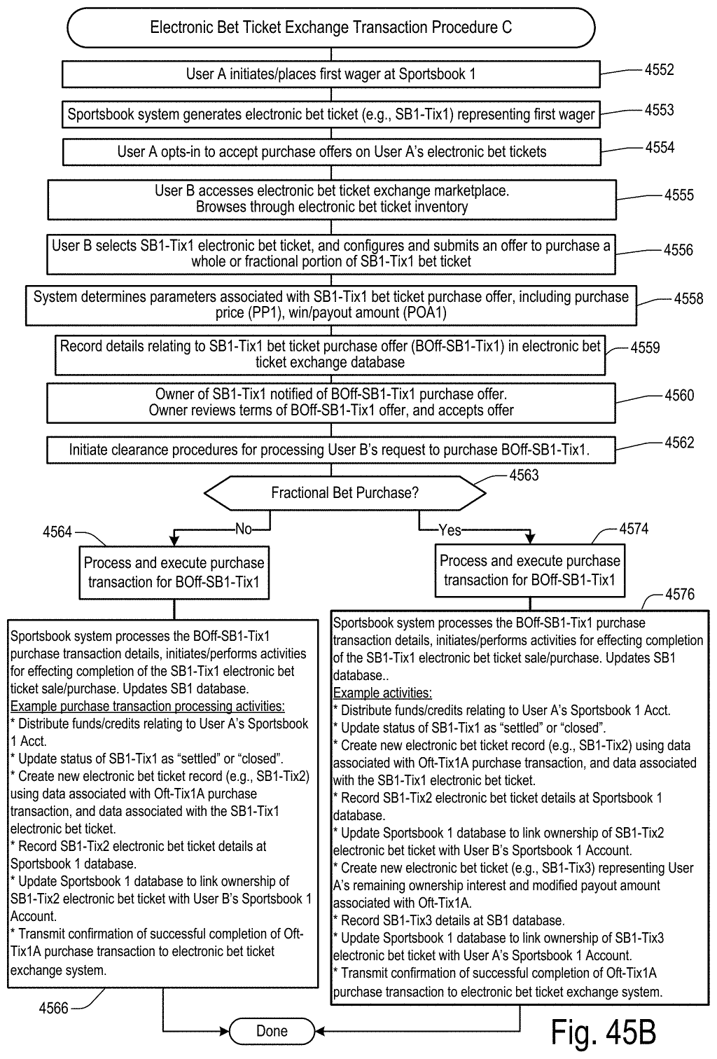

FIG. 45A shows an example embodiment of an Electronic Bet Ticket Exchange Transaction Procedure B, illustrating an example procedural flow for implementing an electronic bet ticket exchange transaction for enabling an owner of an electronic bet ticket to sell a whole or fractional portion of the electronic bet ticket via an electronic bet ticket exchange marketplace.

At 4502, User A initiates/places first wager via a first sportsbook entity (e.g., Sportsbook 1).

At 4504, the Sportsbook system generates or creates a first electronic bet ticket (e.g., SB1-Tix1 electronic bet ticket) representing details of the first wager, assigns ownership of the SB1-Tix1 electronic bet ticket to User A (e.g., assigned to User A's Sportsbook 1 account), and records these details in a Sportsbook 1 database.

In at least one embodiment, the SB1-Tix1 electronic bet ticket may be digitally represented using a sportsbook bet object data structure, which may be stored in non-transient memory of one or more system databases. FIG. 61 shows an example implementation of one embodiment of sportsbook bet object data structure.

For purposes of illustration, a simplified representation of at least some types of data contained in the SB1-Tix1 electronic bet ticket data record may include, but is not limited to:
Bet ID 1 (e.g., 1234)
Event ID (e.g. NCAA championship)
Bet amount 1 (e.g. $250)
Bet line 1 (e.g. UCLA to win)
Odds Data (e.g., 125:1)
Payout Amount (e.g., $31,250)
Bet Type 1 (e.g., Future)
Originating entity (e.g., Sportsbook 1)
Owner ID (e.g., User A ID)
Owners Sportsbook Account ID
Creation Date.
Owner's WW Account ID
Permission granted for linking to Owner's WW Account (e.g., Y/N)
Permission granted by User to allow other users to submit offers for purchasing electronic bet tickets owned by User? (e.g., Y/N)

Returning to FIG. 45, at 4505, User A accesses online electronic bet ticket exchange marketplace. A link or synced connection may be established between User A's Sportsbook 1 account and User A's marketplace account.

In at least one embodiment, the user may utilize a mobile application (e.g., WagerWire mobile application, Sportsbook 1 mobile application), desktop application, or web browser for accessing the online electronic bet ticket exchange marketplace. In some embodiments, at least a portion of the electronic bet ticket exchange marketplace services may be hosted or implemented by the WagerWire system. In other embodiments, at least some electronic bet ticket exchange marketplace service may be hosted or implemented by a sportsbook system and/or by a third-part system.

In some embodiments, functionality for accessing the electronic bet ticket exchange marketplace may be integrated into the Sportsbook 1's mobile application, desktop application and/or website application. In some embodiments, the electronic bet ticket exchange marketplace may be implemented as a “white label” electronic bet ticket exchange marketplace under the Sportsbook 1's own branding.

At 4506, User A selects first bet ticket (e.g., SB1-Tix1), and initiates new bet ticket listing offer for selling a whole or fractional portion of the SB1-Tix1 bet ticket originating from Sportsbook 1. FIGS. 22A, 23A, 24A, 22B, 23B, 24B illustrate of example embodiments of various WagerWire application GUIs which may be used for enabling a user to configure, post, view, and manage details relating to one or more electronic bet ticket sale listings and/or offers initiated by the user.

At 4508 (FIG. 45), the electronic bet ticket exchange system identifies or determines parameters associated with new bet ticked offer listing, including, for example, an SB1-Tix1 bet ticket offer price (OP1), SB1-Tix1 bet ticket win or payout amount (POA1), and other parameters associated with SB1-Tix1 electronic bet ticket.

At 4509, the electronic bet ticket exchange system creates a sales listing in the electronic ticket exchange system database for a new bet ticket offer (Ofr-Tix1A) for selling the SB1-Tix1 electronic bet ticket, in accordance with the sale offer terms and conditions specified in the Ofr-Tix1A listing.

In at least one embodiment, the Ofr-Tix1A electronic bet ticket sale offer may be digitally represented using a WagerWire bet object data structure, which may be stored in non-transient memory of one or more system databases. FIG. 62 shows an example implementation of one embodiment of WagerWire bet object data structure.

At 4510, User B accesses the electronic bet ticket exchange marketplace, identifies the Ofr-Tix1A sale listing, and initiates a purchase request to purchase the SB1-Tix1 electronic bet ticket (or portion thereof) in accordance with the terms and conditions specified in the Oft-Tix1A offer.

At 4512, the electronic bet ticket exchange system processes User B's request to purchase the electronic bet ticket corresponding to the Ofr-Tix1A offer, and initiates and/or executes various activities to facilitate successful completion of the electronic bet ticket purchase transaction. Example clearance procedure activities may include, but are not limited to, one or more of the clearance procedure activities described herein, such as, for example, those described with respect to FIG. 44.

Assuming no issues are detected which would prevent or block the purchase transaction from proceeding, at 4513, the electronic bet ticket exchange system determines, using information relating to the Ofr-Tix1A offer, whether the Ofr-Tix1A offer relates to a whole bet sale or a fractional bet sale. For example, in one embodiment, the system may compare the win amount value of the SB1-Tix1 electronic bet ticket and the win amount value of the Ofr-Tix1A offer. If the win amount value of the Ofr-Tix1A offer is equal to the win amount of value of the SB1-Tix1 electronic bet ticket, the system may determine that the Ofr-Tix1A offer relates to a whole bet sale. Alternatively, if the win amount value of the Ofr-Tix1A offer is less than the win amount of value of the SB1-Tix1 electronic bet ticket, the system may determine that the Ofr-Tix1A offer relates to a fractional bet sale.

As shown at 4514, if the system determines that the Ofr-Tix1A offer relates to a whole bet sale, the system may process and execute purchase transaction for Ofr-Tix1A. According to different embodiments, the processing of the purchase transaction for Ofr-Tix1A may be performed by the WagerWire system and/or the Sportsbook 1 system. Additionally, the processing of the payment transaction relating to the purchase transaction for Ofr-Tix1A may be performed by the WagerWire system, the Sportsbook 1 system, or a third-party payment gateway system (e.g., via credit card). In some embodiments where the WagerWire system handles the payment transaction, funds/payment for the sales price amount (and any applicable transaction fee(s) and/or taxes) may be collected from User B and routed by the WagerWire system into a financial institution holding account, and subsequently automatically transferred to the Sportsbook's bank account (or other financial institution account associated with the Sportsbook). In some embodiments where the Sportsbook system handles the payment transaction, the Sportsbook system may collect funds/payment for the sales price amount (and any applicable transaction fee(s) and/or taxes) from User B, and/or may debits User B's Sportsbook account for the sales price amount (and any applicable transaction fee(s) and/or taxes). According to different embodiments, WagerWire and Sportsbook(s) may split collected transaction fee(s) at a predetermined rate(s) per contractual agreement.

At 4516, the Sportsbook system processes the Ofr-Tix1A purchase transaction details, initiates/performs activities for effecting completion of the whole bet SB1-Tix1 electronic bet ticket sale/purchase, and updates its database accordingly.

Example activities which may be initiated and/or performed for effecting completion of the SB1-Tix1 electronic bet ticket sale/purchase (e.g., whole bet) may include, but are not limited to, one or more of the following (or combinations thereof):
Distribute funds/credits relating to User A's Sportsbook 1 Acct.
Update status of SB1-Tix1 as “settled” or “closed”.
Create new electronic bet ticket record (e.g., SB1-Tix2) using data associated with Oft-Tix1A purchase transaction, and data associated with the SB1-Tix1 electronic bet ticket.
Record SB1-Tix2 electronic bet ticket details at Sportsbook 1 database.
Update Sportsbook 1 database to link ownership of SB1-Tix2 electronic bet ticket with User B's Sportsbook 1 Account.
Transmit confirmation of successful completion of Oft-Tix1A purchase transaction to electronic bet ticket exchange system.

In at least some embodiments, the WagerWire system may be configured or designed to facilitate, enable, initiate, and/or perform one or more of the above-described activities for effecting completion of the SB1-Tix1 electronic bet ticket sale/purchase.

In at least some embodiments, the WagerWire system and/or Sportsbook system may be configured or designed to execute some or all of the activities for effecting successful completion of the SB1-Tix1 electronic bet ticket sale/purchase as a multi-stepped atomic operation.

As shown at 4524, if the system determines that the Ofr-Tix1A offer relates to a fractional bet sale, the system may process and execute purchase transaction for Ofr-Tix1A. According to different embodiments, the processing of the purchase transaction for Ofr-Tix1A may be performed by the WagerWire system and/or the Sportsbook 1 system. Additionally, the processing of the payment transaction relating to the purchase transaction for Ofr-Tix1A may be performed by the WagerWire system, the Sportsbook 1 system, or a third-party payment gateway system (e.g., via credit card).

At 4526, the Sportsbook system processes the Ofr-Tix1A purchase transaction details, initiates/performs activities for effecting completion of the fractional bet SB1-Tix1 electronic bet ticket sale/purchase, and updates its database accordingly.

Example activities which may be initiated and/or performed for effecting completion of the SB1-Tix1 electronic bet ticket sale/purchase (e.g., fractional bet) may include, but are not limited to, one or more of the following (or combinations thereof):
Distribute funds/credits relating to User A's Sportsbook 1 Acct.
Update status of SB1-Tix1 as “settled” or “closed”.
Create new electronic bet ticket record (e.g., SB1-Tix2) using data associated with Oft-Tix1A purchase transaction, and data associated with the SB1-Tix1 electronic bet ticket.
Record SB1-Tix2 electronic bet ticket details at Sportsbook 1 database.
Update Sportsbook 1 database to link ownership of SB1-Tix2 electronic bet ticket with User B's Sportsbook 1 Account.
Create new electronic bet ticket (e.g., SB1-Tix3) representing User A's remaining ownership interest and modified payout amount associated with Oft-Tix1A.
Record SB1-Tix3 details at SB1 database.
Update Sportsbook 1 database to link ownership of SB1-Tix3 electronic bet ticket with User A's Sportsbook 1 Account.
Transmit confirmation of successful completion of Oft-Tix1A purchase transaction to electronic bet ticket exchange system.

In at least some embodiments, the WagerWire system may be configured or designed to facilitate, enable, initiate, and/or perform one or more of the above-described activities for effecting completion of the SB1-Tix1 electronic bet ticket sale/purchase.

In at least some embodiments, the WagerWire system and/or Sportsbook system may be configured or designed to execute some or all of the activities for effecting successful completion of the SB1-Tix1 electronic bet ticket sale/purchase as a multi-stepped atomic operation.

FIG. 45B shows an example embodiment of an Electronic Bet Ticket Exchange Transaction Procedure C, illustrating an example procedural flow for implementing an electronic bet ticket exchange transaction for enabling a user to configure and submit, via an electronic bet ticket exchange marketplace, an offer to purchase a whole or fractional portion of an identified electronic bet ticket owned by a different user.

At 4552, User A initiates/places first wager via a first sportsbook entity (e.g., Sportsbook 1).

At 4553, the Sportsbook system generates or creates a first electronic bet ticket (e.g., SB1-Tix1 electronic bet ticket) representing details of the first wager, assigns ownership of the SB1-Tix1 electronic bet ticket to User A (e.g., assigned to User A's Sportsbook 1 account), and records these details in a Sportsbook 1 database. In at least one embodiment, the SB1-Tix1 electronic bet ticket may be digitally represented using a sportsbook bet object data structure, which may be stored in non-transient memory of one or more system databases.

At 4554, User A grants permission (e.g., “opts-in”) to accept purchase offers submitted by other users to purchase one or more of on User A's active electronic bet tickets. In at least one embodiment, if User A grants permission (e.g., “opts-in”) to accept purchase offers submitted by other users, the Sportsbook system may share anonymized data with electronic bet ticket exchange marketplace(s), wherein the shared anonymized data relates to active electronic bet tickets associated with User A's Sportsbook 1 account.

In one embodiment, the shared anonymized data includes details relating to active electronic bet tickets, but does not include personal identifiable information (PII) information relating to User A and/or User A's Sportsbook 1 account. In at least one embodiment, the shared anonymized data may include encrypted identifier information which may be decrypted by the Sportsbook 1 system and/or electronic bet ticket exchange system and used to identify a specific electronic bet ticket in the Sportsbook 1 database, along with information relating to the Sportsbook 1 account which currently owns the identified electronic bet ticket.

In at least one embodiment, the shared anonymized electronic bet ticket data may be processed by the electronic bet ticket exchange system, and published at the online electronic bet ticket exchange marketplace. For example, using the shared anonymized electronic bet ticket data, the electronic bet ticket exchange system may create and post new electronic bet ticket listings (e.g., “Make an Offer” listings) at the electronic bet ticket exchange marketplace representing active electronic bet tickets which are not currently offered for sale, but which are available to receive purchase offers to the respective owners. In at least one embodiment, the electronic bet ticket exchange system may be configured or designed to include functionality for enabling users accessing the electronic bet ticket exchange marketplace to browse through the inventory of Make an Offer electronic bet tickets, and configure and submit a purchase offer for purchasing an identified electronic bet ticket.

In some embodiments, User A may log into the WagerWire marketplace system and grant permission for the WagerWire system to sync User A's Sportsbook 1 account with User A's WagerWire account (User A WW Account), and to allow the WagerWire system to create and post new electronic bet ticket listings (e.g., “Make an Offer” listings) at the electronic bet ticket exchange marketplace representing active electronic bet tickets owned by User A which are not currently offered for sale, but which are available to receive purchase offers submitted by other users via the WagerWire marketplace.

In some embodiments, functionality for accessing the electronic bet ticket exchange marketplace may be integrated into the Sportsbook 1's mobile application, desktop application and/or website application. In some embodiments, the electronic bet ticket exchange marketplace may be implemented as a “white label” electronic bet ticket exchange marketplace under the Sportsbook 1's own branding.

At 4555, User B accesses the electronic bet ticket exchange marketplace, and browsed through the inventory of electronic bet tickets, which may include a listing for the SB1-Tix1 electronic bet ticket (e.g., presented as a Make an Offer electronic bet ticket).

At 4556, User B identifies the SB1-Tix1 electronic bet ticket, and configures and submits an offer to purchase a whole or fractional portion of SB1-Tix1 bet ticket. FIGS. 22A, 23A, 24A, 22B, 23B, 24B, and 54D illustrate of example embodiments of various WagerWire application GUIs which may be used for enabling a user to configure, post, view, and manage details relating to one or more electronic bet ticket offers initiated by the user.

At 4558 (FIG. 45), the electronic bet ticket exchange system identifies or determines parameters associated with new bet ticked offer listing, including, for example, an SB1-Tix1 bet ticket offer price (OP1), SB1-Tix1 bet ticket win or payout amount (POA1), and other parameters associated with SB1-Tix1 electronic bet ticket.

At 4559, the electronic bet ticket exchange system creates a sales listing in the electronic ticket exchange system database for a new bet ticket offer (BOff-SB1-Tix1) for selling the SB1-Tix1 electronic bet ticket, in accordance with the purchase offer terms and conditions specified in the BOff-SB1-Tix1 listing.

In at least one embodiment, the BOff-SB1-Tix1 electronic bet ticket purchase offer may be digitally represented using a WagerWire bet object data structure, which may be stored in non-transient memory of one or more system databases. FIG. 62 shows an example implementation of one embodiment of WagerWire bet object data structure.

At 4560, the owner of the SB1-Tix1 electronic bet ticket is notified of BOff-SB1-Tix1 electronic bet ticket purchase offer. For example, in one embodiment, when User B submits the BOff-SB1-Tix1 purchase offer via the electronic bet ticket exchange marketplace, the electronic bet ticket exchange system may initiate operation(s) to determine the identity of the user and/or user account that currently owns the SB1-Tix1 electronic bet ticket, and to cause a notification message to be generated and routed to the identified user/user account, notifying the user of the BOff-SB1-Tix1 electronic bet ticket purchase offer.

For example, in one embodiment, the electronic bet ticket exchange system may determine that the SB1-Tix1 electronic bet ticket is owned by a specific user account at Sportsbook 1 (e.g., User A SB1 Acct), may determine that the User A SB1 Acct is linked to an account (e.g., User A WW Account) of the electronic bet ticket exchange system, and may cause a notification message to be generated and routed to the User A WW Account, notifying User A of the BOff-SB1-Tix1 electronic bet ticket purchase offer.

In some embodiments, the electronic bet ticket exchange system may determine that the SB1-Tix1 electronic bet ticket is owned by a specific user account at Sportsbook 1 (e.g., User A SB1 Acct), and may transmit a notification message to the Sportsbook 1 system for routing to the User A SB1 Account, notifying User A of the BOff-SB1-Tix1 electronic bet ticket purchase offer.

Additionally, as shown at 4560, the owner of the SBT-Tix 1 (e.g., User A) reviews terms of BOff-SB1-Tix1 purchase offer. In at least one embodiment, the WagerWire application may be configured or designed to include functionality for displaying details relating to the BOff-SB1-Tix1 purchase offer to the owner. According to different embodiments, the owner (User A) may be provided with a choice of different options for responding to the offer which may include, for example, one or more of the following: Accept Offer, Reject Offer, Submit Counter-Offer. In the specific example embodiment of FIG. 45B, it is assumed that User A accepts the BOff-SB1-Tix1 purchase offer.

At 4564, the electronic bet ticket exchange system receives confirmation of the acceptance of the BOff-SB1-Tix1 offer, and initiates and/or executes various activities and/or operations to facilitate successful completion of the electronic bet ticket purchase transaction. Example clearance procedure activities may include, but are not limited to, one or more of the clearance procedure activities described herein, such as, for example, those described with respect to FIG. 44.

Assuming no issues are detected which would prevent or block the purchase transaction from proceeding, at 4563, the electronic bet ticket exchange system determines, using information relating to the BOff-SB1-Tix1 offer, whether the BOff-SB1-Tix1 offer relates to a whole bet sale or a fractional bet sale. For example, in one embodiment, the system may compare the win amount value of the SB1-Tix1 electronic bet ticket and the win amount value of the BOff-SB1-Tix1 offer. If the win amount value of the BOff-SB1-Tix1 offer is equal to the win amount of value of the SB1-Tix1 electronic bet ticket, the system may determine that the BOff-SB1-Tix1 offer relates to a whole bet sale. Alternatively, if the win amount value of the BOff-SB1-Tix1 offer is less than the win amount of value of the SB1-Tix1 electronic bet ticket, the system may determine that the BOff-SB1-Tix1 offer relates to a fractional bet sale. As shown at 4564, if the system determines that the BOff-SB1-Tix1 offer relates to a whole bet sale, the system may process and execute purchase transaction for BOff-SB1-Tix1. According to different embodiments, the processing of the purchase transaction for BOff-SB1-Tix1 may be performed by the WagerWire system and/or the Sportsbook 1 system. Additionally, the processing of the payment transaction relating to the purchase transaction for BOff-SB1-Tix1 may be performed by the WagerWire system, the Sportsbook 1 system, or a third-party payment gateway system (e.g., via credit card). In some embodiments where the WagerWire system handles the payment transaction, funds/payment for the sales price amount (and any applicable transaction fee(s) and/or taxes) may be collected from User B and routed by the WagerWire system into a financial institution holding account, and subsequently automatically transferred to the Sportsbook's bank account (or other financial institution account associated with the Sportsbook). In some embodiments where the Sportsbook system handles the payment transaction, the Sportsbook system may collect funds/payment for the sales price amount (and any applicable transaction fee(s) and/or taxes) from User B, and/or may debits User B's Sportsbook account for the sales price amount (and any applicable transaction fee(s) and/or taxes). According to different embodiments, WagerWire and Sportsbook(s) may split collected transaction fee(s) at a predetermined rate(s) per contractual agreement.

At 4566, the Sportsbook system processes the BOff-SB1-Tix1 purchase transaction details, initiates/performs activities for effecting completion of the whole bet SB1-Tix1 electronic bet ticket sale/purchase, and updates its database accordingly.

Example activities which may be initiated and/or performed for effecting completion of the SB1-Tix1 electronic bet ticket sale/purchase (e.g., whole bet) may include, but are not limited to, one or more of the following (or combinations thereof):
Distribute funds/credits relating to User A's Sportsbook 1 Acct.
Update status of SB1-Tix1 as “settled” or “closed”.
Create new electronic bet ticket record (e.g., SB1-Tix2) using data associated with Oft-Tix1A purchase transaction, and data associated with the SB1-Tix1 electronic bet ticket.
Record SB1-Tix2 electronic bet ticket details at Sportsbook 1 database.
Update Sportsbook 1 database to link ownership of SB1-Tix2 electronic bet ticket with User B's Sportsbook 1 Account.
Transmit confirmation of successful completion of Oft-Tix1A purchase transaction to electronic bet ticket exchange system.

In at least some embodiments, the WagerWire system may be configured or designed to facilitate, enable, initiate, and/or perform one or more of the above-described activities for effecting completion of the SB1-Tix1 electronic bet ticket sale/purchase.

In at least some embodiments, the WagerWire system and/or Sportsbook system may be configured or designed to execute some or all of the activities for effecting successful completion of the SB1-Tix1 electronic bet ticket sale/purchase as a multi-stepped atomic operation.

As shown at 4574, if the system determines that the BOff-SB1-Tix1 offer relates to a fractional bet sale, the system may process and execute purchase transaction for BOff-SB1-Tix1. According to different embodiments, the processing of the purchase transaction for BOff-SB1-Tix1 may be performed by the WagerWire system and/or the Sportsbook 1 system. Additionally, the processing of the payment transaction relating to the purchase transaction for BOff-SB1-Tix1 may be performed by the WagerWire system, the Sportsbook 1 system, or a third-party payment gateway system (e.g., via credit card).

At 4576, the Sportsbook system processes the BOff-SB1-Tix1 purchase transaction details, initiates/performs activities for effecting completion of the fractional bet SB1-Tix1 electronic bet ticket sale/purchase, and updates its database accordingly.

Example activities which may be initiated and/or performed for effecting completion of the SB1-Tix1 electronic bet ticket sale/purchase (e.g., fractional bet) may include, but are not limited to, one or more of the following (or combinations thereof):
Distribute funds/credits relating to User A's Sportsbook 1 Acct.
Update status of SB1-Tix1 as “settled” or “closed”.
Create new electronic bet ticket record (e.g., SB1-Tix2) using data associated with Oft-Tix1A purchase transaction, and data associated with the SB1-Tix1 electronic bet ticket.
Record SB1-Tix2 electronic bet ticket details at Sportsbook 1 database.
Update Sportsbook 1 database to link ownership of SB1-Tix2 electronic bet ticket with User B's Sportsbook 1 Account.
Create new electronic bet ticket (e.g., SB1-Tix3) representing User A's remaining ownership interest and modified payout amount associated with Oft-Tix1A.
Record SB1-Tix3 details at SB1 database.
Update Sportsbook 1 database to link ownership of SB1-Tix3 electronic bet ticket with User A's Sportsbook 1 Account.
Transmit confirmation of successful completion of Oft-Tix1A purchase transaction to electronic bet ticket exchange system.
In at least some embodiments, the WagerWire system may be configured or designed to facilitate, enable, initiate, and/or perform one or more of the above-described activities for effecting completion of the SB1-Tix1 electronic bet ticket sale/purchase.

In at least some embodiments, the WagerWire system and/or Sportsbook system may be configured or designed to execute some or all of the activities for effecting successful completion of the SB1-Tix1 electronic bet ticket sale/purchase as a multi-stepped atomic operation.

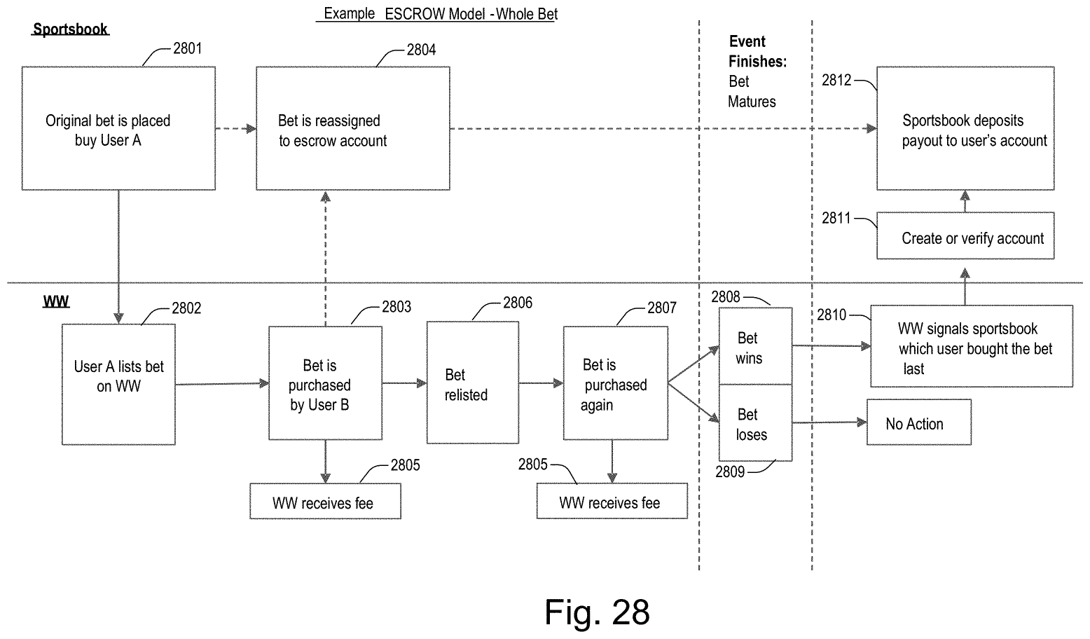

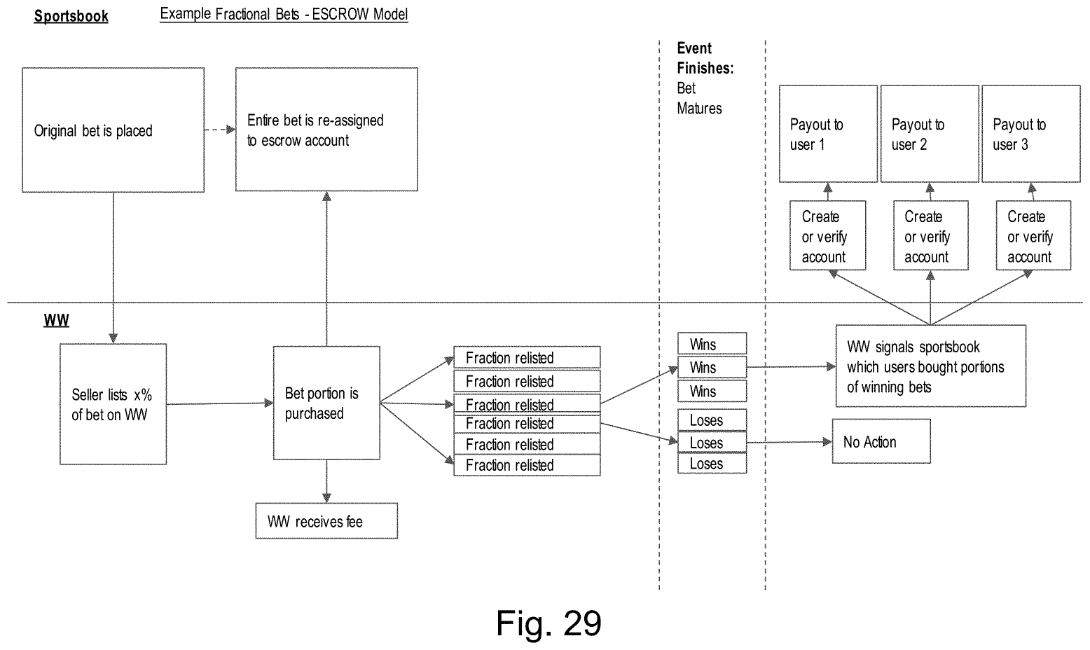

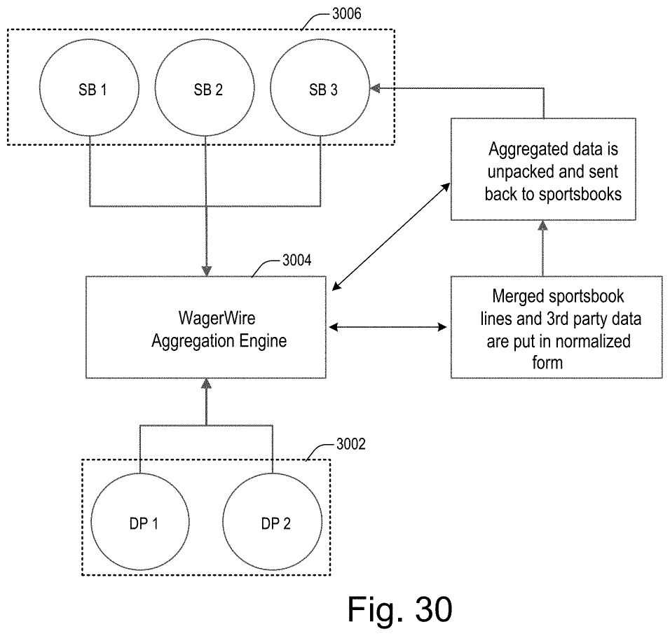

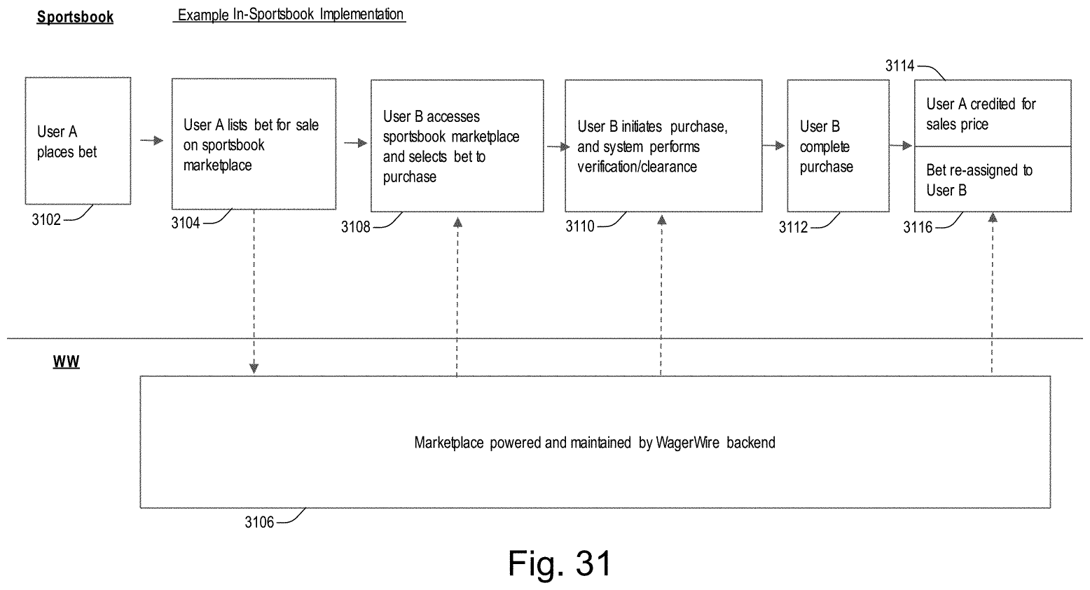

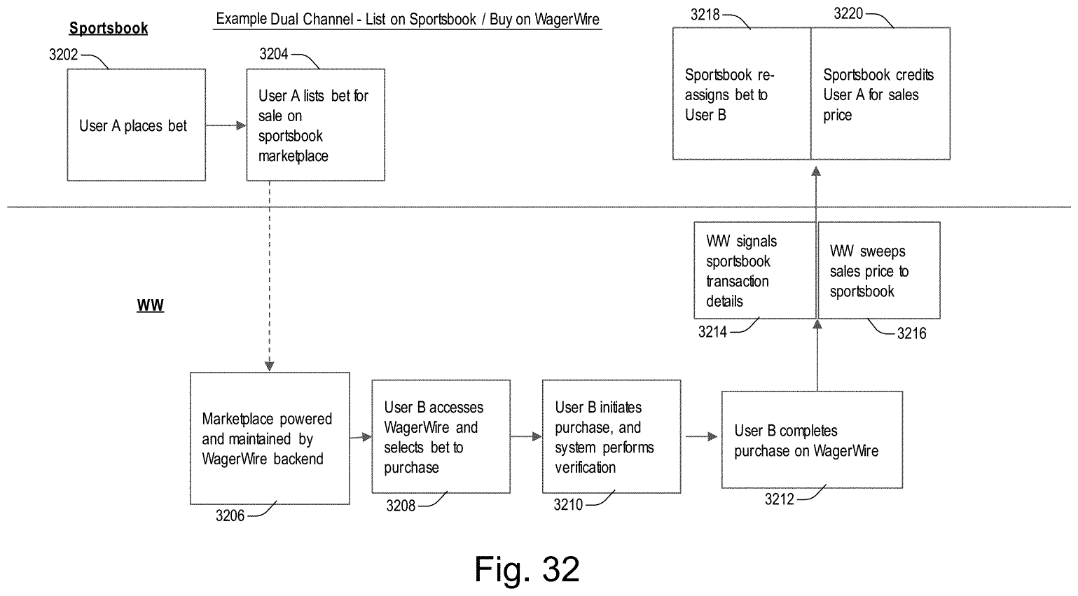

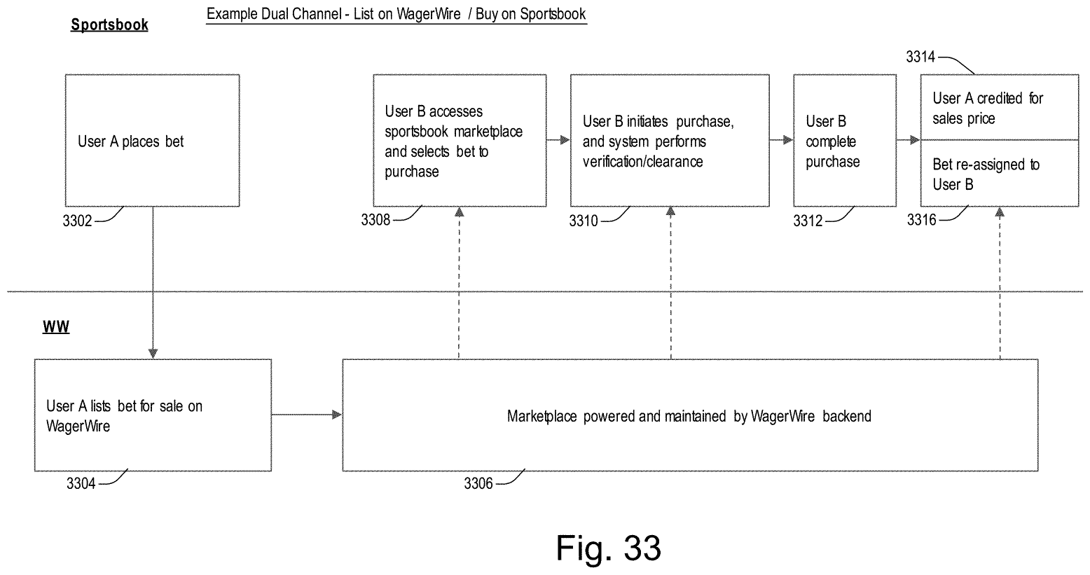

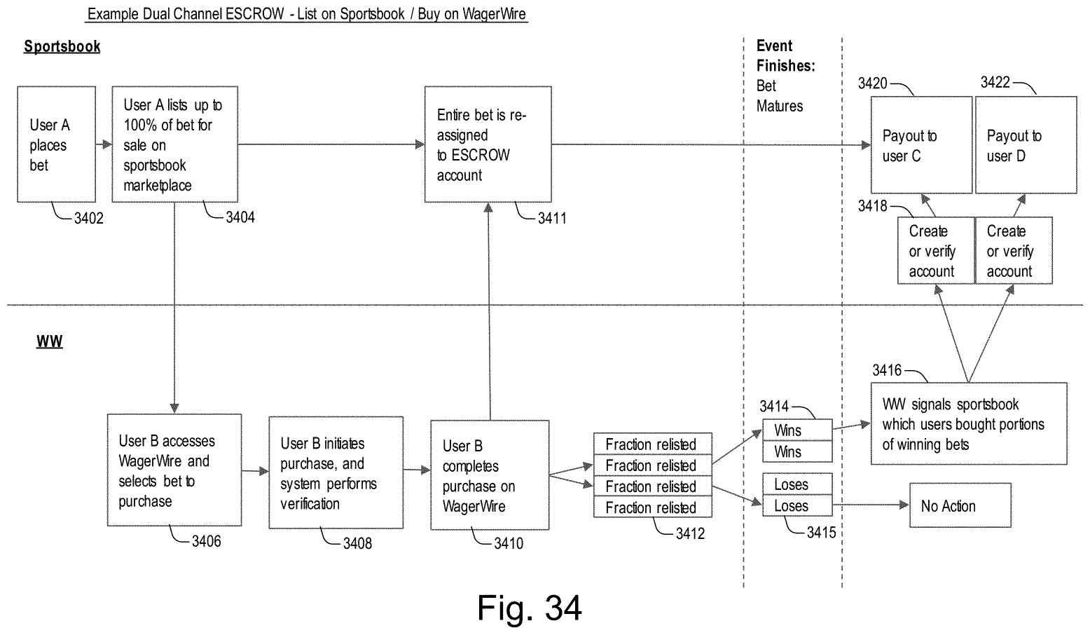

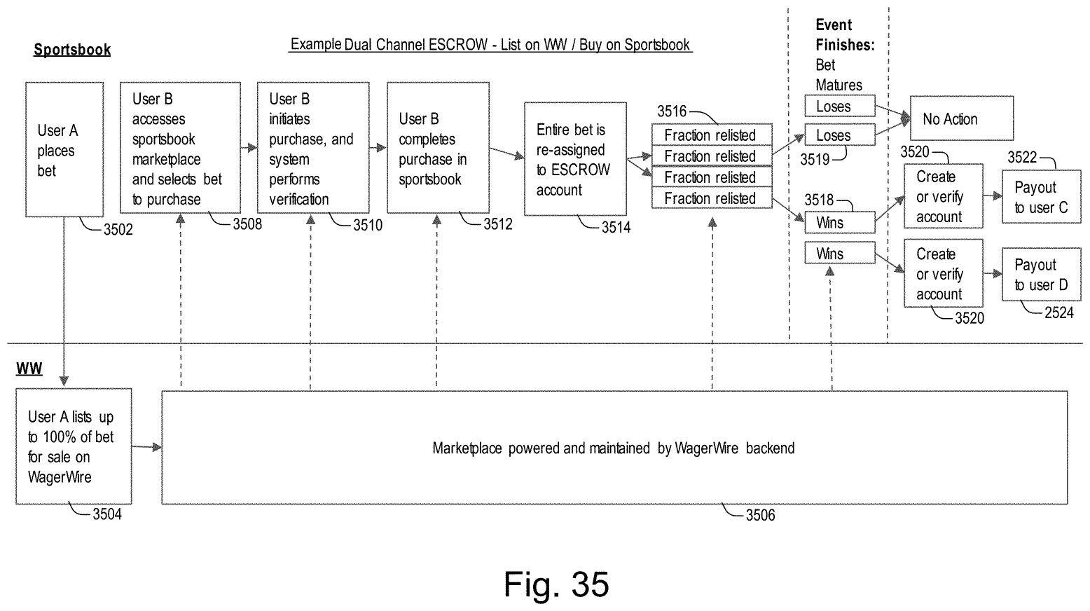

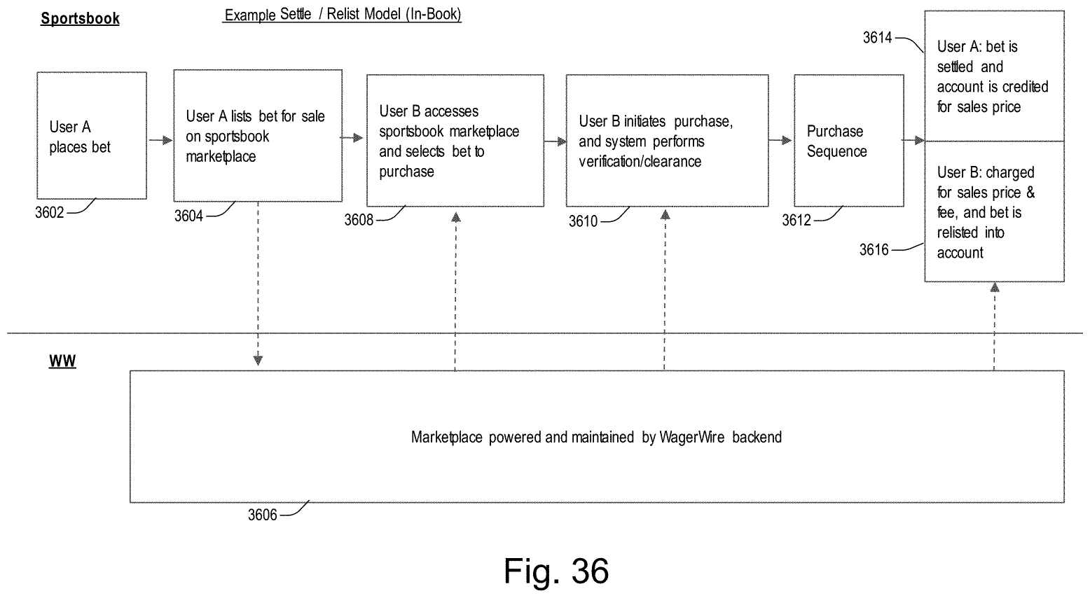

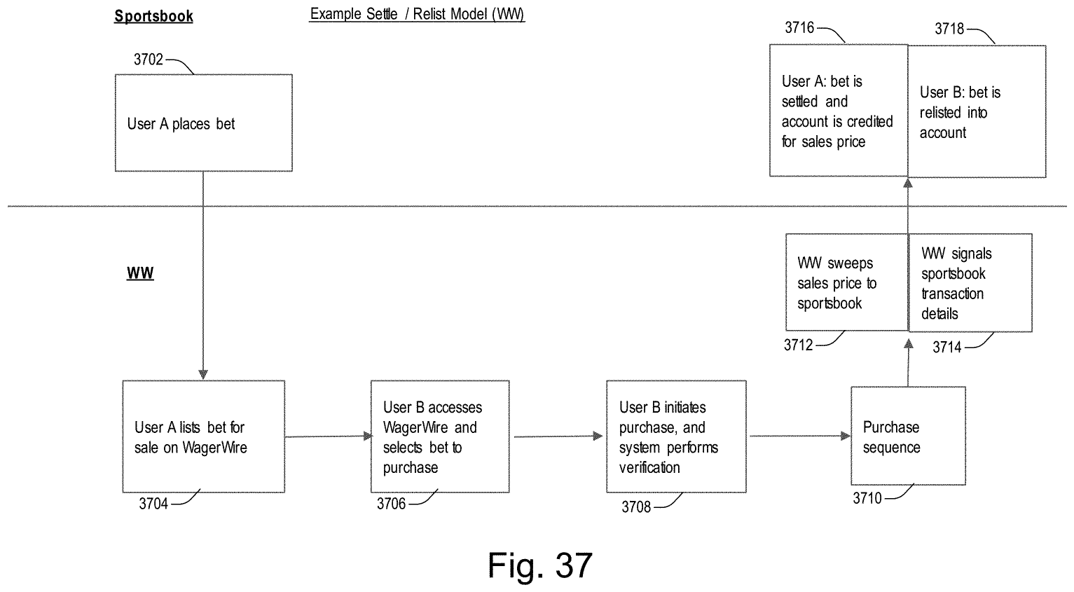

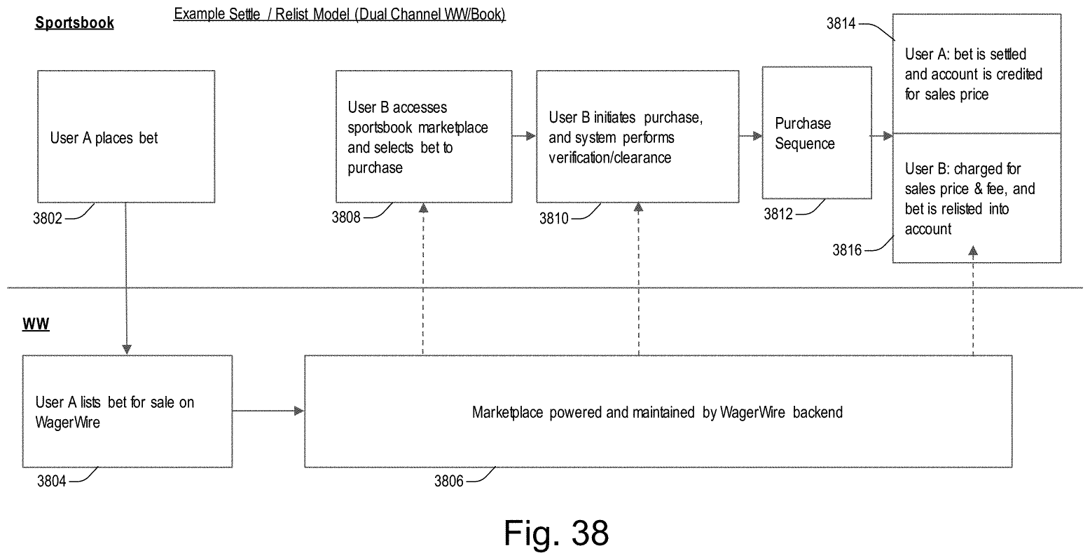

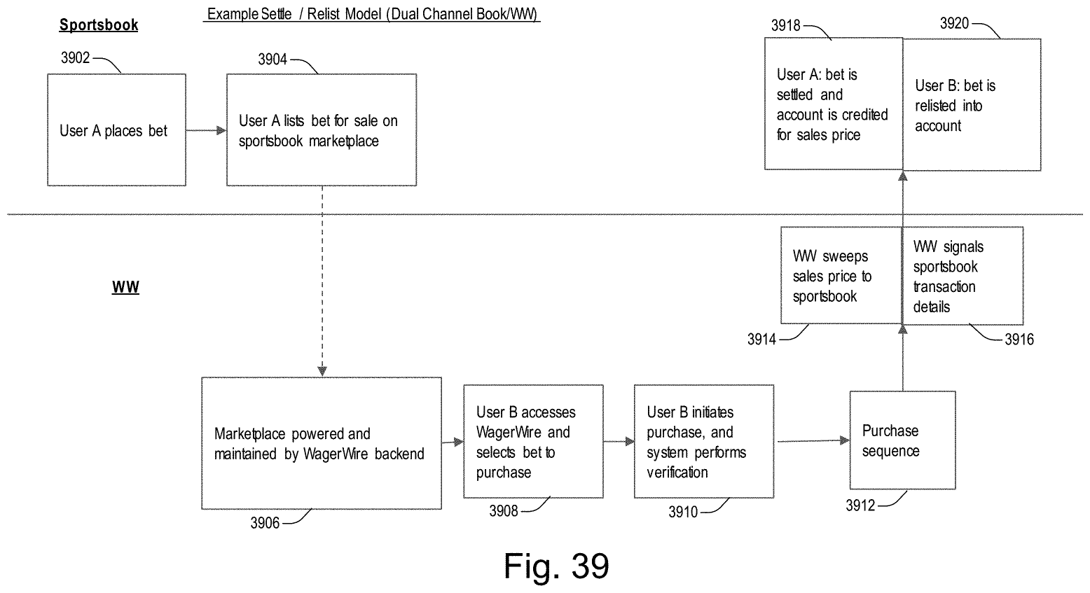

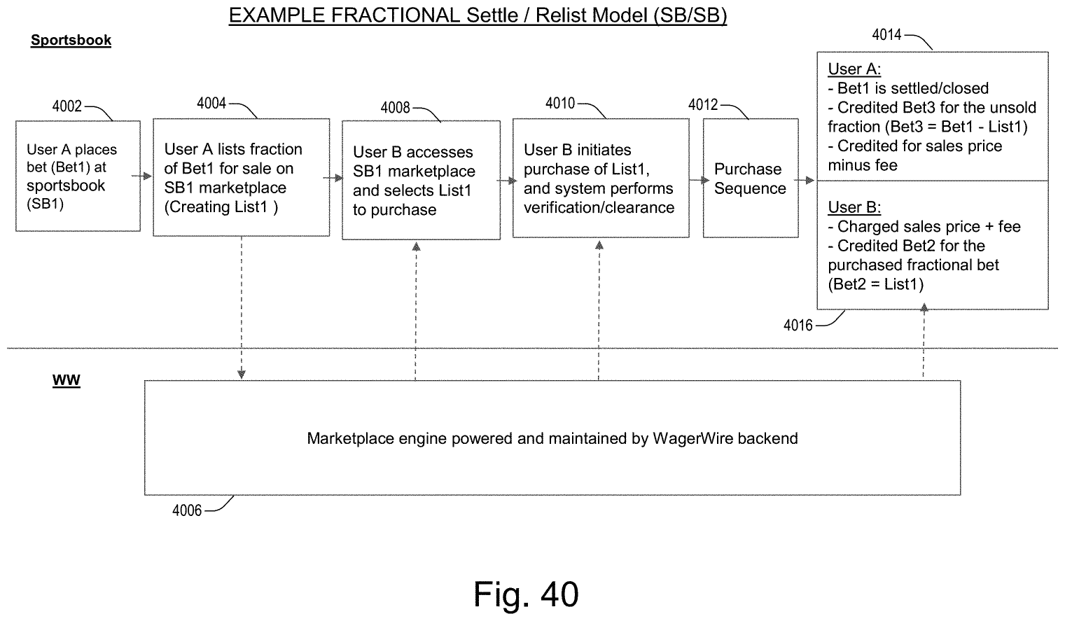

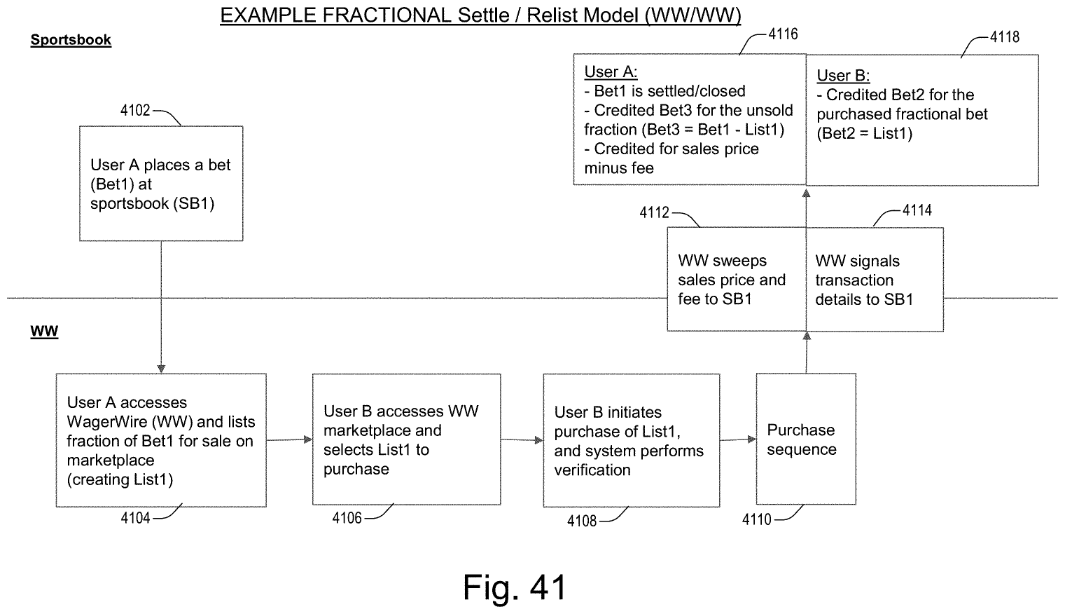

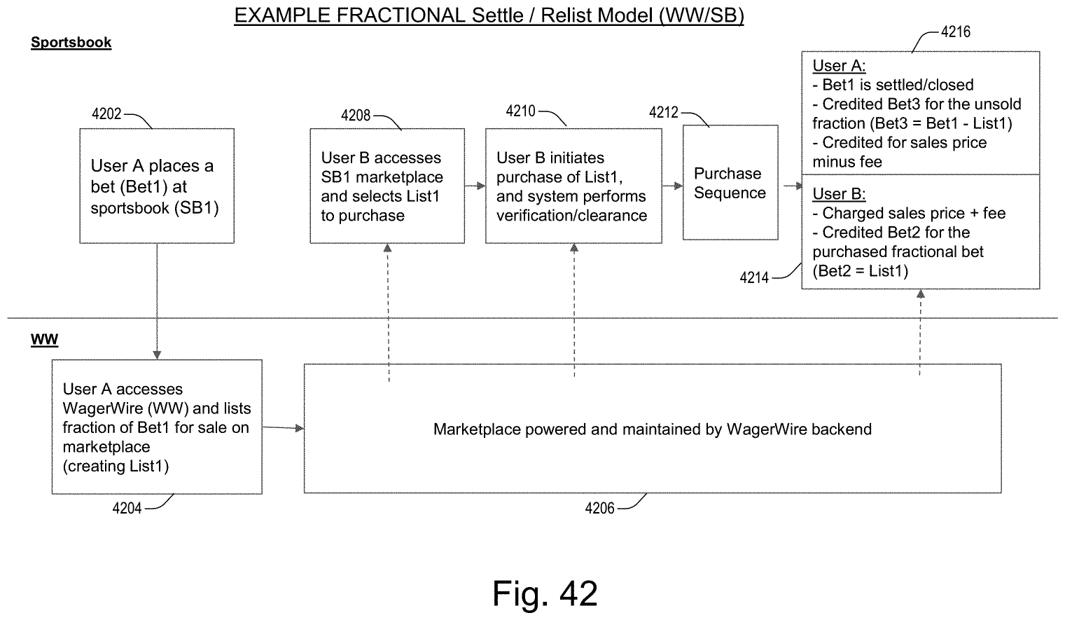

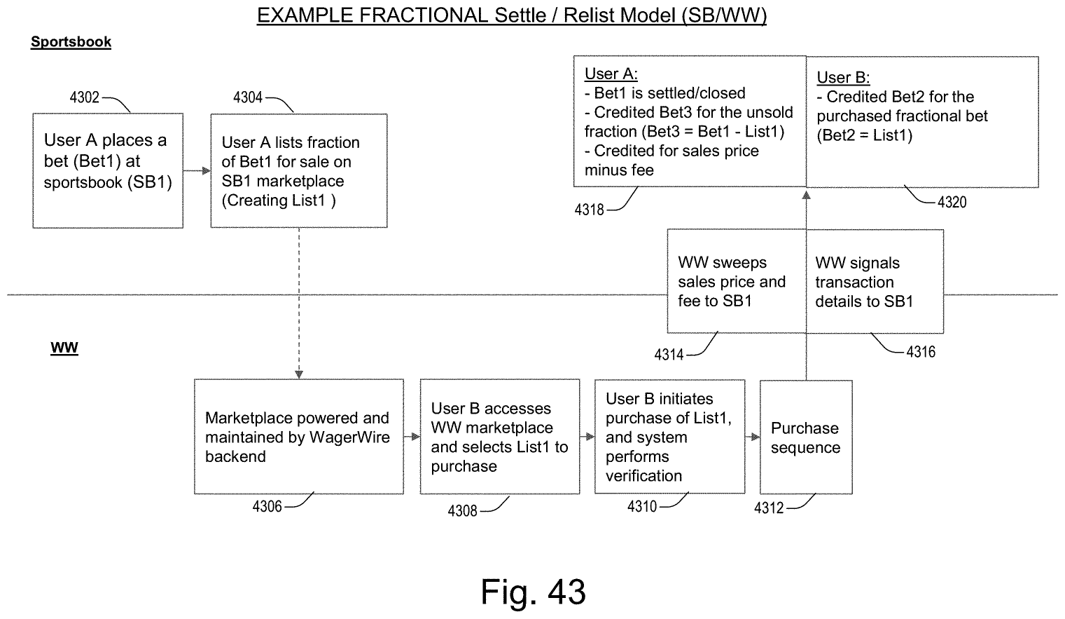

FIGS. 28-43 illustrate various example embodiments of different procedural flows which may be configured or designed to utilize different types of front-end user experience models and/or transaction settlement methods for facilitating activities relating to one or more of the electronic bet ticket exchange techniques disclosed herein. For reference purposes, a brief description of the different example procedural flow embodiments of FIG. 28-43 is provided below:
FIG. 28—Whole bet Escrow Model example procedural flow.
FIG. 29—Fractional Bet Escrow Model example procedural flow.
FIG. 30—Aggregation Engine Data Flow example procedural flow.
FIG. 31—In-Sportsbook Implementation example procedural flow.
FIG. 32—Dual Channel—Book/WW example procedural flow.
FIG. 33—Dual Channel—WW/Book example procedural flow.
FIG. 34—Dual Channel (Book/WW)—escrow Model example procedural flow.
FIG. 35—Dual Channel (WW/Book)—escrow Model example procedural flow.
FIG. 36—Settle/Relist Model (SB/SB) example procedural flow.
FIG. 37—Settle/Relist Model (WW/WW) example procedural flow.
FIG. 38—Settle/Relist Model (WW/SB) example procedural flow.
FIG. 39—Settle/Relist Model (SB/WW) example procedural flow.
FIG. 40—Fractional Settle/Relist Model (SB/SB) example procedural flow.
FIG. 41—Fractional Settle/Relist Model (WW/WW) example procedural flow.
FIG. 42—Fractional Settle/Relist Model (WW/SB) example procedural flow.
FIG. 43—Fractional Settle/Relist Model (SB/WW) example procedural flow.

FIG. 36 shows an example embodiment of a Settle/Relist Model (SB/SB) example procedural flow for conducting an electronic bet ticket exchange transaction between User A (Seller) and User B (Buyer) for selling/purchasing, via an electronic bet ticket exchange marketplace (“WW”), a 100% ownership interest (“whole bet”) of an electronic bet ticket originating from a first Sportsbook entity (“Sportsbook”). In the specific example embodiment of FIG. 36, it is assumed that User A and User B are each using the Sportsbook's mobile application to access the electronic bet ticket exchange marketplace.

User A visits/logs into Sportsbook (e.g., via Sportsbook application or in-person) and places (3602) a sports-related wager or bet. The Sportsbook generates an electronic bet ticket reflecting the terms of the sports-related wager placed by User A, records the electronic bet ticket in the Sportsbook's database, and assigns the electronic bet ticket to User A's Sportsbook account.

User A accesses Sportsbook marketplace (e.g., via Sportsbook's application powered by WagerWire), and initiates (3604) a listing for selling the selected electronic bet ticket via the WagerWire marketplace. In some embodiments, the WagerWire marketplace may be implemented as a “white label” electronic bet ticket exchange marketplace under the Sportsbook's own branding.

In at least one embodiment, the WagerWire system may periodically monitor the status of the electronic bet ticket listing and originating electronic bet ticket in order to determine if the listing has been subsequently canceled, or if the originating electronic bet ticket has been cashed out. If the WagerWire system determines that that identified electronic bet ticket has been cancelled or cashed out, it may automatically initiate at least one action for canceling or removing the electronic bet ticket listing from the electronic bet ticket exchange marketplace.

In at least one embodiment, the Sportsbook marketplace listings are powered and/or maintained (3606) by WagerWire system backend, which may be configured or designed to provide a feed of filtered listings associated with bets originating from that Sportsbook (e.g., backend functionality abstracted from user).

User B accesses WagerWire application, browses WagerWire marketplace, and identifies (3608) bet listing for purchase.

User B initiates (3610) request to purchase identified bet listing. System performs verification/clearance analysis to confirm eligibility and approval for purchasing of listing (e.g. bet listing status, User KYC, user geolocation, jurisdiction/regulation compliance, AML compliance, etc.). Additionally, as checkout is initiated, the bet listing status may be updated to “checkout” status, for example, in order to prevent other users from purchasing the identified electronic bet ticket for a specified time interval.

System initiates (3612) electronic bet ticket purchase sequence. For example, in one embodiment, following system approval/clearance, system checks if odds have changed, and if this results in a new price, User B is prompted to accept new price. Thereafter, User B completes purchase using Sportsbook account fund balance.

Upon completion of electronic bet ticket purchase transaction by User B, the WagerWire system may automatically transmit transaction details of the electronic bet ticket purchase transaction to the Sportsbook system which originated the electronic bet ticket.

Sportsbook system initiates purchase transaction settlement operations. System debits (3616) User B for the sales price and transaction fee, credits User A for the sales price. User A's bet is settled (3614) or closed and bet is relisted into User B's account based on the transaction parameters. In at least one embodiment, the relisting of the bet into User B's account results in a new electronic bet ticket (representing the relisted bet) being generated at the Sportsbook database and assigned to User B's Sportsbook account.

FIGS. 50A-50O illustrate example screenshots of different graphical user interfaces (GUIs) which may be generated by a mobile device application (e.g., WagerWire application, Sportsbook application) running on a user's mobile computing device (e.g., smartphone) for enabling the user to engage in various electronic bet ticket exchange transactions with other users via an online electronic bet ticket exchange marketplace.

By way of illustration, an example walk-through description of the procedural flow of FIG. 36 is described below with reference to the example GUI screenshot embodiments of FIGS. 50A-O.

| FIG. # | Example Activity Enabled by GUI |
|---|---|
| 50A | User A accesses Sportsbook platform (contracted Sportsbook partner of WW) |
| 50B | User A logs into Sportsbook account |
| 50C | User A accesses my bets page |
| 50D | User A selects an open bet to list for sale |
| 50E | User A completes sell listing form by selecting the price to list for |
| 50F | User A posts bet for sale, creating a sale listing in the WagerWire marketplace listings database |
| 50F | Upon listing the bet for sale, a WagerWire account is created for that user. If that user already has an |
| | existing WagerWire account, the system will match the two and associate the listing to their existing |
| | account |
| 50G | User A receives confirmation of sales listing on the marketplace |
| 50H | If User A subsequently attempts to cash out the bet while it is actively listed for sale, the system warns |
| | them that the bet listing will be cancelled |
| 50I | User B accesses Sportsbook platform |
| 50J | User B logs into Sportsbook account |
| 50K | User B accesses Sportsbook marketplace and browses available bets for sale (bets can be filtered by |
| | geolocation of User B, if necessary) |
| 50L | User B selects bet they intend to purchase |
| 50M | User B initiates checkout |
| 50N | System performs verification/clearance analysis to confirm eligibility and approval for purchasing of |
| | listing (e.g., bet listing status, User KYC, user geolocation, AML, etc.) |
| 50N | Additionally, as checkout is initiated, bet listing status is updated to checkout status such that no other |
| | users can complete purchase for a period of time. |
| 50N | Upon purchasing the bet, a WagerWire account is created for that user. If that user already has an existing |
| | WagerWire account, the system will match the two and associate the purchased bet to their existing |
| | account |
| No GUI | Transaction Execution process initiates: |
| No GUI | Sportsbook debits User B's account for sales price and transaction fee |
| No GUI | Sportsbook settles User A's bet and relists it into User B's account based on the transaction parameters |
| No GUI | Sportsbook credits User A's account for the sales price |
| No GUI | WagerWire and Sportsbook split the transaction fee at a predetermined rate per contractual agreement |
| 50O | User B receives confirmation of purchase completion and the bet now belongs to User B's Sportsbook |
| | account |

FIG. 38 shows an example embodiment of a Settle/Relist Model (WW/SB) example procedural flow for conducting an electronic bet ticket exchange transaction between User A (Seller) and User B (Buyer) for selling/purchasing, via an electronic bet ticket exchange marketplace (“WW”), a 100% ownership interest (“whole bet”) of an electronic bet ticket originating from a first Sportsbook entity (“Sportsbook”). In the specific example embodiment of FIG. 38, it is assumed that User A is using the WagerWire mobile application to access the electronic bet ticket exchange marketplace, and that User B is using the Sportsbook mobile application to access the electronic bet ticket exchange marketplace.

At 3802, User A visits/logs into Sportsbook (e.g., via Sportsbook application or in-person) and places (3602) a sports-related wager or bet. The Sportsbook generates an electronic bet ticket reflecting the terms of the sports-related wager placed by User A, records the electronic bet ticket in the Sportsbook's database, and assigns the electronic bet ticket to User A's Sportsbook account.

At 3804 and 3806, User A accesses the WagerWire marketplace via the WagerWire application and lists the electronic bet ticket for sale on the marketplace. In at least one embodiment, the electronic bet ticket may be listed as available for sale on both the WagerWire marketplace and the Sportsbook's “internal” marketplace, which may be powered by the WagerWire system backend.

At 3808, User B accesses Sportsbook application, browses the Sportsbook's internal marketplace powered by WagerWire, and identifies User A's electronic bet ticket listing for purchase.

At 3810, User B initiates request to purchase the electronic bet ticket listing. System performs verification/clearance analysis to confirm eligibility and approval for purchasing of listing. Additionally, as checkout is initiated, bet listing status is updated to checkout status such that no other users can complete purchase for a period of time.

At 3812, the WagerWire system initiates electronic bet ticket purchase sequence. User B completes purchase using Sportsbook account fund balance.

At 3814 the WagerWire system transmits the electronic bet ticket purchase transaction details to the Sportsbook system.

At 3816, the Sportsbook system initiates purchase transaction settlement operations. Sportsbook debits User B's account for the sales price and transaction fee, and credits User A for the sales price. User A's bet is settled and bet is relisted into User B's account based on the transaction parameters. In at least one embodiment, the relisting of the bet into User B's account results in a new electronic bet ticket (representing the relisted bet) being generated at the Sportsbook database and assigned to User B's Sportsbook account.

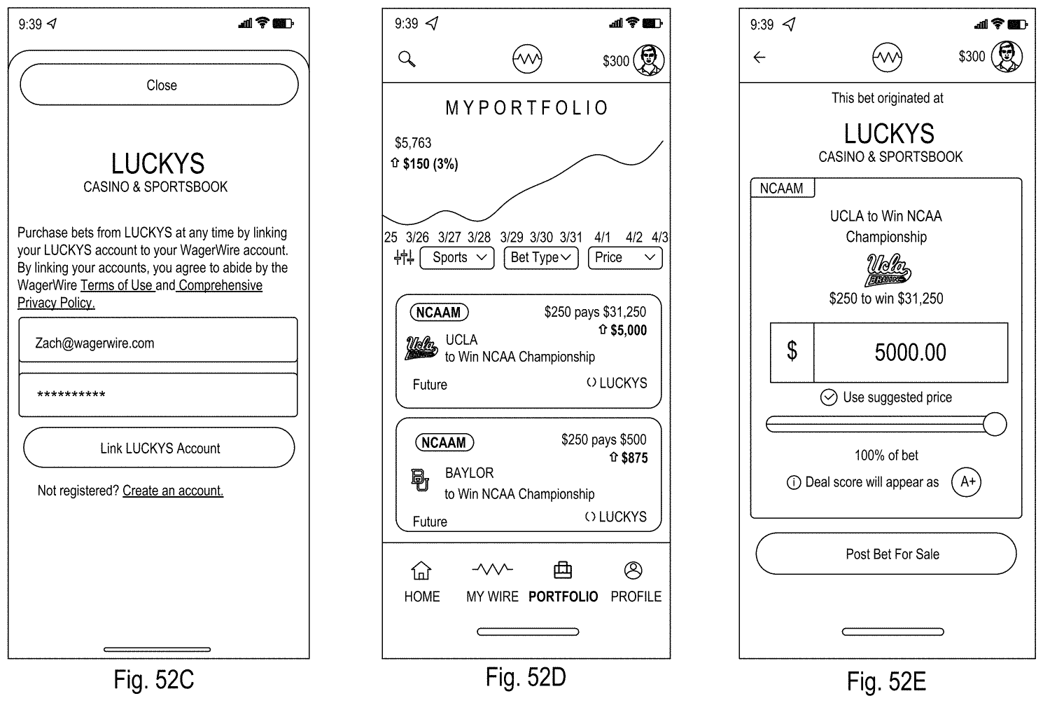

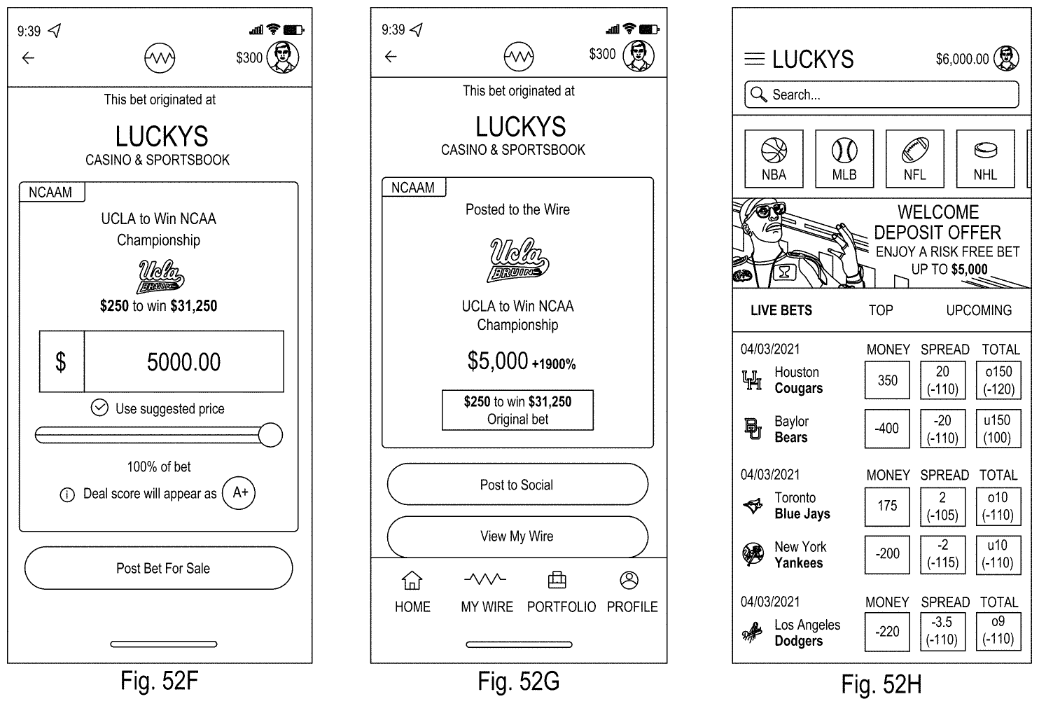

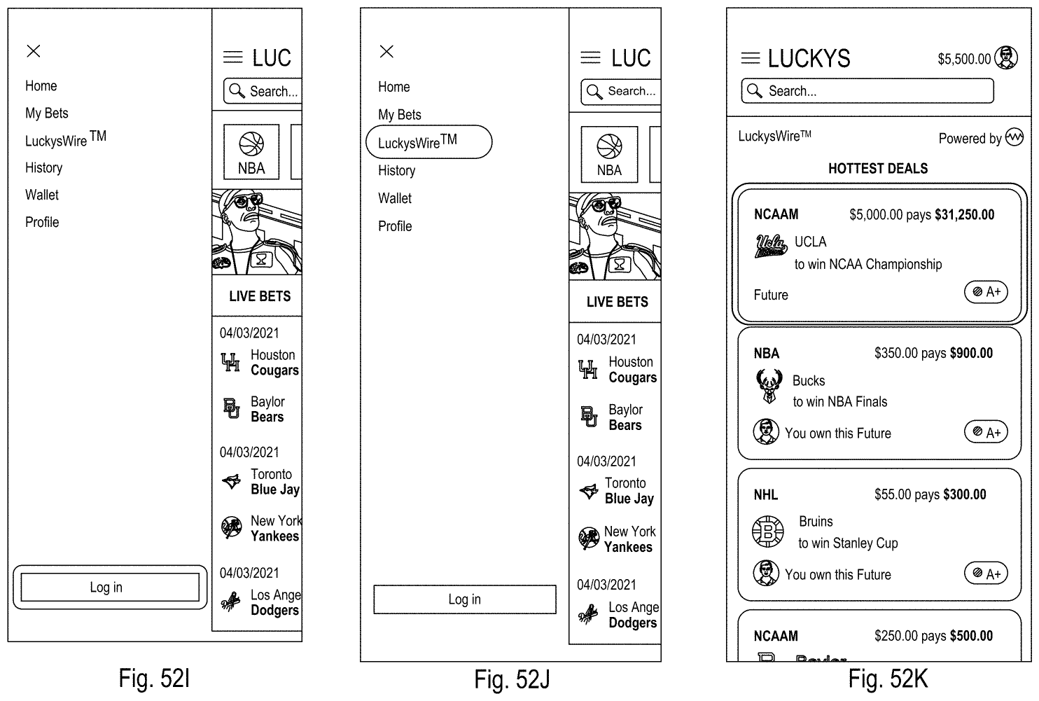

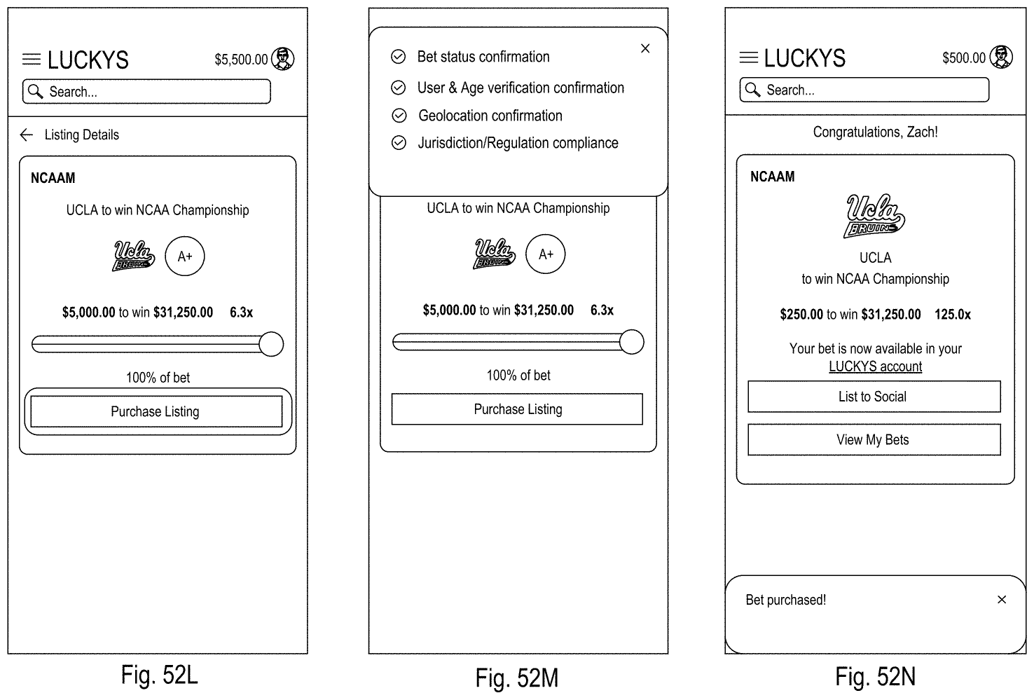

FIGS. 52A-52N illustrate example screenshots of different graphical user interfaces (GUIs) which may be generated by a mobile device application (e.g., WagerWire application) running on a user's mobile computing device (e.g., smartphone) for enabling the user to engage in various electronic bet ticket exchange transactions with other users via an online electronic bet ticket exchange marketplace.

By way of illustration, an example walk-through description of the procedural flow of FIG. 38 is described below with reference to the example GUI screenshot embodiments of FIGS. 52A-52N.

| FIG. # | Example Activity Enabled by GUI |
|---|---|
| 52A | User A accesses WagerWire platform |
| 52B | User A logs into WagerWire account |
| 52C | User A gains Sportsbook permissions through authentication of user login and password with online |
| | Sportsbook |
| 52D | User A selects an open bet to list for sale |
| 52E | User A chooses a price to list for |
| 52F | User A posts bet for sale, creating sales listing |
| 52G | User A receives confirmation of sales listing on the marketplace |
| 52H | User B accesses Sportsbook platform |
| 52I | User B logs into Sportsbook account |
| 52J | User B accesses Sportsbook marketplace and browses available bets for sale (bets can be filtered by |
| | geolocation of User B, if desired) |
| 52K | User B selects bet they intend to purchase |
| 52L | User B initiates checkout |
| 52M | System performs verification/clearance analysis to confirm eligibility and approval for purchasing of |
| | listing. Additionally, as checkout is initiated, bet listing status is updated to checkout status such that |
| | no other users can complete purchase for a period of time. |
| 52M | Upon purchasing the bet, a WagerWire account is created for that user. If that user already has an |
| | existing WagerWire account, the system will match the two and associate the purchased bet to their |
| | existing account |
| No GUI | Transaction Execution process initiates: |
| No GUI | Sportsbook debits User B's account for sales price and transaction fee |
| No GUI | Sportsbook settles User A's bet and relists it into User B's account based on the transaction parameters |
| No GUI | Sportsbook credits User A's account for the sales price |
| No GUI | WagerWire and Sportsbook split the transaction fee at a predetermined rate per contractual agreement |
| 52N | User B receives confirmation of purchase completion, and the bet is assigned to User B's Sportsbook |
| | account |

FIG. 39 shows an example embodiment of a Settle/Relist Model (SB/WW) example procedural flow for conducting an electronic bet ticket exchange transaction between User A (Seller) and User B (Buyer) for selling/purchasing, via an electronic bet ticket exchange marketplace (“WW”), a 100% ownership interest (“whole bet”) of an electronic bet ticket originating from a first Sportsbook entity (“Sportsbook”). In the specific example embodiment of FIG. 39, it is assumed that User B is using the WagerWire mobile application to access the electronic bet ticket exchange marketplace, and that User A is using the Sportsbook mobile application to access the electronic bet ticket exchange marketplace.

At 3902, User A visits/logs into Sportsbook (e.g., via Sportsbook application or in-person) and places (3602) a sports-related wager or bet. The Sportsbook generates an electronic bet ticket reflecting the terms of the sports-related wager placed by User A, records the electronic bet ticket in the Sportsbook's database, and assigns the electronic bet ticket to User A's Sportsbook account.

At 3904, User A accesses Sportsbook's internal marketplace (e.g., powered by WagerWire), and lists the electronic bet ticket for sale.

At 3906, the Sportsbook marketplace listings are powered and/or maintained by WagerWire system backend, which may be configured or designed to provide a feed of filtered listings associated with bets originating from that

Sportsbook (e.g., backend functionality abstracted from user).

At 3908, User B accesses Sportsbook application, browses the Sportsbook's internal marketplace powered by WagerWire, and identifies User A's electronic bet ticket listing for purchase.

At 3910, User B initiates request to purchase the electronic bet ticket listing. WagerWire system performs verification/clearance analysis to confirm eligibility and approval for purchasing of listing. Additionally, as checkout is initiated, bet listing status is updated to checkout status such that no other users can complete purchase for a period of time.

At 3912, the WagerWire system initiates electronic bet ticket purchase sequence. User B completes purchase using WagerWire account fund balance.

At 3914 and 3916, the WagerWire system transmits the electronic bet ticket purchase transaction details to the Sportsbook system, and transfers the sales price and transaction fee to the Sportsbook.

At 3918 and 3920, the Sportsbook system initiates transaction settlement operations. Sportsbook system credits User A account for the sales price. User A's bet is settled and bet is relisted into User B's account based on the transaction parameters. In at least one embodiment, the relisting of the bet into User B's account results in a new electronic bet ticket (representing the relisted bet) being generated at the Sportsbook database and assigned to User B's Sportsbook account.

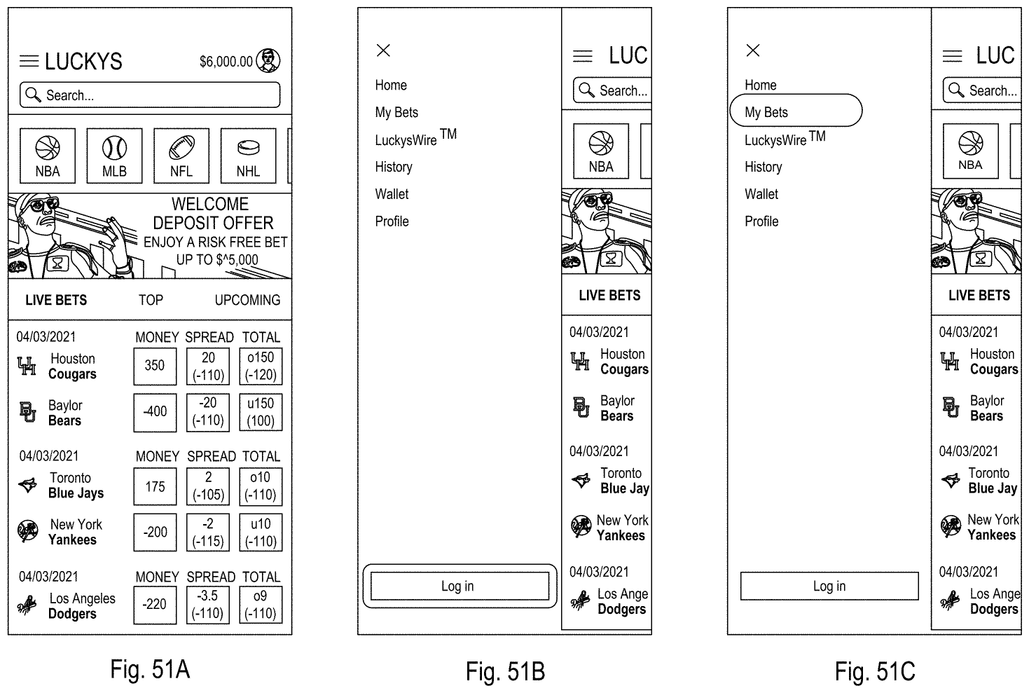

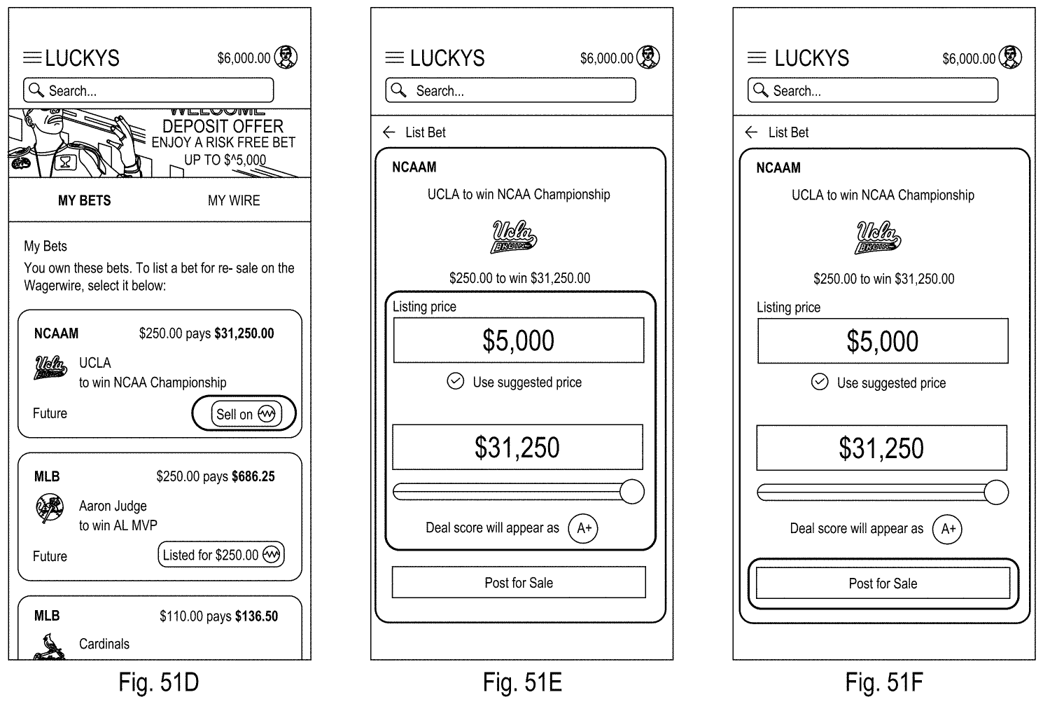

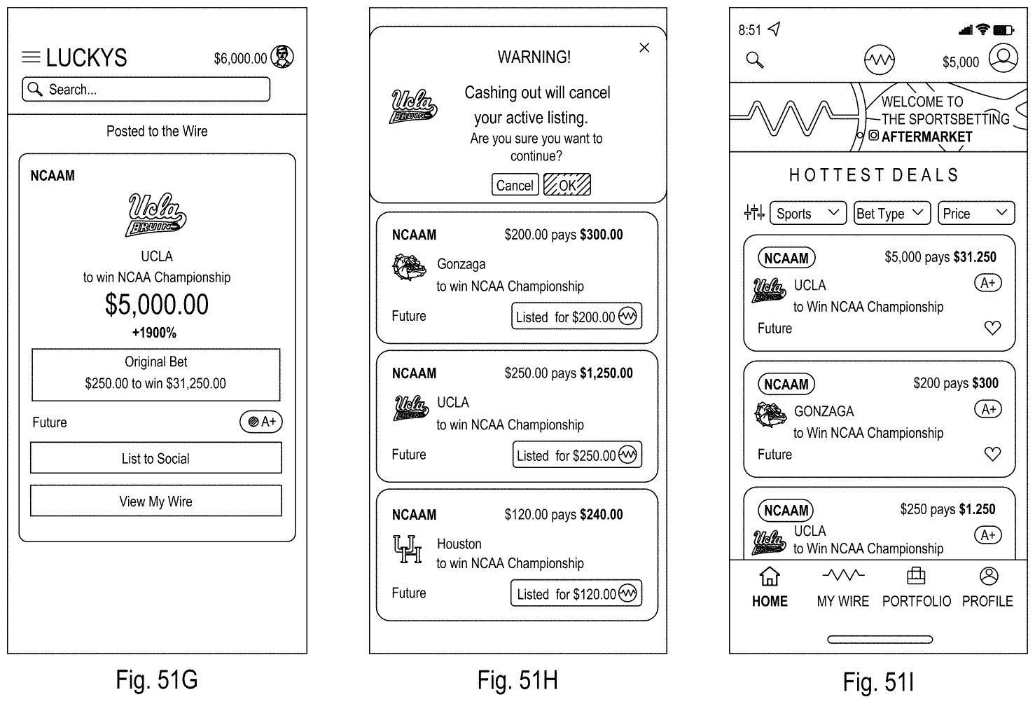

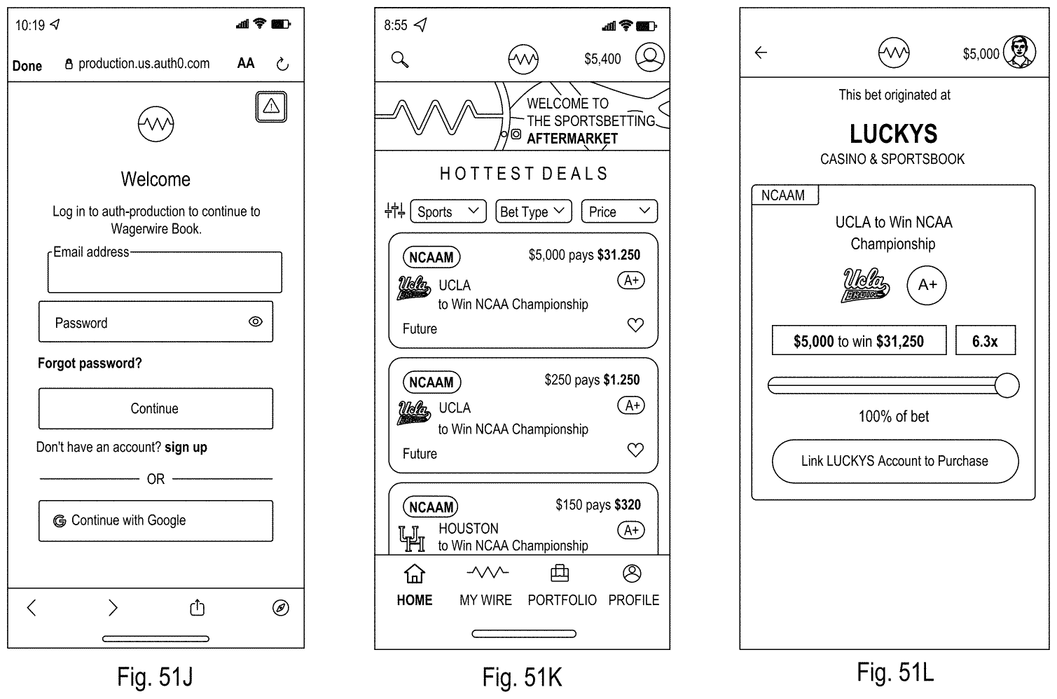

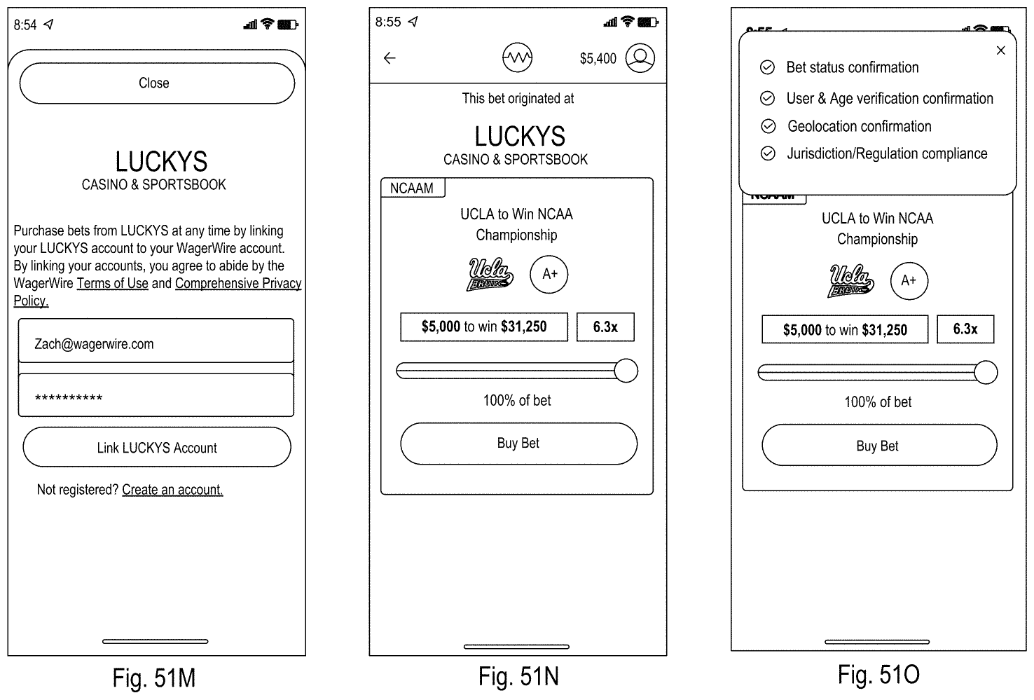

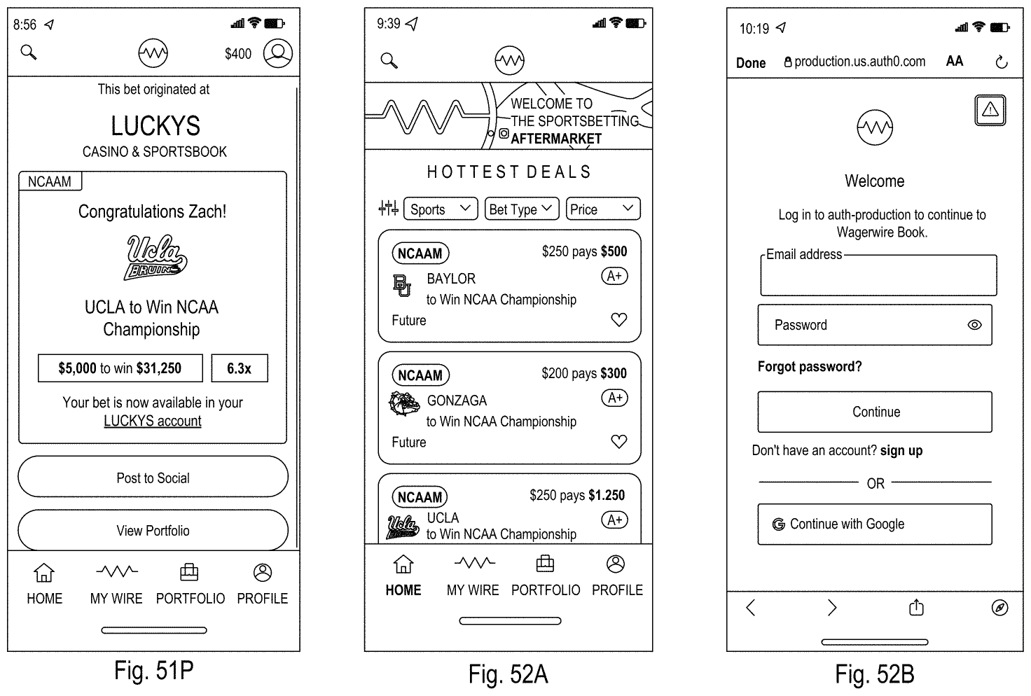

FIGS. 51A-52N illustrate example screenshots of different graphical user interfaces (GUIs) which may be generated by a mobile device application (e.g., WagerWire application) running on a user's mobile computing device (e.g., smartphone) for enabling the user to engage in various electronic bet ticket exchange transactions with other users via an online electronic bet ticket exchange marketplace.

By way of illustration, an example walk-through description of the procedural flow of FIG. 39 is described below with reference to the example GUI screenshot embodiments of FIGS. 51A-52P.

| FIG. # | Example Activity Enabled by GUI |
|---|---|
| 51A | User A accesses Sportsbook platform (contracted Sportsbook partner of WW) |
| 51B | User A logs into Sportsbook account |
| 51C | User A accesses my bets page |
| 51D | User A selects an open bet to list for sale |
| 51E | User A completes sell checkout form by selecting the price to list for |
| 51F | User A posts bet for sale, creating a sale listing |
| 51F | Upon listing the electronic bet ticket for sale, a WagerWire account is created for that user. If that user |
| | already has an existing WagerWire account, the KYC would match up and instead associate the listing |
| | to their existing account |
| 51G | User A receives confirmation of sales listing on the marketplace |
| 51H | If User A subsequently attempts to cash out the electronic bet ticket while it is actively listed for sale, |
| | the system warns them that the electronic bet ticket listing will be cancelled |
| 51I | User B accesses WagerWire platform |
| 51J | User B logs into WagerWire account |
| 51K | User B browses availability bets for sale and selects one to purchase (bets can be filtered by geolocation |
| | of User B, if desired) |
| 51L | User B reviews bet details and is prompted to authenticate account for the originating Sportsbook |
| 51M | User B gains Sportsbook permissions through authentication of user login and password with online |
| | Sportsbook. If User B does not already have an account with the Sportsbook, they are required to |
| | register for one. |
| 51N | User B initiates checkout process |
| 51O | System performs verification/clearance analysis to confirm eligibility and approval for purchasing of |
| | listing (e.g. bet listing status, User KYC, user geolocation). Additionally, as checkout is initiated, bet |
| | listing status is updated to checkout status such that no other users can complete purchase for a period |
| | of time. |
| No GUI | Transaction Execution process initiates: |
| No GUI | WagerWire transmits transaction details to Sportsbook. |
| No GUI | Payment from User B for the sales price and transaction fee is automatically transferred to the |
| | Sportsbook |
| No GUI | Sportsbook receives confirmation of the payment and credits User A's account for the sales price |
| No GUI | Sportsbook settles User A's bet and relists it into User B's account based on the transaction parameters |
| No GUI | WagerWire and Sportsbook split the transaction fee at a predetermined rate per contractual agreement |
| 51P | User B receives confirmation of purchase completion |

FIG. 37 shows an example embodiment of a Settle/Relist Model (WW/WW) example procedural flow for conducting an electronic bet ticket exchange transaction between User A (Seller) and User B (Buyer) for selling/purchasing, via an electronic bet ticket exchange marketplace (“WW”), a 100% ownership interest (“whole bet”) of an electronic bet ticket originating from a first Sportsbook entity (“Sportsbook”). In the specific example embodiment of FIG. 37, it is assumed that both User A and User B are each using the WagerWire mobile application to access the electronic bet ticket exchange marketplace.

At 3702, User A visits/logs into Sportsbook (e.g., via Sportsbook application or in-person) and places (3602) a sports-related wager or bet. The Sportsbook generates an electronic bet ticket reflecting the terms of the sports-related wager placed by User A, records the electronic bet ticket in the Sportsbook's database, and assigns the electronic bet ticket to User A's Sportsbook account.

At 3704, User A accesses the WagerWire marketplace via the WagerWire application and lists the electronic bet ticket for sale on the marketplace.

At 3706, User B accesses the WagerWire marketplace via the WagerWire application, browses marketplace and identifies the electronic bet ticket listing for purchase.

At 3708, User B initiates request to purchase the electronic bet ticket listing. System performs verification/clearance analysis to confirm eligibility and approval for purchasing of listing. Additionally, as checkout is initiated, bet listing status is updated to checkout status such that no other users can complete purchase for a period of time.

At 3710, the WagerWire system initiates electronic bet ticket purchase sequence. User B completes purchase using WagerWire account fund balance.

At 3712 and 3714, the WagerWire system transmits the electronic bet ticket purchase transaction details to the Sportsbook system, and transfers the sales price and transaction fee to the Sportsbook.

At 3716 and 3718, the Sportsbook system initiates purchase transaction settlement operations. Sportsbook system credits User A for the sales price. User A's bet is settled and bet is relisted into User B's account based on the purchase transaction parameters.

By way of illustration, an example walk-through description of the procedural flow of FIG. 37 is described below with reference to the example GUI screenshot embodiments of FIGS. 51I-P and 52A-G.

| FIG. # | Example Activity Enabled by GUI |
|---|---|
| 52A | User A accesses WagerWire platform via WagerWire application |
| 52B | User A logs into WagerWire account |
| 52C | User A gains Sportsbook permissions through authentication of user login and password with online |
| | Sportsbook. In at least one embodiment, this activity may be performed either before or during |
| | checkout process. |
| 52D | User A selects an open bet to list for sale |
| 52E | User A configures a sale price for the listing |
| 52F | User A posts bet for sale, creating sales listing |
| 52G | User A receives confirmation of sales listing on the marketplace |
| 51I | User B accesses WagerWire platform |
| 51J | User B logs into WagerWire account |
| 51M | User B gains Sportsbook permissions through authentication of user login and password with online |
| | Sportsbook |
| 51K | User B browses availability bets for sale and selects electronic bet ticket to purchase (bets can be filtered |
| | by geolocation of User B, if desired) |
| 51N | User B initiates checkout process, provides payment details. Payment may be made by direct point of |
| | sale (e.g., credit/debit card, etc.) and/or with pre-loaded funds in User B's WagerWire account. |
| 51O | System performs verification/clearance analysis to confirm eligibility and approval for purchasing of |
| | listing. Additionally, as checkout is initiated, bet listing status is updated to checkout status such that no |
| | other users can complete purchase for a period of time. |
| No GUI | Transaction Execution process initiates: |
| No GUI | WagerWire transmits transaction details to Sportsbook (bet ID, user A & user B, sales price) |
| No GUI | Payment from User B for the sales price and transaction fee is automatically transferred to the Sportsbook |
| No GUI | Sportsbook receives confirmation of the payment and credits User A's account for the sales price |
| No GUI | Sportsbook settles User A's bet and relists it into User B's account based on the transaction parameters |
| No GUI | WagerWire and Sportsbook split the transaction fee at a predetermined rate per contractual agreement |
| 51P | User B receives confirmation of completion of electronic bet ticket purchase |

FIG. 40 shows an example embodiment of a Settle/Relist Model (SB/SB) example procedural flow for conducting an electronic bet ticket exchange transaction between User A (Seller) and User B (Buyer) for selling/purchasing, via an electronic bet ticket exchange marketplace (“WW”), a fractional ownership interest (“fractional bet”) of an electronic bet ticket originating from a first Sportsbook entity (“Sportsbook”). In the specific example embodiment of FIG. 40, it is assumed that User A and User B are each using the Sportsbook's mobile application to access the electronic bet ticket exchange marketplace.

At 4002, User A accesses Sportsbook (SB1) (application or in-person) and places a bet (Bet1).

At 4004, User A accesses SB1 internal marketplace, powered by WagerWire, and elects to list a fraction of Bet1 for sale (creating List1). If Bet1 is subsequently cancelled or cashed out, then List1 will be cancelled.

At 4006, SB1 internal marketplace listings are maintained by WagerWire backend, filtered for only bets from that Sportsbook (backend functionality abstracted from user).

At 4008, User B accesses SB1 and browses the internal marketplace and selects List1 for purchase.

At 4010, User B initiates request to purchase List1. System performs verification/clearance analysis to confirm eligibility and approval for purchasing of List1 (e.g., bet listing status, User KYC, user geolocation, adequate funds available). Additionally, as checkout is initiated, bet listing status is updated to checkout status such that no other users can complete purchase for a period of time. Other Users could request purchase and wait in queue to purchase bet listing should User B fail to complete purchase.

At 4012, Purchase sequence commences: Following system approval/clearance, system checks if odds have changed, and if this results in a new price, User B is prompted to accept new price. Following all of the above, User B initiates purchase using SB1 account fund balance.

At 4014 and 4016, WagerWire system transmits transaction details to SB1 (e.g., User A, User B, Bet1, List1, Sales Price, Fee). Sportsbook performs transaction settlement:
User A: Bet1 is settled/closed; account is credited Bet3 for the unsold/remaining fraction (Bet3=Bet1−List1); account is credited for the sales price minus transaction fee.
User B: Account is charged for sales price plus transaction fee; account is credited Bet2 based upon the parameters of the listing (Bet2=List1).
System performs confirmation/reconciliation that Bet2+Bet3=Bet1 and all account balances are accurately reflected.

FIG. 42 shows an example embodiment of a Settle/Relist Model (WW/SB) example procedural flow for conducting an electronic bet ticket exchange transaction between User A (Seller) and User B (Buyer) for selling/purchasing, via an electronic bet ticket exchange marketplace (“WW”), a fractional ownership interest (“fractional bet”) of an electronic bet ticket originating from a first Sportsbook entity (“Sportsbook”). In the specific example embodiment of FIG. 42, it is assumed that User A is using the WagerWire mobile application to access the electronic bet ticket exchange marketplace, and that User B is using the Sportsbook mobile application to access the electronic bet ticket exchange marketplace.

At 4202, User A accesses Sportsbook (SB1) (application or in-person) and places a bet (Bet1).

At 4204, User A accesses WagerWire application and elects to list a fraction of Bet1 for sale (creating List1). If Bet1 is subsequently cancelled or cashed out, then List1 will be cancelled.

At 4206, SB1 internal marketplace listings are maintained by WagerWire backend, filtered for only bets from that Sportsbook (backend functionality abstracted from user).

At 4208, User B accesses SB1 and browses the internal marketplace and selects List1 for purchase.

At 4210, User B initiates request to purchase List1. System performs verification/clearance analysis to confirm eligibility and approval for purchasing of List1 (e.g., bet listing status, User KYC, user geolocation, adequate funds available). Additionally, as checkout is initiated, bet listing status is updated to checkout status such that no other users can complete purchase for a period of time. Other Users could request purchase and wait in queue to purchase bet listing should User B fail to complete purchase.

At 4212, Purchase sequence commences: Following system approval/clearance, system checks if odds have changed, and if this results in a new price, User B is prompted to accept new price. Following all of the above, User B initiates purchase using SB1 account fund balance.

At 4214 and 4216, WagerWire system transmits transaction details to SB1 (User A, User B, Bet1, List1, Sales Price, Fee). Sportsbook system performs transaction settlement:
User A: Bet1 is settled/closed; account is credited Bet3 for the unsold/remaining fraction (Bet3=Bet1−List1); account is credited for the sales price minus transaction fee.
User B: Account is charged for sales price plus transaction fee; account is credited Bet2 based upon the parameters of the listing (Bet2=List1).
System performs confirmation/reconciliation that Bet2+Bet3=Bet1 and all account balances are accurately reflected.

FIG. 43 shows an example embodiment of a Settle/Relist Model (SB/WW) example procedural flow for conducting an electronic bet ticket exchange transaction between User A (Seller) and User B (Buyer) for selling/purchasing, via an electronic bet ticket exchange marketplace (“WW”), a fractional ownership interest (“fractional bet”) of an electronic bet ticket originating from a first Sportsbook entity (“Sportsbook”). In the specific example embodiment of FIG. 43, it is assumed that User B is using the WagerWire mobile application to access the electronic bet ticket exchange marketplace, and that User A is using the Sportsbook mobile application to access the electronic bet ticket exchange marketplace.

At 4302, User A accesses Sportsbook (SB1) (application or in-person) and places a bet (Bet1)

At 4304, User A accesses SB1 internal marketplace, powered by WagerWire, and elects to list a fraction of Bet1 for sale (creating List1). If Bet1 is subsequently cancelled or cashed out, then List1 will be cancelled.

At 4306, SB1 internal marketplace listings are maintained by WagerWire backend, filtered for only bets from that Sportsbook (backend functionality abstracted from user)

At 4308, User B accesses WagerWire application and browses marketplace and selects List1 for purchase.

At 4310, User B initiates request to purchase List1. System performs verification/clearance analysis to confirm eligibility and approval for purchasing List1 (e.g., bet listing status, User KYC, user geolocation, adequate funds available). Additionally, as checkout is initiated, bet listing status is updated to checkout status such that no other users can complete purchase for a period of time.

At 4312, Purchase sequence commences: Following system approval/clearance, system checks if odds have changed, and if this results in a new price, User B is prompted to accept new price. Following all of the above, User B initiates purchase using WagerWire account fund balance, and/or using point of sale funds (e.g., credit card, debit card, etc.). WagerWire charges User B for sales price and transaction fee.

At 4314 and 4316, WagerWire system transmits transaction details to SB1 (e.g., User A, User B, Bet1, List1, Sales Price, Fee), and transfers the sales price and transaction fee to SB1 bank account

At 4318 and 4320, Sportsbook performs transaction settlement:
User A: Bet1 is settled/closed; account is credited Bet3 for the unsold/remaining fraction (Bet3=Bet1−List1); account is credited for the sales price minus transaction fee
User B: Account is credited Bet2 based upon the parameters of the listing (Bet2=List1)
System performs confirmation/reconciliation that Bet2+Bet3=Bet1 and all account balances are accurately reflected

FIG. 41 shows an example embodiment of a Settle/Relist Model (WW/WW) example procedural flow for conducting an electronic bet ticket exchange transaction between User A (Seller) and User B (Buyer) for selling/purchasing, via an electronic bet ticket exchange marketplace (“WW”), a fractional ownership interest (“fractional bet”) of an electronic bet ticket originating from a first Sportsbook entity (“Sportsbook”). In the specific example embodiment of FIG. 41, it is assumed that both User A and User B are each using the WagerWire mobile application to access the electronic bet ticket exchange marketplace.

At 4102, User A accesses Sportsbook (SB1) (application or in-person) and places a bet (Bet1)

At 4104, User A accesses WagerWire application and elects to list a fraction of Bet1 for sale (creating List1). If Bet1 is subsequently cancelled or cashed out, then List1 will be cancelled.

At 4106, User B accesses WagerWire application and browses marketplace and selects List1 for purchase.

At 4108, User B initiates request to purchase List1. System performs verification/clearance analysis to confirm eligibility and approval for purchasing List1 (e.g., bet listing status, User KYC, user geolocation, adequate funds available). Additionally, as checkout is initiated, bet listing status is updated to checkout status such that no other users can complete purchase for a period of time.

At 4110, Purchase sequence commences: Following system approval/clearance, system checks if odds have changed, and if this results in a new price, User B is prompted to accept new price. Following all of the above, User B initiates purchase using WagerWire account fund balance. WagerWire charges User B for sales price and transaction fee.

At 4112 and 4114, WagerWire system transmits transaction details to SB1 (e.g., User A, User B, Bet1, List1, Sales Price, Fee), and transfers the sales price and transaction fee to SB1 bank account

At 4116 and 4118, Sportsbook performs transaction settlement:
User A: Bet1 is settled/closed; account is credited Bet3 for the unsold/remaining fraction (Bet3=Bet1−List1); account is credited for the sales price minus transaction fee
User B: Account is credited Bet2 based upon the parameters of the listing (Bet2=List1)
System performs confirmation/reconciliation that Bet2+Bet3=Bet1 and all account balances are accurately reflected

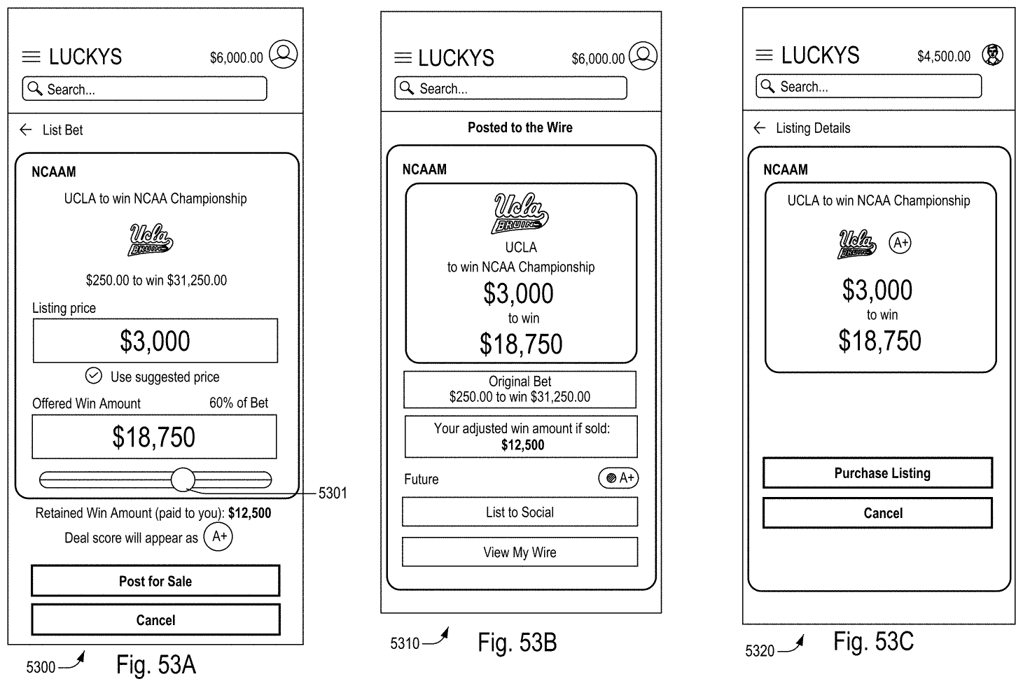

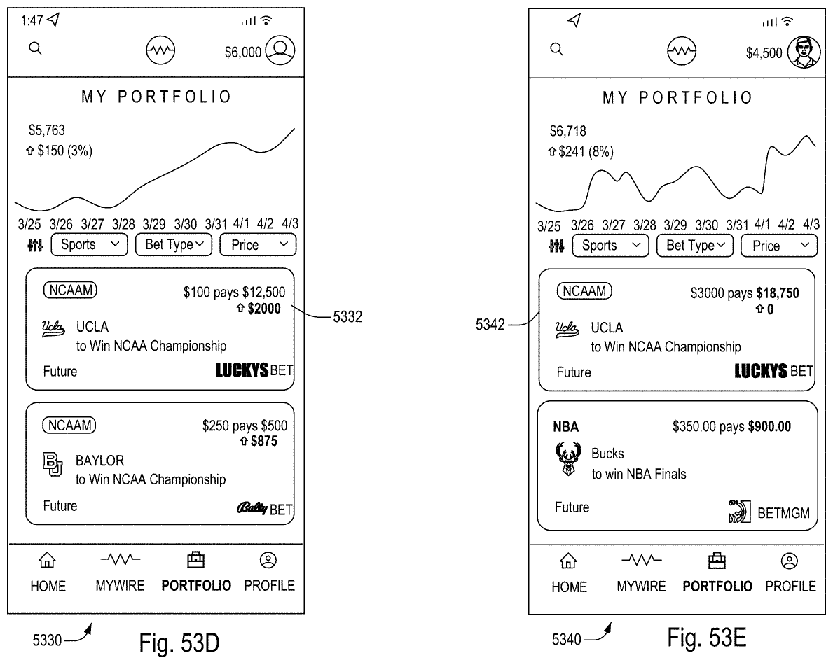

FIGS. 53A-E show example GUI screenshots relating to an example procedural flow involving the sale/purchase of a fractional portion of an electronic bet ticket via an electronic bet ticket exchange marketplace. By way of illustration, an example walk-through description of the procedural flow relating to FIGS. 53A-E is described below.

User A accesses Sportsbook platform, logs into Sportsbook account, and places a bet for $250 on ‘UCLA to win the NCAA Championship’ at 125-1 odds for a potential payout of $31,250 (herein “UCLA bet”). The Sportsbook system updates User A's account accordingly, assigning 100% ownership of the newly created electronic sports bet ticket (“UCLA electronic bet ticket”) to User A.

Later in the season, User A decides to list a fractional portion of the UCLA bet for sale. User A logs into the Sportsbook platform, and selects the UCLA bet to list for sale.

The system responds by presenting an Offer Configuration GUI to User A (e.g., via the Sportsbook mobile application). In one embodiment, the Offer Configuration GUI may initially be configured with default parameters for the whole bet, as illustrated, for example, in FIG. 51E. In one embodiment, the WagerWire system may dynamically calculate and display a suggested sale price of $5000 for selling 100% of the entire bet.

However, User A desires to sell 60% ownership of the bet, and retain 40% ownership. Accordingly, in one embodiment, User A manually adjusts the fractional slider button (e.g., 5301, FIG. 53A) to the 60% position, as illustrated in FIG. 53A. The displayed values of the suggested listing price and win amount may proportionately increase/decrease relative to the position of the fractional slider button. As illustrated in the example embodiment of FIG. 53A, the proposed listing as currently configured corresponds to an offer to sell a 60% ownership portion of the bet at a listing price of $3,000, and a potential win amount $18,750.

User A confirms posting of the listing at the electronic bet ticket exchange marketplace (powered by WagerWire), and the Sportsbook mobile application displays a confirmation of the posted listing, e.g., as illustrated in FIG. 53B.

User B logs into the electronic bet ticket exchange marketplace, browses available bets for sale, and selects the bet listing posted by User A. User B is presented with a bet purchase confirmation GUI, as illustrated, for example, in FIG. 53C. User B selects “Purchase Listing” to initiate the checkout/purchase process.

System performs verification/clearance analysis to confirm eligibility and approval for purchasing of listing. User B provides payment details for completing the purchase, and the system processes and completes the purchase transaction.

Upon completion of the bet purchase transaction, the Sportsbook system is notified of the completed purchase transaction, along with details relating to the purchase offer. The Sportsbook system executes transaction settlement processes which, for example, may include, but is not limited to:
Sportsbook debits User B's Sportsbook account for sales price and transaction fee.
Distribute funds/credits of fractional electronic bet ticket sale to User A's Sportsbook Acct.
Update status of UCLA electronic bet ticket as “settled” or “closed”.
Create new electronic bet ticket (e.g., UCLA Bet 1) using data associated with purchase transaction, and data associated with the UCLA electronic bet ticket.
Record UCLA Bet 1 electronic bet ticket details at Sportsbook database.
Update Sportsbook database to link ownership of UCLA Bet 1 electronic bet ticket with User B's Sportsbook Account.
Create new electronic bet ticket (e.g., UCLA Bet 2) representing User A's remaining ownership interest and modified payout amount associated based on data associated with purchase transaction, and data associated with the UCLA electronic bet ticket.
Record UCLA Bet 2 electronic bet ticket details at SB1 database.
Update Sportsbook database to link ownership of UCLA Bet 2 electronic bet ticket with User A's Sportsbook Account.
Transmit confirmation of successful completion of purchase transaction to electronic bet ticket exchange system.

In at least one embodiment, after completion of the bet purchase transaction settlement processes, a representation of the UCLA Bet 1 electronic bet ticket assigned to User B may appear in User B's WagerWire account portfolio (and/or User B's Sportsbook account portfolio) as illustrated, for example, at 5342 of FIG. 53E.

Similarly, after completion of the bet purchase transaction settlement processes, a representation of the User A's remaining ownership portion of the original UCLA electronic bet ticket (now settled and reissued as UCLA Bet 2) may appear in User A's WagerWire account portfolio (and/or User B's Sportsbook account portfolio) as illustrated, for example, at 5332 of FIG. 53D.

As illustrated in the example embodiment of FIGS. 53D and 53E, the values reflecting the wager amount and win amount of each respective electronic bet ticket have been automatically and dynamically calculated and populated (e.g., by the WagerWire system) based on the details of the UCLA bet and the fractional UCLA bet purchase transaction.

For example, as illustrated in the example embodiment of FIG. 53E, the bet amount value and win amount value of the electronic bet ticket 5342 reflects the purchase price and win amount values corresponding to the fractional UCLA bet purchase transaction.

As illustrated in the example embodiment of FIG. 53D, the bet amount value and win amount value of the electronic bet ticket 5332 reflects purchase price and win amount values which are proportional to the percentage ownership of the UCLA electronic bet ticket which User A retained after completion of the fractional UCLA bet purchase transaction. By way of illustration, in this example scenario, User A sold a 60% ownership portion of the UCLA bet to User B, and retained a 40% ownership portion. The original wager amount of the UCLA bet was $250 for 100% ownership portion. Since User A retained a 40% ownership portion, the adjusted wager amount for the UCLA Bet 2 electronic bet ticket may be calculated as $250*40%=$100. Similarly, the adjusted win amount for the UCLA Bet 2 electronic bet ticket may be calculated as $31,250*40%=$12,500. Alternatively, the adjusted win amount for the UCLA Bet 2 electronic bet ticket may be calculated as $31,250−$18,750 (win amount sold to User B)=$12,500.

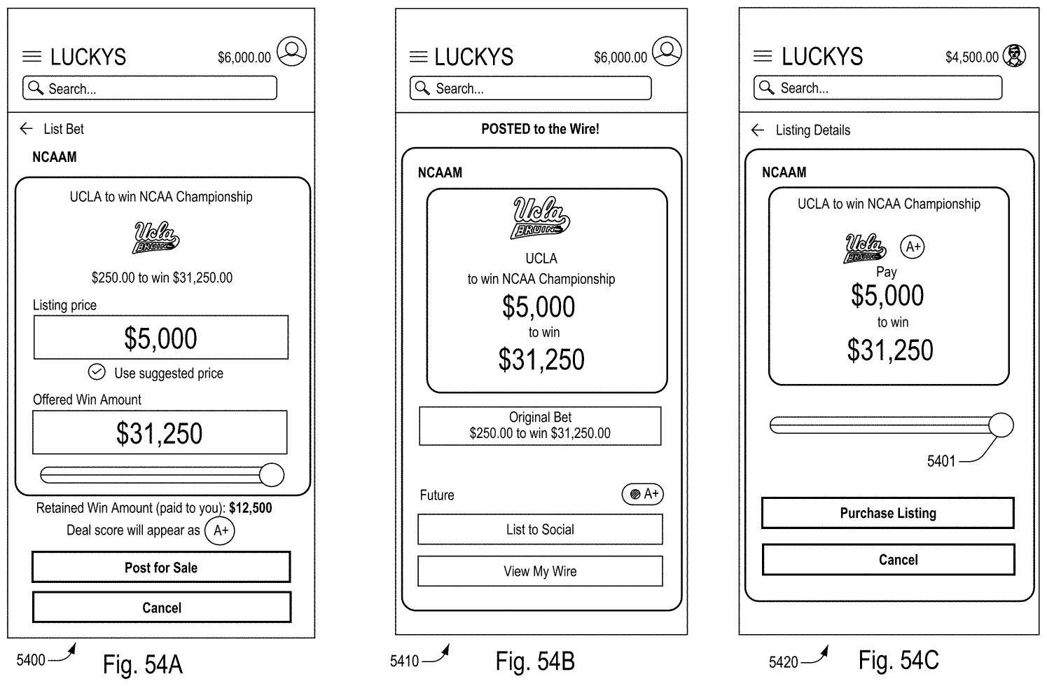

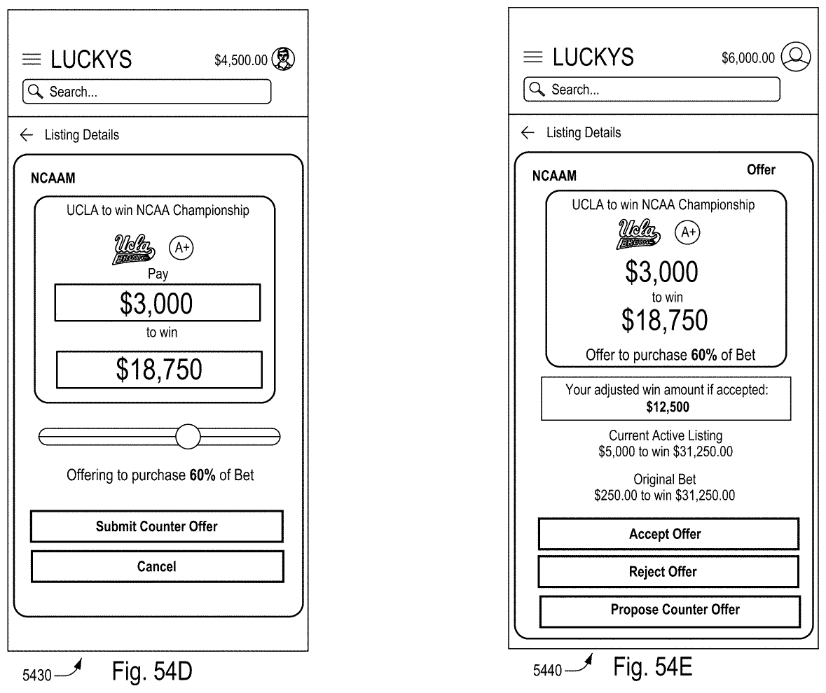

FIGS. 54A-E show example GUI screenshots relating to an example procedural flow involving a buyer-initiated offer to purchase of a fractional portion of an electronic bet ticket via an electronic bet ticket exchange marketplace. By way of illustration, an example walk-through description of the procedural flow relating to FIGS. 54A-E is described below.

User A accesses Sportsbook platform, logs into Sportsbook account, and places a bet for $250 on ‘UCLA to win the NCAA Championship’ at 125-1 odds for a potential payout of $31,250 (herein “UCLA bet”). The sportsbook system updates User A's account accordingly, assigning 100% ownership of the newly created electronic sports bet ticket (“UCLA electronic bet ticket”) to User A.

Later in the season, User A decides to list a whole portion of the UCLA bet for sale. User A logs into the Sportsbook platform, and selects the UCLA bet to list for sale.

The system responds by presenting an Offer Configuration GUI to User A (e.g., via the Sportsbook mobile application), as illustrated, for example, in FIG. 54A. In one embodiment, the WagerWire and/or Sportsbook system may dynamically calculate and display a suggested sale price (e.g., $5000) for selling 100% of the entire bet.

User A reviews and confirms the listing offer details (e.g., $5000 to win $31,750), and posts the listing at the electronic bet ticket exchange marketplace (powered by WagerWire). In one embodiment, the Sportsbook mobile application displays a confirmation of the posted listing, e.g., as illustrated in FIG. 54B.

User B logs into the electronic bet ticket exchange marketplace, browses available bets for sale, and selects the bet listing posted by User A. User B is presented with a bet purchase confirmation GUI, as illustrated, for example, in FIG. 54C. However, User B only desires to purchase 60% of the UCLA bet (as opposed to 100%). Accordingly, in one embodiment, User B may manually adjust the fractional slider button (e.g., 5401, FIG. 54C) to the 60% position, as shown, for example, in FIG. 54D.

In at least one embodiment, when the GUI detects User B's interaction with the fractional slider button, it may automatically and/or dynamically display a Purchase Offer Configuration GUI (e.g., 5430, FIG. 54D) to User B, which is configured or designed to enable the user to configure and submit an offer (or counter-offer) to buy or purchase a whole or fraction portion of an identified electronic bet ticket (e.g., which may, or may not be currently offered for sale). For example, as illustrated in the example embodiment of FIG. 54D, User B configures the Purchase Offer Configuration GUI 5430 and submits (e.g., via the WagerWire marketplace) a “buy” offer to the UCLA bet owner (User A) to purchase 60% of the UCLA bet (e.g., win amount of $18,750) for $3000. In at least one embodiment, the displayed values of the suggested offer price and win amount may proportionately increase/decrease relative to the position of the fractional slider button.

User A receives a notification of the proposed offer from User B, and logs into the WagerWire marketplace to view the offer details, and respond accordingly. As illustrated in the example embodiment of FIG. 54E, an Offer Reply GUI 5440 may be presented to the User A. The Offer Reply GUI 5440 may be configured or designed to provide User A with a choice of different options for responding to the fractional bet offer, such as, for example: Accept Offer, Reject Offer, Propose Counter-Offer, etc. In the present example scenario, it is assumed that User A chooses to accept of the proposed offer, and selects Accept Offer to initiate the checkout/purchase process.

The system may notify User B of the acceptance of the buy offer, and may request User B to provide payment details for completing the purchase. The System performs verification/clearance analysis to confirm eligibility and approval for User B's fractional purchase of the UCLA bet in accordance with the terms of the accepted buy offer, and processes and completes the purchase transaction.

Upon completion of the bet purchase transaction, the Sportsbook system is notified of the completed purchase transaction, along with details relating to the purchase offer. The Sportsbook system executes transaction settlement processes which, for example, may include, but is not limited to:
Sportsbook debits User B's Sportsbook account for sales price and transaction fee.
Distribute funds/credits of fractional electronic bet ticket sale to User A's Sportsbook Acct.
Update status of UCLA electronic bet ticket as “settled” or “closed”.
Create new electronic bet ticket (e.g., UCLA Bet 1) using data associated with purchase transaction, and data associated with the UCLA electronic bet ticket.
Record UCLA Bet 1 electronic bet ticket details at Sportsbook database.
Update Sportsbook database to link ownership of UCLA Bet 1 electronic bet ticket with User B's Sportsbook Account.
Create new electronic bet ticket (e.g., UCLA Bet 2) representing User A's remaining ownership interest and modified payout amount associated based on data associated with purchase transaction, and data associated with the UCLA electronic bet ticket.
Record UCLA Bet 2 electronic bet ticket details at SB1 database.
Update Sportsbook database to link ownership of UCLA Bet 2 electronic bet ticket with User A's Sportsbook Account.
Transmit confirmation of successful completion of purchase transaction to electronic bet ticket exchange system.

In at least one embodiment, after completion of the bet purchase transaction settlement processes, a representation of the UCLA Bet 1 electronic bet ticket assigned to User B may appear in User B's WagerWire account portfolio (and/or User B's Sportsbook account portfolio) as illustrated, for example, at 5342 of FIG. 53E.

Similarly, after completion of the bet purchase transaction settlement processes, a representation of the User A's remaining ownership portion of the original UCLA electronic bet ticket (now settled and reissued as UCLA Bet 2) may appear in User A's WagerWire account portfolio (and/or User B's Sportsbook account portfolio) as illustrated, for example, at 5332 of FIG. 53D.

FIG. 28 shows an example embodiment of a procedural flow illustrating a WagerWire-powered electronic bet ticket sale/purchase transaction for a whole bet which is implemented in accordance with one embodiment of an escrow settlement method. For purposes of illustration, an example walk-through description of the procedural flow embodiment of FIG. 28 is described below.

At 2801, User A (“Seller) purchases original electronic bet ticket from Sportsbook

At 2802, User A lists electronic bet ticket for sale via online electronic bet ticket exchange marketplace (e.g., WagerWire marketplace). In at least one embodiment, the online marketplace listings may be maintained by WagerWire system backend and stored in a WagerWire system database.

At 2803, the listed electronic bet ticket is purchased by a second user (User B, “Buyer) via online marketplace powered by WagerWire. According to different embodiments, the payment transaction relating to the purchase of the electronic bet ticket by User B may be processed by the WagerWire system, the Sportsbook system, or a third-party payment gateway system (e.g., via credit card). In some embodiments where the WagerWire system handles the payment transaction, funds/payment for the sales price amount (and any applicable transaction fee(s) and/or taxes) may be collected from User B and routed by the WagerWire system into a financial institution holding account, and subsequently automatically transferred to the Sportsbook's bank account (or other financial institution account associated with the Sportsbook). According to different embodiments, WagerWire and Sportsbook(s) may split collected transaction fee(s) (2805) at a predetermined rate(s) per contractual agreement.

The WagerWire system transmits to the Sportsbook system purchase transaction details relating to the electronic bet ticket purchase. In response, the Sportsbook system re-assigns (2804) the identified electronic bet ticket to an escrow/holding account. Status of electronic bet ticket remains set as “active”.

In at least one embodiment, the WagerWire system maintains ledger identifying the user(s) that purchased the electronic bet ticket (2810). In at least one embodiment, the electronic bet ticket may be bought and relisted/sold (2806, 2807) unlimited times until maturity. In the WagerWire system database, the most recent buyer of the electronic bet ticket will have a credit for the electronic bet ticket in their account, which allows that user to relict the electronic bet ticket for sale if desired.

Upon bet maturation, if bet wins (2808), the user who is the current owner of the electronic bet ticket (held in escrow) may be required to create an account at the Sportsbook (e.g., if an account does not already exist), or may be required to verify (2811) the login credentials of their existing Sportsbook account.

If the electronic bet ticket is a winner, payout is deposited (2812) in the Sportsbook account corresponding to the current owner of the electronic bet ticket.

If bet loses (2809), no action is necessary.

FIG. 29 shows an example embodiment of a procedural flow illustrating a WagerWire-powered electronic bet ticket sale/purchase transaction for a fractional bet which is implemented in accordance with one embodiment of an escrow settlement method. For purposes of illustration, an example walk-through description of Seller-side and Buyer-side activities relating to the fractional electronic bet ticket sale/purchase transaction is described below.

### Seller-Side Activity (Seller=User A):

User A accesses WagerWire platform
User A logs into WagerWire account
User A gains permissions through authentication of user login and password with sportsbook operator
User A selects an open bet to list for sale (e.g., UCLA to Win NCAA (Bet ID 12345))
User A chooses the % to sell, and configures listing price parameters (e.g., 50% for $2500)
User A creates sales listing

### Buyer-Side Activity (Buyer=User B):

User B accesses WagerWire platform
User B logs into WagerWire account
User B gains permissions through authentication of user login and password with sportsbook operator
User B browses availability bets for sale
User B selects bet to purchase (e.g., UCLA to Win NCAA)
User completes checkout and makes payment (e.g., Pays $2,687.5 (price+7.5% fee))
Transaction Execution process initiates:
   WagerWire transmits transaction details to sportsbook (bet ID, user A & user B, sales price)
   Sportsbook re-assigns bet to WagerWire Holding Account from User A. In at least one embodiment, the WagerWire Holding Account may be configured or designed to function as an escrow account.
   Payment is received into bank holding account and then swept to sportsbook
   Sportsbook credits User A's account with the sales proceeds (e.g., User A credited $2,687.5)

### Transaction Flow—Escrow

Seller lists portion of his bet for sale on the marketplace
Upon being purchased, whole bet is re-assigned to escrow/holding account
WagerWire maintains ledger of which users own what portions of the electronic bet ticket (can be bought and relisted unlimited times until maturity)
If the electronic bet ticket is a winner, payout is proportionally credited to the sportsbook accounts of all fractional holders
Reconciliation process to confirm fractional bet holders total 100% of bet and all payouts received into correct sportsbook accounts

In at least some embodiments, the WagerWire system may maintain an Electronic Bet Ticket Ownership database, which may be used for tracking whole or partial ownership electronic bet tickets which are purchased and/or sold via the WagerWire marketplace.

FIG. 49 shows an example representation of a portion 4900 of and Electronic Bet Ticket Ownership database which may be used for tracking whole or partial ownership electronic bet tickets which are purchased and/or sold via the WagerWire marketplace. As illustrated in the example embodiment of FIG. 49, database portion 4900 may be configured or designed to include various types of data fields such as, for example: User ID, electronic bet ticket ID, originating sportsbook ID, percentage of ownership interest held, and/or other types of electronic bet ticket-related data as described herein.

In at least one embodiment, the Electronic Bet Ticket Ownership database may be configured or designed to function as a WagerWire internal ledger for facilitating tracking of transaction activity such as, for example, tracking the ownerships of bets at a user level, whether in whole or in part. The ledger may also include sportsbook information which may be used to identify the sportsbook where each respective bet originated.

In at least one embodiment, the user interfaces of the sportsbook and WagerWire applications may be configured to display a representation of the fractional bet ticket ownership while the electronic bet ticket is held in the escrow/holding account until maturity. The fractional ticket ownership may appear in User A's WagerWire account portfolio (and/or User B's Sportsbook account portfolio) as illustrated, for example, at 5332 of FIG. 53D, and as is tracked and maintained in the Electronic Bet Ticket Ownership database

FIG. 31 shows an example embodiment of an In-Sportsbook Reassignment Model (SB/SB) example procedural flow for conducting an electronic bet ticket exchange transaction between User A (Seller) and User B (Buyer) for selling/purchasing, via an electronic bet ticket exchange marketplace (WW), a whole or fractional ownership portion of an electronic bet ticket originating from a first sportsbook entity (Sportsbook).

In the specific example embodiment of FIG. 36, it is assumed that User A and User B are each using the Sportsbook's mobile application to access the electronic bet ticket exchange marketplace.

At 3102, User A visits/logs into Sportsbook (e.g., via Sportsbook application or in-person) and places (3602) a sports-related wager or bet. The Sportsbook generates an electronic bet ticket reflecting the terms of the sports-related wager placed by User A, records the electronic bet ticket in the Sportsbook's database, and assigns the electronic bet ticket to User A's Sportsbook account.

At 3104, User A accesses sportsbook internal marketplace, powered by WagerWire, and lists the electronic bet ticket for sale. If bet is subsequently cancelled or cashed out, the electronic bet ticket listing will be cancelled.

A 3106, Internal sportsbook marketplace is powered and maintained by WagerWire backend, filtered for only bets from that sportsbook (backend functionality abstracted from user)

At 3108, User B accesses sportsbook application and browse in-sportsbook marketplace and identifies the electronic bet ticket listing for purchase.

At 3010, User B initiates request to purchase the electronic bet ticket listing. System performs verification/clearance analysis to confirm eligibility and approval for purchasing of listing (e.g. bet listing status, User KYC, user geolocation). Additionally, as checkout is initiated, bet listing status is updated to checkout status such that no other users can complete purchase for a period of time. Other Users could request purchase and wait in queue to purchase the electronic bet ticket listing should User B fail to complete purchase

At 3112, Complete purchase sequence: Following system approval/clearance, system checks if odds have changed, and if this results in a new price, User B is prompted to accept new price. Following all of the above, User B completes purchase using sportsbook account fund balance.

At 3114 and 3116, WagerWire system transmits transaction details to the sportsbook application (User A, User B, Bet ID, Sales Price). Transaction Execution process initiates:
Sportsbook debits buyer's account for sales price plus transaction fee
Sportsbook re-assigns bet to User B from User A
Sportsbook credits User A's account with the sales proceeds
WagerWire and Sportsbook split transaction fee

FIG. 32 shows an example embodiment of a Dual Channel Reassignment Model (SB/WW) example procedural flow for conducting an electronic bet ticket exchange transaction between User A (Seller) and User B (Buyer) for selling/purchasing, via an electronic bet ticket exchange marketplace (WW), a whole or fractional ownership portion of an electronic bet ticket originating from a first sportsbook entity (Sportsbook).

In the specific example embodiment of FIG. 32, it is assumed that User B is using the WagerWire mobile application to access the electronic bet ticket exchange marketplace, and that User A is using the Sportsbook mobile application to access the electronic bet ticket exchange marketplace.

At 3202, User A visits sportsbook (application or in-person) and places a bet

At 3204, User A then lists the electronic bet ticket for sale within the sportsbook application, powered by WagerWire. If bet is subsequently cancelled or cashed out, the electronic bet ticket listing will be cancelled.

At 3206, Internal marketplace is powered and maintained by WagerWire backend such that sales listings are available to be purchased in-sportsbook and on the WagerWire platform

At 3208, User B accesses WagerWire application and browses marketplace and identifies the electronic bet ticket listing for purchase.

At 3210, User B initiates request to purchase the electronic bet ticket listing. System performs verification/clearance analysis to confirm eligibility and approval for purchasing of listing (e.g. bet listing status, User KYC, user geolocation). Additionally, as checkout is initiated, bet listing status is updated to checkout status such that no other users can complete purchase for a period of time.

At 3212, Complete purchase sequence: Following system approval/clearance, system checks if odds have changed, and if this results in a new price, User B is prompted to accept new price. Following all of the above, User B completes purchase using sportsbook account fund balance.

At 3214 and 3216, WagerWire system transmits transaction details to the sportsbook application (User A, User B, Bet ID, Sales Price), and transfers the sales price to the sportsbook

At 3218 and 3220, Transaction Execution process initiates:
WagerWire transmits transaction details to sportsbook (bet ID, user A & user B, sales price)
Sportsbook re-assigns bet to User B from User A
Payment is received into bank holding account and then swept to sportsbook
Sportsbook credits User A's account with the sales proceeds
WagerWire and Sportsbook split transaction fee

FIG. 33 shows an example embodiment of a Dual Channel Reassignment Model (WW/SB) example procedural flow for conducting an electronic bet ticket exchange transaction between User A (Seller) and User B (Buyer) for selling/purchasing, via an electronic bet ticket exchange marketplace (WW), a whole or fractional ownership portion of an electronic bet ticket originating from a first sportsbook entity (Sportsbook).

In the specific example embodiment of FIG. 38, it is assumed that User A is using the WagerWire mobile application to access the electronic bet ticket exchange marketplace, and that User B is using the Sportsbook mobile application to access the electronic bet ticket exchange marketplace.

At 3302, User A visits/logs into Sportsbook (e.g., via Sportsbook application or in-person) and places (3602) a sports-related wager or bet. The Sportsbook generates an electronic bet ticket reflecting the terms of the sports-related wager placed by User A, records the electronic bet ticket in the Sportsbook's database, and assigns the electronic bet ticket to User A's Sportsbook account.

At 3304, User A accesses WagerWire application and lists the electronic bet ticket for sale. If bet is subsequently cashed out or cancelled for any reason, the electronic bet ticket listing will be automatically cancelled.

At 3306, Bet listing is available for sale on both the WagerWire platform and the sportsbook internal marketplace, powered by WagerWire backend.

At 3308, User B accesses sportsbook application, browses the sportsbook marketplace and identifies the electronic bet ticket listing for purchase.

At 3310, User B initiates request to purchase the electronic bet ticket listing. System performs verification/clearance analysis to confirm eligibility and approval for purchasing of listing (e.g. bet listing status, User KYC, user geolocation). Additionally, as checkout is initiated, bet listing status is updated to checkout status such that no other users can complete purchase for a period of time.

At 3312, Complete purchase sequence: Following system approval/clearance, system checks if odds have changed, and if this results in a new price, User is prompted to accept new price. Following all of the above, User B completes purchase using sportsbook account fund balance.

At 3314 and 3316, WagerWire system transmits transaction details to the sportsbook application (User A, User B, Bet ID, Sales Price). Transaction Execution process initiates:
Sportsbook debits buyer's account for sales price plus transaction fee
Sportsbook re-assigns bet to User B from User A
Sportsbook credits User A's account with the sales proceeds
WagerWire and Sportsbook split transaction fee

FIG. 34 shows an example embodiment of a Dual Channel Escrow Model (SB/WW) example procedural flow for conducting an electronic bet ticket exchange transaction between User A (Seller) and User B (Buyer) for selling/purchasing, via an electronic bet ticket exchange marketplace (WW), a whole or fractional ownership portion of an electronic bet ticket originating from a first sportsbook entity (Sportsbook).

In the specific example embodiment of FIG. 37, it is assumed User A is using the WagerWire mobile application to access the electronic bet ticket exchange marketplace, and that User B is using the Sportsbook mobile application to access the electronic bet ticket exchange marketplace.

At 3402, User A visits sportsbook (application or in-person) and places a bet

At 3404, User A then lists up to 100% of the electronic bet ticket for sale within the sportsbook application, powered by WagerWire. If bet is subsequently cancelled or cashed out, the electronic bet ticket listing will be cancelled.

In at least one embodiment, internal marketplace is powered and maintained by WagerWire backend such that sales listings are available to be purchased in-sportsbook and on the WagerWire platform

At 3406, User B accesses WagerWire application and browses marketplace and identifies the electronic bet ticket listing for purchase.

At 3408, User B initiates request to purchase the electronic bet ticket listing. System performs verification/clearance analysis to confirm eligibility and approval for purchasing of listing (e.g. bet listing status, User KYC, user geolocation). Additionally, as checkout is initiated, bet listing status is updated to checkout status such that no other users can complete purchase for a period of time.

At 3410, Complete purchase sequence: Following system approval/clearance, system checks if odds have changed, and if this results in a new price, User B is prompted to accept new price. Following all of the above, User B completes purchase using sportsbook account fund balance.

At 3411, Upon being purchased by User B, the electronic bet ticket is re-assigned to escrow account. In one embodiment, the escrow account may be implemented as a sportsbook user account which sits in the sportsbook system and is owned/controlled by WagerWire. WagerWire maintains an electronic bet ticket ownership ledger of which keeps track of user(s) who have an ownership interest in the escrowed electronic bet ticket, along with their respective ownership percentage. In at least some embodiments, the escrowed electronic bet ticket remains open or active until bet maturity, and fractional portions of the escrowed electronic bet ticket can be bought and relisted unlimited times until bet maturity.

At 3412, User B relicts the electronic bet ticket for sale, in whole or in parts.

At 3415, If bet loses, no action is necessary

At 3414 and 3416, If bet wins, WagerWire signals sportsbook which users bought portions of the winning bet

At 3418, Users holding winning bets are required to verify their sportsbook account username and password, or create a new sportsbook account

At 3420 and 3422, Following creation/verification of sportsbook account, payout is deposited in the sportsbook account of the final owner of the bet

FIG. 35 shows an example embodiment of a Dual Channel Escrow Model (WW/SB) example procedural flow for conducting an electronic bet ticket exchange transaction between User A (Seller) and User B (Buyer) for selling/purchasing, via an electronic bet ticket exchange marketplace (WW), a whole or fractional ownership portion of an electronic bet ticket originating from a first sportsbook entity (Sportsbook).

In the specific example embodiment of FIG. 37, it is assumed that User B is using the WagerWire mobile application to access the electronic bet ticket exchange marketplace, and that User A is using the Sportsbook mobile application to access the electronic bet ticket exchange marketplace.

At 3502, User A visits sportsbook (application or in-person) and places a bet

At 3504, User A accesses WagerWire application and lists up to 100% of the electronic bet ticket for sale. If bet is subsequently cashed out or cancelled for any reason, the electronic bet ticket listing will be automatically cancelled.

At 3506, Bet listing is available for sale on both the WagerWire platform and the sportsbook internal marketplace, powered and maintained by WagerWire backend.

At 3508, User B accesses sportsbook application, browses the sportsbook marketplace and identifies the electronic bet ticket listing for purchase.

At 3510, User B initiates request to purchase the electronic bet ticket listing within the sportsbook application. Upon purchase request, WagerWire system performs verification/clearance analysis to confirm eligibility and approval for purchasing of listing (e.g. bet listing status, User KYC, user geolocation). Additionally, as checkout is initiated, bet listing status is updated to checkout status such that no other users can complete purchase for a period of time.

At 3512, Complete purchase sequence: Following system approval/clearance, system checks if odds have changed, and if this results in a new price, User B is prompted to accept new price. Following all of the above, User B completes purchase using sportsbook account fund balance.

At 3514, Upon being purchased by User B, the electronic bet ticket is re-assigned to escrow account. In one embodiment, the escrow account may be implemented as a sportsbook user account which sits in the sportsbook system and is owned/controlled by WagerWire. In other embodiments, the escrow account may be implemented as an escrow account at the Wager Wire system. WagerWire maintains an electronic bet ticket ownership ledger of which keeps track of user(s) who have an ownership interest in the escrowed electronic bet ticket, along with their respective ownership percentage. In at least some embodiments, the escrowed electronic bet ticket remains open or active until bet maturity, and fractional portions of the escrowed electronic bet ticket can be bought and relisted unlimited times until bet maturity.

At 3516, User B relicts the electronic bet ticket for sale, in whole or in parts.

At 3519, if bet loses, no action is necessary

At 3518, if bet wins, WagerWire signals sportsbook which users bought portions of the winning bet

At 3520, users holding winning bets are required to verify their sportsbook account username and password, or create a new sportsbook account

At 3522 and 3524, following creation/verification of sportsbook account, payout is deposited in the sportsbook account of the final owner of the bet.

FIG. 30 illustrates an example data flow functionality and data processing functionality which may be implemented by a WagerWire aggregation engine. In at least one embodiment, the WagerWire system may include an Aggregation Engine (e.g., 3004, FIG. 30) which may be configured or designed to include functionality for:
Enabling the WagerWire system to interface with multiple different remote sportsbook systems (e.g., 3006, FIG. 30) that each have their own unique APIs and database structures.
Normalizing disparate data received from each of the sportsbooks into a distinct, normalized data format.
Enabling the WagerWire system to simultaneously or concurrently receive and/or access data from multiple different sports data provider (3002, FIG. 30) APIs relating to odds, scores, etc.
Identifying data provider(s) used by each sportsbook, and matching the data to appropriate sportsbooks.
Converting the normalized data back into different customized data formats which are compatible for performing data communications via each different remote sportsbook API.

### Data Structures, Transaction Tracking, and Payment Settlement

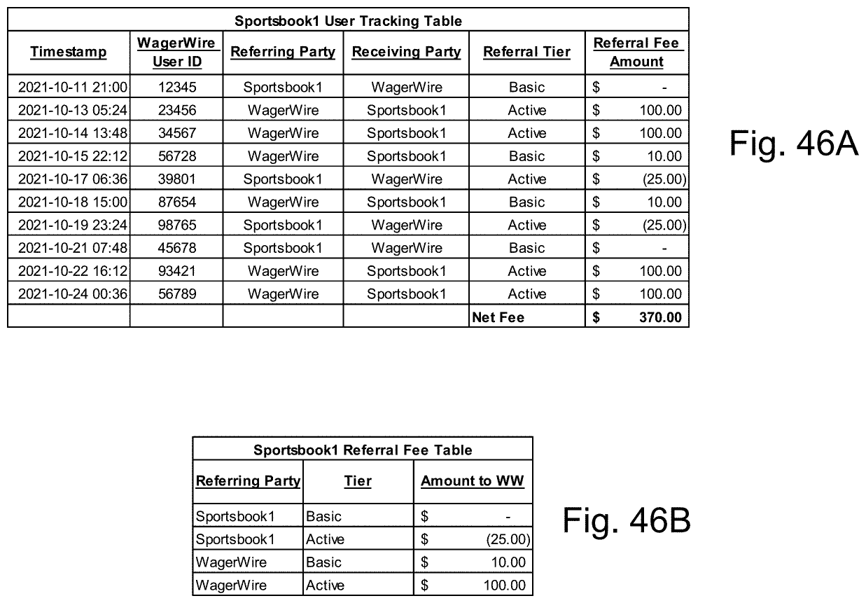

FIGS. 46A-B, 47A-B, 48A-B, 49, and 61-63 illustrate example embodiments of various types of data structures and data which may be used for accounting, tracking, distributing, and/or managing of funds relating to WagerWire facilitated transactions across one or more different Sportsbook entities.

More specifically, FIGS. 46A-B, 47A-B, 48A-B illustrate different example embodiments of the WagerWire internal ledger for tracking the origins of new user signups between WagerWire and one or more Sportsbooks, and the resulting affiliate referral fees earned by each respective party.

In at least one embodiment, throughout the course of business, WagerWire system refers new users to register accounts with online sportsbooks, and online sportsbooks refer users to register accounts with the WagerWire system. In at least one embodiment, this two-way onboarding activity is tracked in a ledger to account for referral fees earned by each party. A separate table is maintained for each sportsbook as the commercial terms are unique to each (the referenced figures illustrate three such tables for illustrative purposes).

According to different embodiments, there can be multiple tiers of user referral, such as a smaller referral fee earned for a basic signup regardless of user activity, and a larger fee earned for an active user.

### Payment Flows

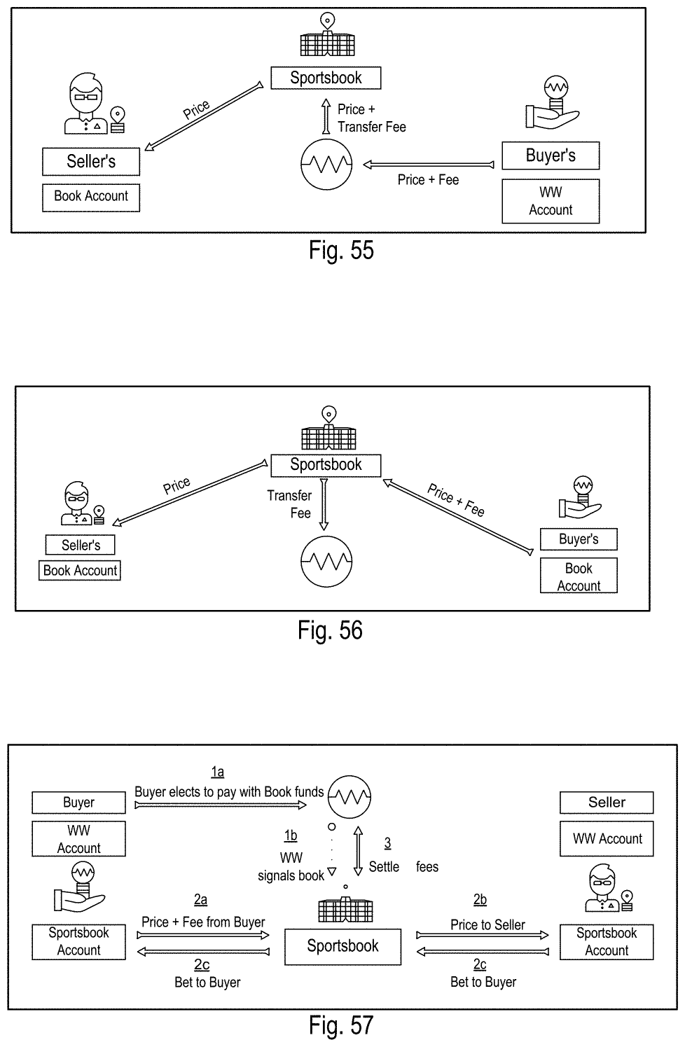

FIGS. 55-57 illustrate example embodiments of different types of payment flows which may be implemented between the WagerWire System and one or more sportsbook systems.

FIG. 55 illustrates an example embodiment of a WW-Book payment flow. As illustrated in the example payment flow embodiment of FIG. 55:
Buyer pays purchase price and transaction fee using WagerWire account balance.
WagerWire System transfers the purchase price and processing fee to the appropriate sportsbook.
Sportsbook credits the purchase price into sellers sportsbook account.

FIG. 56 illustrates an example embodiment of a Book-Book payment flow. As illustrated in the example payment flow embodiment of FIG. 56:
Buyer pays purchase price and transaction fee using sportsbook account balance.
Sportsbook credits the purchase price into sellers sportsbook account.
Sportsbook remits transaction fee to WagerWire.

An Illustrative Example Involving a Book-Book Payment Flow May be as Follows:
Buyer and Seller has already synced their sportsbook account within the WW application to authorize transaction activity.
Buyer selects desired bet to purchase and initiates bet checkout in the WW application.
WW communicates transaction details to the originating sportsbook operating system via API.
Originating sportsbook debits the Buyer's account for sales price+transaction fee.
Originating sportsbook credits the Seller's account for sales price.
Originating sportsbook periodically remits accrued transaction fees to WW.

FIG. 57 illustrates an example embodiment of a sportsbook funded payment flow. As illustrated in the example payment flow embodiment of FIG. 57:
Buyer purchases bet and elects to pay with Sportsbook account balance
WagerWire signals Sportsbook the transaction details
Sportsbook debits Buyer for sales price and transaction fee
Sportsbook credits Seller for the sales price
Sportsbook re-assigns bet to the Buyer
Periodically, WagerWire and Sportsbook settle accrued fees

In at least some embodiments, users may complete checkout within the WagerWire application. Payment may be made using pre-loaded cash balance or at the point-of-sale with credit/debit card or alternate methods (e.g., PayPal, crypto, etc.)

Dynamic Deal Score Calculations

In at least one embodiment, the WagerWire system may be configured or designed to include functionality for automatically and/or dynamically calculating (e.g., in real-time) a “Deal Score” value which may be used to represent how good of a “deal” this prospective electronic bet ticket sale offer is relative to the same or similar bets offered by Sportsbook operators, as well as other electronic bet ticket sale offers in the marketplace. Additional details relating to the Deal Score functionality are described in greater detail herein, for example, with respect to FIG. 58.

FIG. 58 shows an example screenshot of an Electronic Bet Ticket Checkout GUI which is configured or designed to display a Deal Score value (e.g., “A+”, 5801) representing how good of a “deal” this prospective electronic bet ticket sale offer is relative to other electronic bet ticket sale offers in the marketplace.

According to different embodiments, Deal Score may be calculated as a comparison of the sales price of an electronic bet ticket to the implied value of the ticket. The lower the price relative to 100% of the implied value of the bet, the better the deal score. A simplified example is illustrated in Deal Score Table 1 below. In at least some embodiments, the exact percentages may be dynamically adjusted and the range of Deal Score values may include subcategories for + and − (e.g. A+, A, A−, B+, etc.)

TABLE 1
Deal Score

| Deal Score | % of Implied Value |
|---|---|
| A | 80% or less |
| B | 81-90% |
| C | 91% or more |

In at least some embodiments, Deal Score calculation may factor in a time value of money as part of deal score calculation. For example, the sooner the electronic bet ticket the resolves the greater that attribute is to the deal score.

### Automated, Dynamic Sales Pricing Functionality

In at least some embodiments, the WagerWire system may be configured or designed to include functionality for automatically and dynamically adjusting the sales price (e.g., in real-time) of an electronic bet ticket listed for sale, based on various event(s)/condition(s).

For example, in one embodiment, dynamic sales price (DSP) is updated by WagerWire in real time as the win probability fluctuates for a bet listing. In some embodiments, the DSP is calculated relative to the implied value of the electronic bet ticket (in the same manner as the suggested price), and is updated with every change in the odds.

In some embodiments, the WagerWire system may be configured or designed to continuously and/or periodically monitor data feeds for changes in odds, market conditions, price fluctuations, and/or other events/conditions which may affect the sale price of a given electronic bet ticket listed for sale at the WagerWire marketplace, and dynamically calculate new pricing based on current conditions, and automatically and dynamically modify the price of the electronic bet ticket sales listing.

FIG. 59 shows an example screenshot of a WagerWire application GUI a user may utilize for configuring a sales price of an electronic bet ticket to be listed for sale at the WagerWire marketplace. As illustrated in the example embodiment of FIG. 59, the GUI includes a user-selectable check-box for enabling/disabling dynamic sales pricing (DSP) functionality for the displayed electronic bet ticket sales listing.

### Example Flow

User chooses to list a bet for sale.
User elects to use Dynamic Pricing.
User selects what deal score they want the price to be maintained at.
User completes listing.
As odds for the electronic bet ticket fluctuate during the game or throughout the season, WagerWire updates the sales price accordingly.

### Conditional Purchase Functionality

In at least some embodiments, the WagerWire system may be configured or designed to provide conditional purchase functionality for enabling users to configure specific purchase parameters under which they instruct the system to automatically purchase an electronic bet ticket which qualifies.

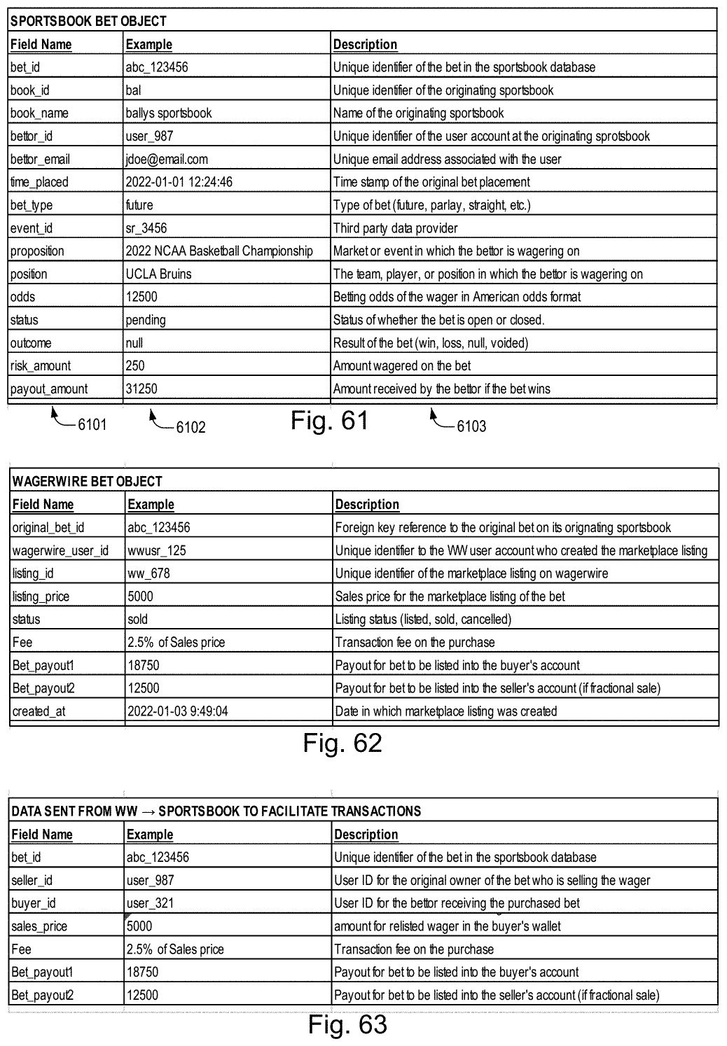

FIG. 60 shows an example embodiment of a Conditional Purchase Configuration GUI which provides functionality for enabling a user to configure specific conditional purchase parameters. Example of different types of configurable conditional purchase parameters may include, but are not limited to: sport, team, event, bet type, deal score, price, etc.

In one embodiment, the user may provide payment method in advance, and authorize the conditional purchase. Once activated, the WagerWire system may continuously and/or periodically monitor marketplace listings for electronic bet ticket offerings which meet the specified conditional purchase criteria, and automatically purchase (e.g., on behalf of the user) electronic bet tickets which meet the conditional purchase criteria.

### Example Flow

User wishes to purchase any “Bengals to win NFL Superbowl” bet at an C+ or better deal score, up to $500.
A second user at a later point in time lists their Bengals to win NFL Superbowl bet for $100 with a resulting A deal score.
Conditional purchase is automatically triggered upon the listing being posted.

Other aspects relating to sports wagering technology are disclosed in one or more of the following references:
U.S. patent application Ser. No. 15/873,543, by LaRocca et al., titled “System, method, and non-transitory computer-readable storage media for multiple exchange of multiple iterations of the same online wager transaction”, filed Feb. 18, 2016, the entirety of which is incorporated herein by reference for all purposes.
U.S. patent application Ser. No. 15/047,529, by LaRocca et al., titled “Systems, devices and methods for electronic sports book wagering with a wager sell back option”, filed Feb. 11, 2013, the entirety of which is incorporated herein by reference for all purposes.
U.S. patent application Ser. No. 13/764,557, by Brook et al., titled “Systems, devices and methods for electronic sports book wagering with a wager sell back option”, filed Feb. 11, 2013, the entirety of which is incorporated herein by reference for all purposes.
U.S. patent application Ser. No. 12/687,980, by Amaitis et al., titled “Electrical computers and digital processing systems involving interprogram or interprocess communication regarding amusement devices and games”, filed Jan. 15, 2010, the entirety of which is incorporated herein by reference for all purposes.
U.S. patent application Ser. No. 13/551,242, by Scott et al., titled “System and method for peer to peer race and sports wager exchange”, filed Jul. 17, 2012, the entirety of which is incorporated herein by reference for all purposes.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

1. A computerized system for facilitating exchange of wager-based electronic bet tickets among users via an online electronic bet ticket exchange marketplace; the users including a first user, a second user, and a third user; the wager-based electronic bet tickets including a first electronic bet ticket originating from a first sportsbook system, and including a second electronic bet ticket originating from a second sportsbook system; the first electronic bet ticket representing a first bet placed by the first user at the first sportsbook system; the first electronic bet ticket having associated therewith a first wagered amount value and a first bet win amount value; the first electronic bet ticket being represented by a first bet object stored in non-transient memory of a first sportsbook system database; the first bet object including data identifying a first user account as a current owner of the first electronic bet ticket; the first user account being associated with the first user; the second electronic bet ticket representing a second bet placed by the second user at the second sportsbook system; the second electronic bet ticket having associated therewith a second wagered amount value and a second bet win amount value; the second electronic bet ticket being represented by a second bet object stored in non-transient memory of a second sportsbook system database; the second bet object including data identifying a second user account as a current owner of the second electronic bet ticket; the second user account being associated with the second user; the system comprising:
at least one processor;
at least one interface operable to provide a communication link to at least one network device;
non-transient memory;
the at least one processor being operable to execute a plurality of instructions stored in the memory for:
receiving, at a computerized ticket exchange system, a first request from the first user to post, at the electronic bet ticket exchange marketplace, a first sale offer to sell a first portion of ownership interest in the first electronic bet ticket, the first sale offer specifying a first set of terms, including a first purchase price, a first win amount;
processing the first request;
posting, in response to processing the first request, the first sale offer at the electronic bet ticket exchange marketplace;
receiving, at the computerized ticket exchange system, a second request from the second user to post, at the electronic bet ticket exchange marketplace, a second sale offer to sell a second portion of ownership interest in the second electronic bet ticket, the second sale offer specifying a second set of terms, including a second purchase price, a second win amount;
processing the second request;
posting, in response to processing the second request, the second sale offer at the electronic bet ticket exchange marketplace; and
enabling the third user to access the online electronic bet ticket exchange marketplace and view a plurality of offers posted to the electronic bet ticket exchange marketplace, including the first sale offer and second sale offer;
receiving, at the ticket exchange system, a third request from the third user to purchase the first portion of ownership interest in the first electronic bet ticket in accordance with the first set of terms;
processing the third request;
executing, in response to processing the third request, a first plurality of operations for facilitating execution of a first electronic bet ticket sale transaction relating to a sale of the first portion of ownership interest in the first electronic bet ticket to the third user, in accordance with the first sale offer, the first plurality of operations, including:
performing verification and regulatory compliance clearance analysis to confirm eligibility and approval for executing the first electronic bet ticket sale transaction;
determining whether the first electronic bet ticket sale transaction relates to a whole bet sale of a 100% portion of ownership interest in the first electronic bet ticket, or a whole bet sale of a 100% portion of ownership interest in the first electronic bet ticket;
calculating a first amount of proceeds of the first electronic bet ticket sale transaction which are due to the first user;
transmitting, to the first sportsbook system, a first set of transaction details relating to the first electronic bet ticket sale transaction;
transmitting instructions to the first sportsbook system for causing the first sportsbook system to distribute funds or credits relating to the first amount of proceeds to the first user account; and
if it is determined that the first electronic bet ticket sale transaction relates to the whole bet sale of a 100% portion of ownership interest in the first electronic bet ticket, transmitting additional instructions to the first sportsbook system for causing the first sportsbook system to update the first sportsbook system database to reassign ownership of the first electronic bet ticket to a third user account at the first sportsbook system, wherein the third user account is associated with the third user.

2. The system of claim 1 further comprising causing the at least one processor to execute instructions for:
executing a second plurality of operations if it is determined that the first electronic bet ticket sale transaction relates to the fractional bet sale of less than a 100% portion of ownership interest in the first electronic bet ticket, including:
transmitting additional instructions to the first sportsbook system for causing the first sportsbook system to update the first sportsbook system database to reassign an entirety of the first electronic bet ticket to a first escrow account;
calculating an updated win amount for the first electronic bet ticket which is retained by the first user after execution of the first electronic bet ticket sale transaction;
maintaining a first ledger at a database for tracking first fractional ownership information relating to the first electronic bet ticket;
updating the first ledger to reflect that the second user owns a first fractional portion of the first electronic bet ticket corresponding to the first win amount;
updating the first ledger to reflect that the first user owns a first fractional portion of the first electronic bet ticket corresponding to the updated win amount;
identifying an outcome of the first bet upon detection that the first bet has reached maturity;
determining if the outcome of the first bet represents a win condition;
if it is determined that the outcome of the first that represents a win condition, distributing a first portion of funds or credits corresponding to the updated win amount to a first account associated with the first user; and
if it is determined that the outcome of the first that represents a win condition, distributing a second portion of funds or credits corresponding to the first win amount to a second account associated with the second user.

3. The system of claim 1 further comprising causing the at least one processor to execute instructions for:
executing a second plurality of operations if it is determined that the first electronic bet ticket sale transaction relates to the fractional bet sale of less than a 100% portion of ownership interest in the first electronic bet ticket, including:
transmitting additional instructions to the first sportsbook system for causing the first sportsbook system to update a status of the of the first electronic bet ticket to reflect that the first electronic bet ticket is settled or closed;
transmitting additional instructions to the first sportsbook system for causing the first sportsbook system to create a third electronic bet ticket at the first sportsbook system representing the first portion of ownership interest in the first electronic bet ticket, using the first set of transaction details;
transmitting additional instructions to the first sportsbook system for causing the first sportsbook system to update the first sportsbook system database to associate ownership of the third electronic bet ticket with a third user account at the first sportsbook system, wherein the third user account is associated with the third user;
calculating an updated win amount for the first electronic bet ticket which is retained by the first user after execution of the first electronic bet ticket sale transaction;
transmitting additional instructions to the first sportsbook system for causing the first sportsbook system to create a fourth electronic bet ticket at the first sportsbook system representing a remainder portion of ownership interest in the first electronic bet ticket which is retained by the first user after execution of the first electronic bet ticket sale transaction, using the first set of transaction details; and
transmitting additional f instructions to the first sportsbook system for causing the first sportsbook system to update the first sportsbook system database to associate ownership of the fourth electronic bet ticket with the first user account.

4. The system of claim 1 further comprising causing the at least one processor to execute instructions for:
enabling the first user to create a first marketplace account at the electronic bet ticket exchange system;
enabling the first user to initiate linking of the first sportsbook account and the first marketplace account;
accessing the first sportsbook system database and identifying the first electronic bet ticket assigned to the first user account;
updating a database of the ticket exchange system to create a first link or association between the first electronic bet ticket and the first marketplace account;
enabling the second user to create a second marketplace account at the electronic bet ticket exchange system;
enabling the second user to initiate linking of the second sportsbook account and the second marketplace account;
accessing the second sportsbook system database and identifying the second electronic bet ticket assigned to the second user account; and
updating the database of the ticket exchange system to create a second link or association between the second electronic bet ticket and the second marketplace account.

5. The system of claim 1 further comprising causing the at least one processor to execute instructions for:
processing a first payment transaction relating to the first electronic bet ticket sale transaction; and
causing a first portions of funds associated with the first payment transaction to be routed to a financial account associated with the first sportsbook system.

6. The system of claim 1 further comprising causing the at least one processor to execute instructions for:
calculating a first purchase amount which is to be paid by the third user in connection with the first electronic bet ticket sale transaction; and
transmitting additional instructions to the first sportsbook system for causing the first sportsbook system to debit the third user account for the first purchase amount.

7. The system of claim 1 further comprising causing the at least one processor to execute instructions for:
receiving, at the computerized ticket exchange system, a second request from the second user to post, at the electronic bet ticket exchange marketplace, a second sale offer to sell a second portion of ownership interest in the second electronic bet ticket, the second sale offer specifying a second set of terms, including a second purchase price, a second win amount;
processing the second request;
posting, in response to processing the second request, the second sale offer at the electronic bet ticket exchange marketplace;
receiving, at the ticket exchange system, a fourth request from the third user to purchase the second portion of ownership interest in the second electronic bet ticket in accordance with the second set of terms;
processing the fourth request;
executing, in response to processing the fourth request, a second plurality of operations for facilitating execution of a second electronic bet ticket sale transaction relating to a sale of the second portion of ownership interest in the second electronic bet ticket to the third user, in accordance with the second sale offer, the second plurality of operations including:
performing verification and regulatory compliance clearance analysis to confirm eligibility and approval for executing the second electronic bet ticket sale transaction;
determining whether the second electronic bet ticket sale transaction relates to a whole bet sale of a 100% portion of ownership interest in the second electronic bet ticket, or a whole bet sale of a 100% portion of ownership interest in the second electronic bet ticket;
calculating a second amount of proceeds of the second electronic bet ticket sale transaction which are due to the second user;
transmitting, to the second sportsbook system, a second set of transaction details relating to the second electronic bet ticket sale transaction;
transmitting instructions to the second sportsbook system for causing the second sportsbook system to distribute funds or credits relating to the second amount of proceeds to the second user account; and
if it is determined that the second electronic bet ticket sale transaction relates to the whole bet sale of a 100% portion of ownership interest in the second electronic bet ticket, transmitting additional instructions to the second sportsbook system for causing the second sportsbook system to update the second sportsbook system database to reassign ownership of the second electronic bet ticket to a third user account at the second sportsbook system, wherein the third user account is associated with the third user.

8. The system of claim 1 further comprising causing the at least one processor to execute instructions for:
executing a second plurality of operations if it is determined that the second electronic bet ticket sale transaction relates to the fractional bet sale of less than a 100% portion of ownership interest in the second electronic bet ticket, including:
transmitting additional instructions to the second sportsbook system for causing the second sportsbook system to update a status of the of the second electronic bet ticket to reflect that the second electronic bet ticket is settled or closed;
transmitting additional instructions to the second sportsbook system for causing the second sportsbook system to create a third electronic bet ticket at the second sportsbook system representing the second portion of ownership interest in the second electronic bet ticket, using the second set of transaction details;
transmitting additional instructions to the second sportsbook system for causing the second sportsbook system to update the second sportsbook system database to associate ownership of the third electronic bet ticket with a third user account at the second sportsbook system, wherein the third user account is associated with the third user;
calculating an updated win amount for the second electronic bet ticket which is retained by the second user after execution of the second electronic bet ticket sale transaction;
transmitting additional instructions to the second sportsbook system for causing the second sportsbook system to create a fourth electronic bet ticket at the second sportsbook system representing a remainder portion of ownership interest in the second electronic bet ticket which is retained by the second user after execution of the second electronic bet ticket sale transaction, using the second set of transaction details; and
transmitting additional f instructions to the second sportsbook system for causing the second sportsbook system to update the second sportsbook system database to associate ownership of the fourth electronic bet ticket with the second user account.

9. B10. A computer implemented computer program product for facilitating exchange of wager-based electronic bet tickets among users via an online electronic bet ticket exchange marketplace; the users including a first user, a second user, and a third user; the wager-based electronic bet tickets including a first electronic bet ticket originating from a first sportsbook computer program product, and including a second electronic bet ticket originating from a second sportsbook computer program product; the first electronic bet ticket representing a first bet placed by the first user at the first sportsbook computer program product; the first electronic bet ticket having associated therewith a first wagered amount value and a first bet win amount value; the first electronic bet ticket being represented by a first bet object stored in non-transitory memory of a first sportsbook computer program product database; the first bet object including data identifying a first user account as a current owner of the first electronic bet ticket; the first user account being associated with the first user; the second electronic bet ticket representing a second bet placed by the second user at the second sportsbook computer program product; the second electronic bet ticket having associated therewith a second wagered amount value and a second bet win amount value; the second electronic bet ticket being represented by a second bet object stored in non-transitory memory of a second sportsbook computer program product database; the second bet object including data identifying a second user account as a current owner of the second electronic bet ticket; the second user account being associated with the second user; the computer program product comprising causing at least one processor to execute a plurality of instructions for:
receiving, at a computerized ticket exchange system, a first request from the first user to post, at the electronic bet ticket exchange marketplace, a first sale offer to sell a first portion of ownership interest in the first electronic bet ticket, the first sale offer specifying a first set of terms, including a first purchase price, a first win amount;
processing the first request;
posting, in response to processing the first request, the first sale offer at the electronic bet ticket exchange marketplace;
receiving, at the computerized ticket exchange system, a second request from the second user to post, at the electronic bet ticket exchange marketplace, a second sale offer to sell a second portion of ownership interest in the second electronic bet ticket, the second sale offer specifying a second set of terms, including a second purchase price, a second win amount;
processing the second request;
posting, in response to processing the second request, the second sale offer at the electronic bet ticket exchange marketplace; and
enabling the third user to access the online electronic bet ticket exchange marketplace and view a plurality of offers posted to the electronic bet ticket exchange marketplace, including the first sale offer and second sale offer;
receiving, at the ticket exchange system, a third request from the third user to purchase the first portion of ownership interest in the first electronic bet ticket in accordance with the first set of terms;
processing the third request;
executing, in response to processing the third request, a first plurality of operations for facilitating execution of a first electronic bet ticket sale transaction relating to a sale of the first portion of ownership interest in the first electronic bet ticket to the third user, in accordance with the first sale offer, the first plurality of operations, including:
performing verification and regulatory compliance clearance analysis to confirm eligibility and approval for executing the first electronic bet ticket sale transaction;
determining whether the first electronic bet ticket sale transaction relates to a whole bet sale of a 100% portion of ownership interest in the first electronic bet ticket, or a whole bet sale of a 100% portion of ownership interest in the first electronic bet ticket;
calculating a first amount of proceeds of the first electronic bet ticket sale transaction which are due to the first user;
transmitting, to the first sportsbook system, a first set of transaction details relating to the first electronic bet ticket sale transaction;
transmitting instructions to the first sportsbook system for causing the first sportsbook system to distribute funds or credits relating to the first amount of proceeds to the first user account; and
if it is determined that the first electronic bet ticket sale transaction relates to the whole bet sale of a 100% portion of ownership interest in the first electronic bet ticket, transmitting additional instructions to the first sportsbook system for causing the first sportsbook system to update the first sportsbook system database to reassign ownership of the first electronic bet ticket to a third user account at the first sportsbook system, wherein the third user account is associated with the third user.

10. The computer program product of claim B10 further comprising causing the at least one processor to execute instructions for:
executing a second plurality of operations if it is determined that the first electronic bet ticket sale transaction relates to the fractional bet sale of less than a 100% portion of ownership interest in the first electronic bet ticket, including:
transmitting additional instructions to the first sportsbook system for causing the first sportsbook system to update the first sportsbook system database to reassign an entirety of the first electronic bet ticket to a first escrow account;
calculating an updated win amount for the first electronic bet ticket which is retained by the first user after execution of the first electronic bet ticket sale transaction;
maintaining a first ledger at a database for tracking first fractional ownership information relating to the first electronic bet ticket;
updating the first ledger to reflect that the second user owns a first fractional portion of the first electronic bet ticket corresponding to the first win amount;
updating the first ledger to reflect that the first user owns a first fractional portion of the first electronic bet ticket corresponding to the updated win amount;
identifying an outcome of the first bet upon detection that the first bet has reached maturity;
determining if the outcome of the first bet represents a win condition;
if it is determined that the outcome of the first that represents a win condition, distributing a first portion of funds or credits corresponding to the updated win amount to a first account associated with the first user; and
if it is determined that the outcome of the first that represents a win condition, distributing a second portion of funds or credits corresponding to the first win amount to a second account associated with the second user.

11. The computer program product of claim B10 further comprising causing the at least one processor to execute instructions for:
executing a second plurality of operations if it is determined that the first electronic bet ticket sale transaction relates to the fractional bet sale of less than a 100% portion of ownership interest in the first electronic bet ticket, including:
transmitting additional instructions to the first sportsbook system for causing the first sportsbook system to update a status of the of the first electronic bet ticket to reflect that the first electronic bet ticket is settled or closed;
transmitting additional instructions to the first sportsbook system for causing the first sportsbook system to create a third electronic bet ticket at the first sportsbook system representing the first portion of ownership interest in the first electronic bet ticket, using the first set of transaction details;
transmitting additional instructions to the first sportsbook system for causing the first sportsbook system to update the first sportsbook system database to associate ownership of the third electronic bet ticket with a third user account at the first sportsbook system, wherein the third user account is associated with the third user;
calculating an updated win amount for the first electronic bet ticket which is retained by the first user after execution of the first electronic bet ticket sale transaction;
transmitting additional instructions to the first sportsbook system for causing the first sportsbook system to create a fourth electronic bet ticket at the first sportsbook system representing a remainder portion of ownership interest in the first electronic bet ticket which is retained by the first user after execution of the first electronic bet ticket sale transaction, using the first set of transaction details; and
transmitting additional f instructions to the first sportsbook system for causing the first sportsbook system to update the first sportsbook system database to associate ownership of the fourth electronic bet ticket with the first user account.

12. The computer program product of claim B10 further comprising causing the at least one processor to execute instructions for:
enabling the first user to create a first marketplace account at the electronic bet ticket exchange system;
enabling the first user to initiate linking of the first sportsbook account and the first marketplace account;
accessing the first sportsbook system database and identifying the first electronic bet ticket assigned to the first user account;
updating a database of the ticket exchange system to create a first link or association between the first electronic bet ticket and the first marketplace account;
enabling the second user to create a second marketplace account at the electronic bet ticket exchange system;
enabling the second user to initiate linking of the second sportsbook account and the second marketplace account;
accessing the second sportsbook system database and identifying the second electronic bet ticket assigned to the second user account; and
updating the database of the ticket exchange system to create a second link or association between the second electronic bet ticket and the second marketplace account.

13. The computer program product of claim B10 further comprising causing the at least one processor to execute instructions for:
processing a first payment transaction relating to the first electronic bet ticket sale transaction; and
causing a first portions of funds associated with the first payment transaction to be routed to a financial account associated with the first sportsbook system.

14. The computer program product of claim B10 further comprising causing the at least one processor to execute instructions for:
calculating a first purchase amount which is to be paid by the third user in connection with the first electronic bet ticket sale transaction; and
transmitting additional instructions to the first sportsbook system for causing the first sportsbook system to debit the third user account for the first purchase amount.

15. The computer program product of claim B10 further comprising causing the at least one processor to execute instructions for:
receiving, at the computerized ticket exchange system, a second request from the second user to post, at the electronic bet ticket exchange marketplace, a second sale offer to sell a second portion of ownership interest in the second electronic bet ticket, the second sale offer specifying a second set of terms, including a second purchase price, a second win amount;
processing the second request;
posting, in response to processing the second request, the second sale offer at the electronic bet ticket exchange marketplace;
receiving, at the ticket exchange system, a fourth request from the third user to purchase the second portion of ownership interest in the second electronic bet ticket in accordance with the second set of terms;
processing the fourth request;
executing, in response to processing the fourth request, a second plurality of operations for facilitating execution of a second electronic bet ticket sale transaction relating to a sale of the second portion of ownership interest in the second electronic bet ticket to the third user, in accordance with the second sale offer, the second plurality of operations including:
performing verification and regulatory compliance clearance analysis to confirm eligibility and approval for executing the second electronic bet ticket sale transaction;
determining whether the second electronic bet ticket sale transaction relates to a whole bet sale of a 100% portion of ownership interest in the second electronic bet ticket, or a whole bet sale of a 100% portion of ownership interest in the second electronic bet ticket;
calculating a second amount of proceeds of the second electronic bet ticket sale transaction which are due to the second user;
transmitting, to the second sportsbook system, a second set of transaction details relating to the second electronic bet ticket sale transaction;
transmitting instructions to the second sportsbook system for causing the second sportsbook system to distribute funds or credits relating to the second amount of proceeds to the second user account; and
if it is determined that the second electronic bet ticket sale transaction relates to the whole bet sale of a 100% portion of ownership interest in the second electronic bet ticket, transmitting additional instructions to the second sportsbook system for causing the second sportsbook system to update the second sportsbook system database to reassign ownership of the second electronic bet ticket to a third user account at the second sportsbook system, wherein the third user account is associated with the third user.

16. The computer program product of claim B10 further comprising causing the at least one processor to execute instructions for:
executing a second plurality of operations if it is determined that the second electronic bet ticket sale transaction relates to the fractional bet sale of less than a 100% portion of ownership interest in the second electronic bet ticket, including:
transmitting additional instructions to the second sportsbook system for causing the second sportsbook system to update a status of the of the second electronic bet ticket to reflect that the second electronic bet ticket is settled or closed;
transmitting additional instructions to the second sportsbook system for causing the second sportsbook system to create a third electronic bet ticket at the second sportsbook system representing the second portion of ownership interest in the second electronic bet ticket, using the second set of transaction details;
transmitting additional instructions to the second sportsbook system for causing the second sportsbook system to update the second sportsbook system database to associate ownership of the third electronic bet ticket with a third user account at the second sportsbook system, wherein the third user account is associated with the third user;
calculating an updated win amount for the second electronic bet ticket which is retained by the second user after execution of the second electronic bet ticket sale transaction;
transmitting additional instructions to the second sportsbook system for causing the second sportsbook system to create a fourth electronic bet ticket at the second sportsbook system representing a remainder portion of ownership interest in the second electronic bet ticket which is retained by the second user after execution of the second electronic bet ticket sale transaction, using the second set of transaction details; and
transmitting additional f instructions to the second sportsbook system for causing the second sportsbook system to update the second sportsbook system database to associate ownership of the fourth electronic bet ticket with t

17. A non-transitory computer usable medium for use in a computer network, the computer network including at least one processor, the computer usable medium having computer readable code embodied therein, the computer readable code comprising computer code for causing at least one processor to execute instructions stored in at least one memory for:
receiving, at a computerized ticket exchange system, a first request from the first user to post, at the electronic bet ticket exchange marketplace, a first sale offer to sell a first portion of ownership interest in the first electronic bet ticket, the first sale offer specifying a first set of terms, including a first purchase price, a first win amount;
processing the first request;
posting, in response to processing the first request, the first sale offer at the electronic bet ticket exchange marketplace;
receiving, at the computerized ticket exchange system, a second request from the second user to post, at the electronic bet ticket exchange marketplace, a second sale offer to sell a second portion of ownership interest in the second electronic bet ticket, the second sale offer specifying a second set of terms, including a second purchase price, a second win amount;
processing the second request;
posting, in response to processing the second request, the second sale offer at the electronic bet ticket exchange marketplace; and
enabling the third user to access the online electronic bet ticket exchange marketplace and view a plurality of offers posted to the electronic bet ticket exchange marketplace, including the first sale offer and second sale offer;
receiving, at the ticket exchange system, a third request from the third user to purchase the first portion of ownership interest in the first electronic bet ticket in accordance with the first set of terms;
processing the third request;
executing, in response to processing the third request, a first plurality of operations for facilitating execution of a first electronic bet ticket sale transaction relating to a sale of the first portion of ownership interest in the first electronic bet ticket to the third user, in accordance with the first sale offer, the first plurality of operations, including:
performing verification and regulatory compliance clearance analysis to confirm eligibility and approval for executing the first electronic bet ticket sale transaction;
determining whether the first electronic bet ticket sale transaction relates to a whole bet sale of a 100% portion of ownership interest in the first electronic bet ticket, or a whole bet sale of a 100% portion of ownership interest in the first electronic bet ticket;
calculating a first amount of proceeds of the first electronic bet ticket sale transaction which are due to the first user;
transmitting, to the first sportsbook system, a first set of transaction details relating to the first electronic bet ticket sale transaction;
transmitting instructions to the first sportsbook system for causing the first sportsbook system to distribute funds or credits relating to the first amount of proceeds to the first user account;
if it is determined that the first electronic bet ticket sale transaction relates to the whole bet sale of a 100% portion of ownership interest in the first electronic bet ticket, transmitting additional instructions to the first sportsbook system for causing the first sportsbook system to update the first sportsbook system database to reassign ownership of the first electronic bet ticket to a third user account at the first sportsbook system, wherein the third user account is associated with the third user;
receiving, at the computerized ticket exchange system, a second request from the second user to post, at the electronic bet ticket exchange marketplace, a second sale offer to sell a second portion of ownership interest in the second electronic bet ticket, the second sale offer specifying a second set of terms, including a second purchase price, a second win amount;
processing the second request;
posting, in response to processing the second request, the second sale offer at the electronic bet ticket exchange marketplace;
receiving, at the ticket exchange system, a fourth request from the third user to purchase the second portion of ownership interest in the second electronic bet ticket in accordance with the second set of terms;
processing the fourth request;
executing, in response to processing the fourth request, a second plurality of operations for facilitating execution of a second electronic bet ticket sale transaction relating to a sale of the second portion of ownership interest in the second electronic bet ticket to the third user, in accordance with the second sale offer, the second plurality of operations including:
performing verification and regulatory compliance clearance analysis to confirm eligibility and approval for executing the second electronic bet ticket sale transaction;
determining whether the second electronic bet ticket sale transaction relates to a whole bet sale of a 100% portion of ownership interest in the second electronic bet ticket, or a whole bet sale of a 100% portion of ownership interest in the second electronic bet ticket;
calculating a second amount of proceeds of the second electronic bet ticket sale transaction which are due to the second user;
transmitting, to the second sportsbook system, a second set of transaction details relating to the second electronic bet ticket sale transaction;
transmitting instructions to the second sportsbook system for causing the second sportsbook system to distribute funds or credits relating to the second amount of proceeds to the second user account; and
if it is determined that the second electronic bet ticket sale transaction relates to the whole bet sale of a 100% portion of ownership interest in the second electronic bet ticket, transmitting additional instructions to the second sportsbook system for causing the second sportsbook system to update the second sportsbook system database to reassign ownership of the second electronic bet ticket to a third user account at the second sportsbook system, wherein the third user account is associated with the third user.
